(19) United States
(12) Patent Application Publication
(10) Pub. No.: US 2013/0293533 A1
(43) Pub. Date: Nov. 7, 2013

(54) IMAGE PROCESSING APPARATUS AND IMAGE PROCESSING METHOD

(71) Applicant: SONY CORPORATION, Tokyo (JP)

(72) Inventor: Masato Akao, Kanagawa (JP)

(73) Assignee: Sony Corporation, Tokyo (JP)

(21) Appl. No.: 13/867,216

(22) Filed: Apr. 22, 2013

(30) Foreign Application Priority Data
May 2, 2012 (JP) 2012-105252

(51) Int. Cl. G09G 5/14

(52) U.S. Cl. CPC G09G 5/14
USPC 345/419

(57) ABSTRACT

There is provided an image processing apparatus including a parallax estimating unit that generates parallax information from a left visual point image to be an image signal for a left eye applied to multi-dimensional image display and a right visual point image to be an image signal for a right eye applied to the multi-dimensional image display, an interpolation direction control unit that controls changing of an interpolation direction of a virtual visual point image including a visual point image other than the left visual point image and the right visual point image, according to a parameter showing a degree of a variation based on the parallax information generated by the parallax estimating unit, and a virtual visual point image generating unit that generates the virtual visual point image in the interpolation direction of which the changing is controlled by the interpolation direction control unit.

### BACKGROUND

The present disclosure relates to an image processing apparatus and an image processing method and more particularly, to an image processing apparatus, an image processing method, and a program that enable mismatching of front and rear frames to be inconspicuous, when an interpolation method changes.

A glasses-free 3D display apparatus that enables a user to perceive a stereoscopic image without wearing glasses, in three-dimensional (3D) image display processing, has begun to be put to practical use. The glasses-free 3D display apparatus includes a lenticular sheet or a parallax barrier provided on a display surface and controls images input to left and right eyes by a viewing position. That is, the glasses-free 3D display apparatus performs a control operation such that a left visual point image corresponding to an image observed from the left eye is observed by the left eye and a right visual point image corresponding to an image observed from the right eye is observed by the right eye.

However, according to the above method, a correct stereoscopic vision is obtained only at limited viewing positions with respect to a display. Therefore, when an observation position of a user is different from a prescribed position, a reverse vision in which an image for the right eye (right visual point image) may be input to the left eye and an image for the left eye (left visual point image) may be input to the right eye or crosstalk in which the left visual point image and the right visual point image are mixed occurs.

Meanwhile, a configuration in which not only a standard left visual point image and a standard right visual point image corresponding to one regular observation position and images from new visual points set not to cause the crosstalk when the display is observed at the other observation positions are generated and displayed has been suggested.

Not only a set of original left and right visual point images but also images of the other virtual visual points are generated as multiple visual point images, a set of optimal left and right visual point images are selected from the multiple visual point images according to an observation position of a user, and image display in which the reverse vision or the crosstalk is suppressed is performed. That is, a pair of left and right visual point images different according to the observation position of the user are made to be observed and a left visual point image and a right visual point image according to the observation position are made to be observed by a left eye and a right eye of an observer, even when the observation position of the user changes.

Specifically, interpolation is performed on the basis of original two visual point images, that is, two visual point images of a left visual point image (L image) and a right visual point image (R image) for the 3D image display input to the display apparatus or the image processing apparatus, so that visual point images of virtual visual points other than the two visual points are generated.

A combination of two optimal images according to the observation position of the user with respect to the display among the generated multiple visual point images is made to be observed by the user and the display and the observation of the 3D image in which the crosstalk in which the left visual point image and the right visual point image are mixed is suppressed are enabled at various observation positions.

For example, a method of inputting an original left visual point image (L image) and an original right visual point image (R image), executing parallax detection from the two images, and generating a plurality of virtual visual point images on the basis of detected parallax information has been suggested in Japanese Patent Application Laid-Open (JP-A) No. 2006-115198. Specifically, a method of detecting parallax from two original 3D images of an input left visual point image (L image) and an input right visual point image (R image) and determining virtual visual point positions different from visual point positions of the input LR images on the basis of a crosstalk amount or a fusional parallax range has been disclosed.

### SUMMARY

As described above, the interpolation methods of performing the interpolation on the basis of the two visual point images of the left visual point image (L image) and the right visual point image (R image) when the visual point images of the virtual visual points other than the two visual points are generated have been suggested.

However, when only the single interpolation method corresponds to all output phases, distortion or blur may occur in the generated virtual visual point images.

When the plurality of interpolation methods are used together, if the output phase may temporally change, the virtual visual point image may temporally change.

It is desirable to enable mismatching of front and rear frames to be inconspicuous, when an interpolation method changes.

According to an embodiment of the present disclosure, there is provided an image processing apparatus including a parallax estimating unit that generates parallax information from a left visual point image to be an image signal for a left eye applied to multi-dimensional image display and a right visual point image to be an image signal for a right eye applied to the multi-dimensional image display, an interpolation direction control unit that controls changing of an interpolation direction of a virtual visual point image including a visual point image other than the left visual point image and the right visual point image, according to a parameter showing a degree of a variation based on the parallax information generated by the parallax estimating unit, and a virtual visual point image generating unit that generates the virtual visual point image in the interpolation direction of which the changing is controlled by the interpolation direction control unit.

The interpolation direction control unit may prohibit the changing of the interpolation direction of the virtual visual point image, when the variation shown by the parameter is large.

The interpolation direction control unit may perform the changing of the interpolation direction of the virtual visual point image, when the variation shown by the parameter is small.

The variation based on the parallax information that is generated by the parallax estimating unit may be a time variation.

The image processing apparatus may further include a reliability calculating unit that calculates reliability of the parallax information generated by the parallax estimating unit. The parameter showing the degree of the variation based on the parallax information generated by the parallax estimating unit may be the reliability of the parallax information calculated by the reliability calculating unit, and the interpolation direction control unit may control the changing of the interpolation direction of the virtual visual point image, according to the reliability of the parallax information calculated by the reliability calculating unit.

The parameter showing the degree of the variation based on the parallax information generated by the parallax estimating unit may be a scale value calculated from the parallax information generated by the parallax estimating unit, and the interpolation direction control unit may control the changing of the interpolation direction of the virtual visual point image, according to the scale value calculated from the parallax information generated by the parallax estimating unit.

The interpolation direction control unit may select one direction as the interpolation direction of the virtual visual point image, according to the parameter showing the degree of the variation based on the parallax information generated by the parallax estimating unit, when the selected one direction is selected as the interpolation direction of the virtual visual point image continuously for a constant time, the interpolation direction control unit may change the interpolation direction of the virtual visual point image to the selected one direction, and when the selected one direction is not selected as the interpolation direction of the virtual visual point image continuously for the constant time, the interpolation direction control unit may prohibit the changing of the interpolation direction of the virtual visual point image.

The virtual visual point image generating unit may set a convergence position of a visual point position to a left visual point or a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

The virtual visual point image generating unit may set a convergence position of a visual point position to any position between a left visual point and a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

The image processing apparatus may further include a face detecting unit that detects a position of a face of a user who views the virtual visual point image which is generated by the virtual visual point image generating unit and is displayed on a display unit. The interpolation direction control unit may control the changing of the interpolation direction of the virtual visual point image, according to the position of the face of the user detected by the face detecting unit.

A display unit that displays the virtual visual point image generated by the virtual visual point image generating unit may be wearable on a head of a user, the image processing apparatus may further include a face detecting unit that detects a position and a direction of a face of the user who views the virtual visual point image displayed on the display unit, and the interpolation direction control unit may control the changing of the interpolation direction of the virtual visual point image, according to the position and the direction of the face of the user detected by the face detecting unit.

The image processing apparatus may further include a scene change detecting unit that detects a scene change from the left visual point image or the right visual point image. The interpolation direction control unit may perform the changing of the interpolation direction of the virtual visual point image, when the scene change is detected by the scene change detecting unit.

According to an embodiment of the present disclosure, there is provided an image processing method including causing an image processing apparatus to generate parallax information from a left visual point image to be an image signal for a left eye applied to multi-dimensional image display and a right visual point image to be an image signal for a right eye applied to the multi-dimensional image display, causing the image processing apparatus to control changing of an interpolation direction of a virtual visual point image including a visual point image other than the left visual point image and the right visual point image, according to a parameter showing a degree of a variation based on the generated parallax information, and causing the image processing apparatus to generate the virtual visual point image in the interpolation direction of which the changing is controlled.

According to an embodiment of the present disclosure, the parallax information is generated from the left visual point image to be the image signal for the left eye applied to the multi-dimensional image display and the right visual point image to be the image signal for the right eye applied to the multi-dimensional image display and the changing of the interpolation direction of the virtual visual point image including the visual point image other than the left visual point image and the right visual point image is controlled according to the parameter showing the degree of the variation based on the generated parallax information. In addition, the virtual visual point image is generated in the interpolation direction of which the changing is controlled.

According to the embodiments of the present disclosure described above, a virtual visual point image including a visual point image other than a left visual point image and a right visual point image can be generated. In particular, when an interpolation direction changes, mismatching of front and rear frames can be prevented from being conspicuous.

### BRIEF DESCRIPTION OF THE DRAWINGS

FIG. 1 is a diagram illustrating the related art;

FIG. 2 is a bock diagram illustrating a configuration example of an image processing apparatus to which the present disclosure is applied;

FIG. 3 is a diagram illustrating an example of processing of a parallax estimating unit;

FIG. 4 is a diagram illustrating an example of processing of a parallax estimating unit;

FIG. 5 is a diagram illustrating generation processing of a basic virtual visual point image;

FIG. 6 is a diagram illustrating generation processing of a basic virtual visual point image;

FIG. 7 is a diagram illustrating generation processing of a basic virtual visual point image;

FIG. 8 is a block diagram illustrating a configuration example of a virtual visual point image generating unit;

FIG. 9 is a diagram illustrating visual point position adjustment processing;

FIG. 10 is a diagram illustrating a setting example of a virtual visual point image position;

FIG. 11 is a diagram illustrating selection processing of an interpolation direction;

FIG. 12 is a block diagram illustrating a configuration example of an image synthesizing unit;

FIG. 13 is a block diagram illustrating a configuration example of a one visual point image synthesizing unit;

FIG. 14 is a flowchart illustrating an example of image processing of an image processing apparatus;

FIG. 15 is a flowchart illustrating visual point position adjustment processing:

FIG. 16 is a flowchart illustrating selection processing of an interpolation direction;

FIG. 17 is a block diagram illustrating a configuration example of an image processing apparatus to which the present disclosure is applied;

FIG. 18 is a diagram illustrating processing of a reliability calculating unit;

FIG. 19 is a diagram illustrating processing of a reliability calculating unit;

FIG. 20 is a diagram illustrating processing of a reliability calculating unit;

FIG. 21 is a diagram illustrating processing of a reliability calculating unit;

FIG. 22 is a block diagram illustrating a configuration example of a virtual visual point image generating unit;

FIG. 23 is a diagram illustrating a setting example of a virtual visual point image position;

FIG. 24 is a diagram illustrating selection processing of an interpolation direction;

FIG. 25 is a flowchart illustrating an example of image processing of an image processing apparatus;

FIG. 26 is a flowchart illustrating visual point position adjustment processing;

FIG. 27 is a flowchart illustrating selection processing of an interpolation direction;

FIG. 28 is a diagram illustrating an image processing apparatus to which the present disclosure is applied;

FIG. 29 is a block diagram illustrating a configuration example of an image processing apparatus;

FIG. 30 is a block diagram illustrating a configuration example of a virtual visual point image generating unit;

FIG. 31 is a diagram illustrating a setting example of a virtual visual point image position;

FIG. 32 is a diagram illustrating an image processing apparatus to which the present disclosure is applied;

FIG. 33 is a block diagram illustrating a configuration example of an image processing apparatus;

FIG. 34 is a diagram illustrating an operation of a visual point position measuring unit;

FIG. 35 is a block diagram illustrating a configuration example of a virtual visual point image generating unit;

FIG. 36 is a flowchart illustrating an example of image processing of an image processing apparatus;

FIG. 37 is a flowchart illustrating visual point position adjustment processing:

FIG. 38 is a flowchart illustrating selection processing of an interpolation direction;

FIG. 39 is a diagram illustrating an image processing apparatus to which the present disclosure is applied;

FIG. 40 is a block diagram illustrating a configuration example of an image processing apparatus;

FIG. 41 is a block diagram illustrating a configuration example of an image processing apparatus to which the present disclosure is applied;

FIG. 42 is a diagram illustrating processing of a scene change detecting unit;

FIG. 43 is a block diagram illustrating a configuration example of a virtual visual point image generating unit that executes analysis processing of a scene;

FIG. 44 is a block diagram illustrating a configuration example of a virtual visual point image generating unit that executes selection processing of an interpolation direction and image synthesis processing;

FIG. 45 is a flowchart illustrating an example of image processing of an image processing apparatus;

FIG. 46 is a flowchart illustrating scene analysis processing;

FIG. 47 is a flowchart illustrating selection processing of an interpolation direction;

FIG. 48 is a block diagram illustrating a configuration example of an image processing apparatus to which the present disclosure is applied;

FIG. 49 is a flowchart illustrating an example of image processing of an image processing apparatus;

FIG. 50 is a flowchart illustrating scene analysis processing;

FIG. 51 is a flowchart illustrating selection processing of an interpolation direction; and

FIG. 52 is a block diagram illustrating a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.

### 1. Description of Related Art

### 2. First Embodiment (Parallax Range)

### 3. Second Embodiment (Reliability)

### 4. Third Embodiment (Motion Parallax)

### 5. Fourth Embodiment (Motion Parallax+Face Detection)

### 6. Fifth Embodiment (Head-Mounted Display)

### 7. Sixth Embodiment (Off-Line Processing)

### 8. Seventh Embodiment (Computer)

### 1. Description of Related Art

### [Description of Related Art>

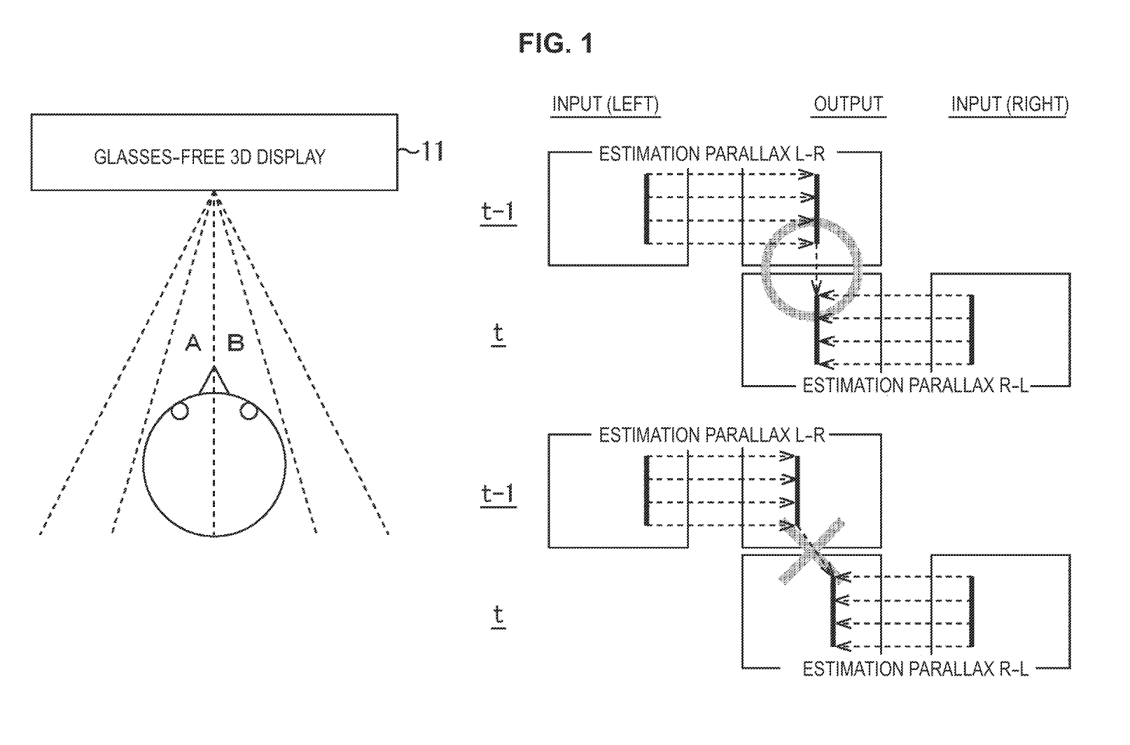

First, the related art will be described with reference to FIG. 1.

In the related art, in an apparatus that generates an image displayed on a glasses-free 3D display 11, an output image is generated on the basis of a visual point image A input to a left eye of a user who views the glasses-free 3D display 11 or a visual point image B input to a right eye.

Here, the case in which an interpolation direction changes from the visual point image A input to the left eye to the visual point image B input to the right eye at times t−1 and t is considered. In the images, thick lines of a vertical direction are included.

Specifically, at the time t−1, estimation parallax L-R is calculated from the visual point image A input to the left eye and an output image of the time t−1 is generated. At the time t, estimation parallax R-L is calculated from the visual point image B input to the right eye and an output image of the time t is generated.

As illustrated at an upper right side of FIG. 1, if the estimation parallax L-R and the estimation parallax R-L are matched, the thick line of the output image of the time t−1 and the thick line of the output image of the time t are almost aligned.

However, as illustrated at a lower right side of FIG. 1, at least one of the estimation parallax L-R and the estimation parallax R-L is wrong, the thick line of the output image of the time t−1 and the thick line of the output image of the time t may not be aligned.

Thereby, at the times t1 to t−1, error of a change in which the thick line of the output image is viewed as if the thick line has jumped in a horizontal direction or a depth direction may be conspicuous.

Therefore, in the present disclosure, mismatching of front and rear frames is prevented from being conspicuous, when the interpolation direction changes. Hereinafter, the present disclosure will be described in detail.

### 2. First Embodiment

### Parallax Range

### [Configuration Example of Image Processing Apparatus]

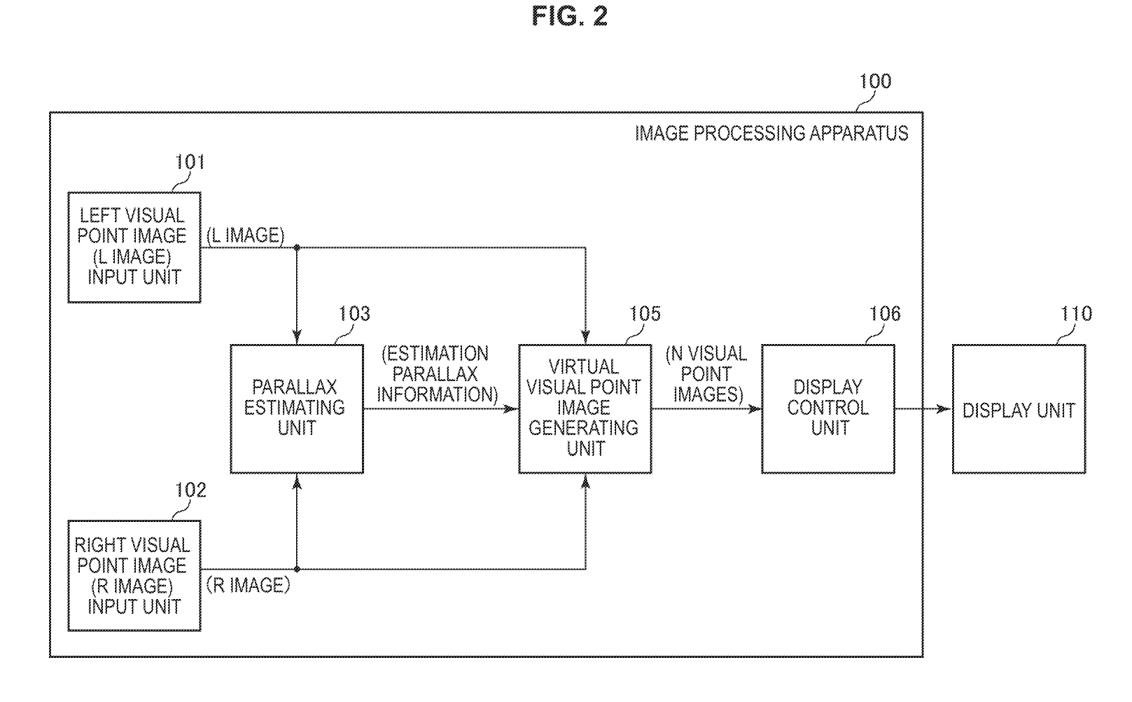

FIG. 2 is a block diagram illustrating a configuration example of an image processing apparatus to which the present disclosure is applied.

In the example of FIG. 2, an image processing apparatus 100 includes a left visual point image (L image) input unit 101, a right visual point image (R image) input unit 102, a parallax estimating unit 103, a virtual visual point image generating unit 105, and a display control unit 106. An image that is generated in the image processing apparatus 100 is output to a display unit 110.

In the configuration illustrated in FIG. 2, the display unit 110 is provided outside the image processing apparatus 100. However, the display unit 110 may be provided inside the image processing apparatus 100.

FIG. 2 illustrates a main configuration of the image processing apparatus. Therefore, the image processing apparatus 100 includes a control unit having a program execution function such as a CPU to execute data processing control, a storage unit to store a program executed in the control unit or various parameters, and an input unit to input parameters or image data, in addition to the configuration illustrated in FIG. 2. For example, the control unit executes processing to be described below according to the program stored in the storage unit in advance.

The left visual point image (L image) input unit 101 and the right visual point image (R image) input unit 102 input a left visual point image (L image) and a right visual point image (R image) for three-dimensional (3D) image display that are generated in advance, respectively. The left visual point image (L image) corresponds to an image observed from a left eye and the right visual point image (R image) corresponds to an image observed from a right eye.

However, the two images are two standard LR images. That is, the two images are LR images that are observed as a correct 3D image when a display is observed from a prescribed position, for example, a center position of the front, in a glasses-free 3D display apparatus that includes a lenticular sheet or a parallax barrier provided on a display surface. When an observation position of a user is different from the prescribed position, a reverse vision in which an image for the right eye (right visual point image) may be input to the left eye and an image for the left eye (left visual point image) may be input to the right eye or crosstalk in which the left visual point image and the right visual point image are mixed occurs.

Meanwhile, the image processing apparatus 100 generates images from new visual points (virtual visual points) not causing the crosstalk when the display is observed at various observation positions, on the basis of input LR images corresponding to one regular observation position, that is, the standard left visual point image and the standard right visual point image.

The parallax estimating unit 103 receives the left visual point image (L image) and the right visual point image (R image) and generates parallax information on the basis of these images. Hereinafter, the L image and the R image are collectively called LR images. The parallax information becomes information that corresponds to a deviation between images (pixel deviation of a horizontal direction) of the same object included in the input LR images and corresponds to a distance of the object.

Specifically, the parallax estimating unit 103 generates data that has parallax information (object distance information) of each pixel unit or each pixel region unit.

The L image from the left visual point image (L image) input unit 101, the R image from the right visual point image (R image) input unit 102, and the parallax information from the parallax estimating unit 103 are input to the virtual visual point image generating unit 105.

The virtual visual point image generating unit 105 receives each information and generates a virtual visual point image. For example, the virtual visual point image generating unit 105 adjusts a parallax amount on the basis of a parallax distribution calculated from the parallax information from the parallax estimating unit 103, executes determination processing of a virtual visual point position, and generates a virtual visual point image corresponding to the determined virtual visual point position.

The virtual visual point image generating unit 105 executes generation processing of the virtual visual point image based on the parallax distribution. That is, a total of N visual point images that are obtained by adding the other visual point images to the two visual point images of the input LR images are generated and output. For example, the virtual visual point image generating unit 105 calculates output phases corresponding to the N visual points, selects an interpolation direction according to the parallax distribution, and generates a virtual visual point image of the selected interpolation direction. This processing will be described in detail below.

The virtual visual point image that is generated by the virtual visual point image generating unit 105 is output to the display unit 110 through the display control unit 106 and is displayed.

The display image that is generated by the image processing apparatus according to the present disclosure is a display image in the glasses-free 3D display apparatus in which the user can view a stereoscopic image without wearing the glasses.

The display unit 110 is a display unit that performs glasses-free 3D display. Specifically, the display unit 110 is a display unit that includes a lenticular sheet or a parallax barrier provided on a display surface and can control images input to the left eye and the right eye by the viewing position.

The display control unit 106 outputs the N visual point images generated by the virtual visual point image generating unit 105 to the display unit 110. The display control unit 106 generates display information according to a display configuration of the display unit 110.

The image processing apparatus 100 can be configured as an imaging apparatus such as a camera including an imaging unit or a display apparatus such as a PC or a television. When the image processing apparatus 100 is configured as the imaging apparatus or the display apparatus, the image processing apparatus 100 has a function according to each apparatus.

For example, the camera has an imaging unit that images LR images corresponding to different visual point images and generates multiple visual point images using the LR images input from the imaging unit.

### [Processing of Parallax Estimating Unit]

Next, processing of the parallax estimating unit 103 will be described. The parallax estimating unit 103 receives a left visual point image (L image) and a right visual point image (R image) and generates parallax information on the basis of these images. The parallax information becomes information that corresponds to a deviation between images (pixel deviation of a horizontal direction) of the same object included in the standard LR images and corresponds to a distance of the object. Specifically, the parallax estimating unit 103 generates data that has parallax information (object distance information) of each pixel unit.

The acquisition of the parallax information is executed by the following existing methods.

(a) Parallax information acquisition processing of a block matching base
(b) Parallax information acquisition processing of a dynamic programming (DP) matching base
(c) Parallax information acquisition processing of a segmentation base
(d) Parallax information acquisition processing of a learning base
(e) Parallax information acquisition processing of a combination of the methods described above

For example, the parallax information is acquired by any method of (a) to (e) described above.

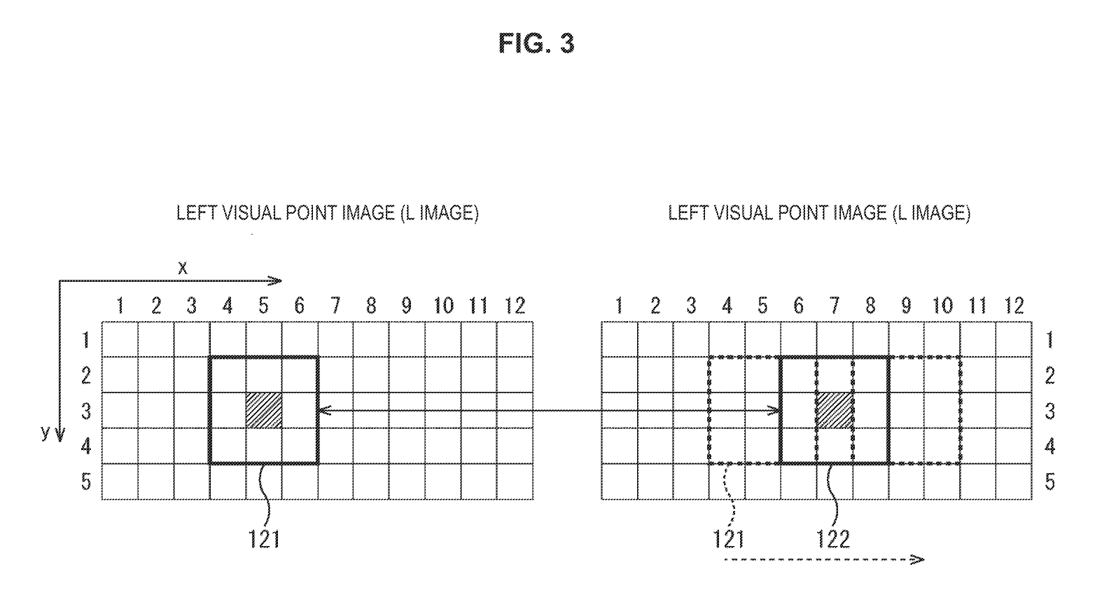

The parallax information acquisition processing of the block matching base will be simply described with reference to FIG. 3. The parallax estimating unit 103 uses a left visual point image (L image) and a right visual point image (R image) to be input original standard images, selects a pixel region (block) 121 of the L image, and detects a pixel region (block) 122 similar to the selected block, from the R image.

That is, the parallax estimating unit 103 selects blocks (matching blocks) determined as imaging regions of the same object, from the LR images. The parallax estimating unit 103 measures a position deviation (the number of pixels in a horizontal direction) of the matching blocks between the LR images.

In FIG. 3, a pixel in the R image that corresponds to an attention pixel LP=(5, 3) of the pixel region (block) 121 of the L image is an attention pixel RP=(7, 3) of the pixel region (block) 122. In this case, parallax d (5, 3) between the LR images at a pixel position (x, y) of the L image=(5, 3) is calculated as represented by the following expression 1.

Parallax d(5, 3)=(7, 3)−(5, 3)=(2,0) [Expression 1]

That is, the parallax d of the pixel position (x, y) of the L image=(5, 3) becomes two pixels.

The position deviation of the block changes according to the distance of the object imaged in the block. That is, the position deviation of the block corresponds to the distance of the object and information of the position deviation is acquired as the parallax information.

As an expression form of the parallax information, there is a depth map (distance image or parallax map). The depth map (parallax map) is an image in which parallax (object distance) of each pixel unit of the L image and the R image is expressed by brightness of a pixel unit. For example, a high-brightness region shows a close object (object close to the camera) and a low-brightness region shows a remote object (object remote from the camera). That is, the depth map is an image in which the object distance is shown by the brightness.

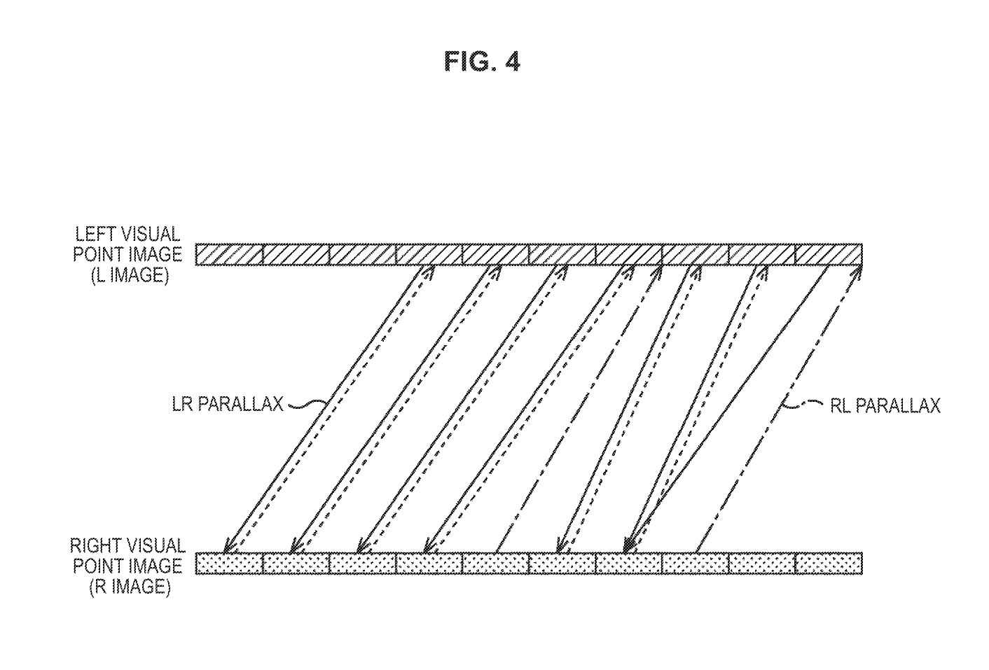

As illustrated in FIG. 4, the parallax estimating unit 103 acquires not only LR parallax information to be information of parallax of the R image based on the L image described above with reference to FIG. 3 but also RL parallax information to be information of parallax of the L image based on the R image. In an example of FIG. 4, the LR parallax information is shown by a solid line and the RL parallax information is shown by a dotted line or a one-dotted chain line.

As shown by the solid line and the dotted line, signs of the LR parallax information and the RL parallax information are different from each other, but the LR parallax information and the RL parallax information are basically matched with each other. However, the RL parallax may not be matched with the LR parallax due to occlusion, as in the RL parallax shown by the one-dotted chain line.

As a method of acquiring the RL parallax information, there are the following two methods.

(f) Parallax information acquisition processing of a block matching base in a reverse reference image
(g) Inversion processing of a sign of LR parallax+interpolation processing from parallax of adjacent pixels

In this way, in the parallax estimating unit 103, the LR parallax information and the RL parallax information are acquired and generated.

### [Outline of Operation of Virtual Visual Point Image Generating Unit]

Next, basic virtual visual point image generation processing based on the input LR images that is executed by the virtual visual point image generating unit 105 will be described.

The L image from the left visual point image (L image) input unit 101, the R image from the right visual point image (R image) input unit 102, and the parallax information from the parallax estimating unit 103 are input to the virtual visual point image generating unit 105. The virtual visual point image generating unit 105 receives each information and generates a virtual visual point image.

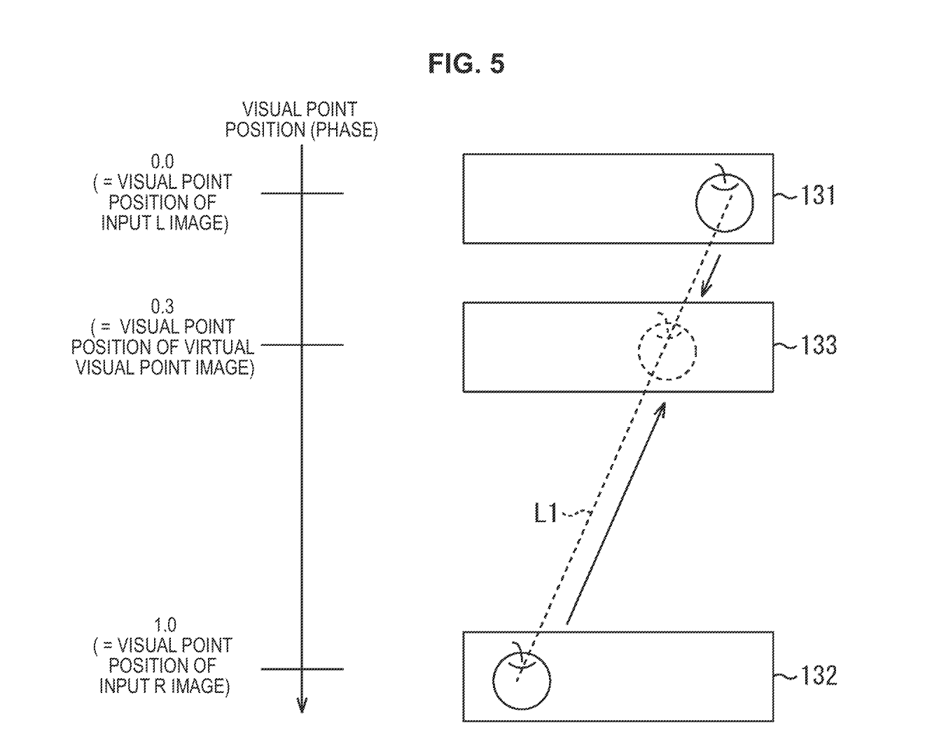

For example, the virtual visual point image generating unit 105 determines virtual visual points of a preset number (for example, 10) and generates a virtual visual point image corresponding to each virtual visual point. The virtual visual point image generating unit 105 generates the virtual visual point image using the input standard LR images. That is, the virtual visual point image generating unit 105 generates the virtual visual point image using the left visual point image (L image) and the right visual point image (R image) to be the input images. A specific example of virtual visual point image generation processing will be described with reference to FIG. 5.

In the example of FIG. 5, an original left visual point image (L image) 131 and an original right visual point image (R image) 132 that are input to the image processing apparatus and a virtual visual point image 133 that is generated on the basis of the LR images are illustrated.

The left visual point image (L image) 131 is an image that is observed from a left visual point position at the standard position and the right visual point image (R image) 132 is an image that is observed from a right visual point position at the standard position.

FIG. 5 illustrates a processing example of the case in which a visual point position of the left visual point image (L image) 131 is set to 0.0, a visual point position of the right visual point image (R image) 132 is set to 1.0, and an image observed from a visual point position between the visual point positions 0.0 to 1.0=0.3 is generated as the virtual visual point image 133.

The same object (apple) is imaged at different positions in the left visual point image (L image) 131 and the right visual point image (R image) 132. In the L image and the R image, the positions of the same object become different from each other, because the visual point positions become different from each other.

When the virtual visual point image 133 of the visual point position=0.3 between the visual point position=0.0 and the visual point position=1.0 is generated, the position of the object (apple) is set by linear interpolation. By changing the object position along a straight line L1 illustrated in FIG. 5 and determining the object position of the virtual visual point image at each virtual visual point, the virtual visual point image can be generated.

As such, the virtual visual point image of each virtual visual point position is generated by linear interpolation processing based on the input LR images.

When the virtual visual point image is generated, the virtual visual point image can be generated by processing for blending two images using both the input LR images. Alternatively, the virtual visual point image can be generated by processing for shifting the object position according to the virtual visual point position using only the L image or the R image, that is, one image. Alternatively, processing for generating the virtual visual point image using only the L image at the virtual visual point position close to the side of the L image and generating the virtual visual point image using only the R image at the position close to the R image may be executed.

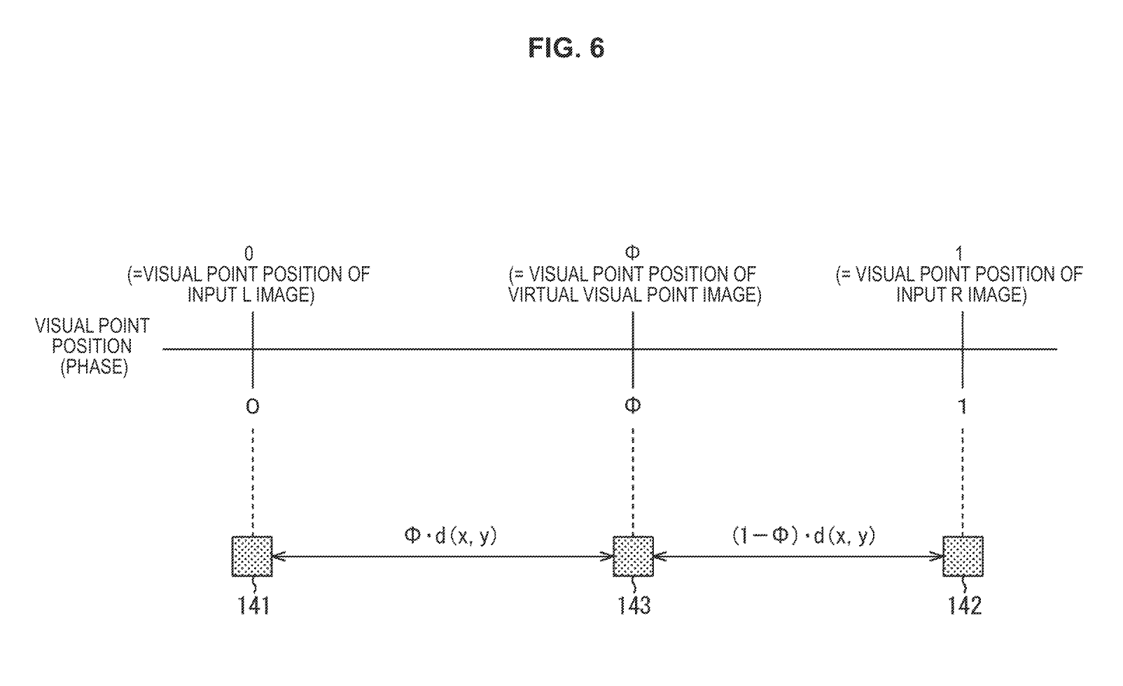

An example of determination processing of a pixel value of the virtual visual point image 131 based on the processing for blending the input LR images will be described with reference to FIG. 6.

In the example of FIG. 6, a pixel P(x, y) 141 of an input left visual point image (L image) at a visual point position=0 and a correspondence pixel 142 of the pixel P of the L image in an input right visual point image (R image) at a visual point position=1 are illustrated. In addition, a correspondence pixel 143 of the pixel P of the L image in a virtual visual point image at a visual point position=Φ is illustrated. In this case, Φ is a value of 0 to 1.

When the parallax of the pixel P(x, y) 141 of the left visual point image (L image) is d(x, y) [pixel], a pixel position of the correspondence pixel 143 of the pixel P(x, y) of the L image in the virtual visual point image is a pixel Q(x+Φ·d(x, y),y). That is, a pixel value of the pixel Q(x+Φ·d(x, y), y) in the virtual visual point image is set to a pixel value of the pixel P(x, y) 141 of the left visual point image (L image).

As such, a pixel value of each pixel of the virtual visual point image is se on the basis of the parallax information of the pixel of the left visual point image (L image).

A pixel value of a pixel not embedded in the virtual visual point image by the above processing is determined by processing in which the right visual point image (R image) is applied, interpolation processing based on pixel values of adjacent pixels, or processing for performing interpolation by a pixel of the same coordinates of the left visual point image.

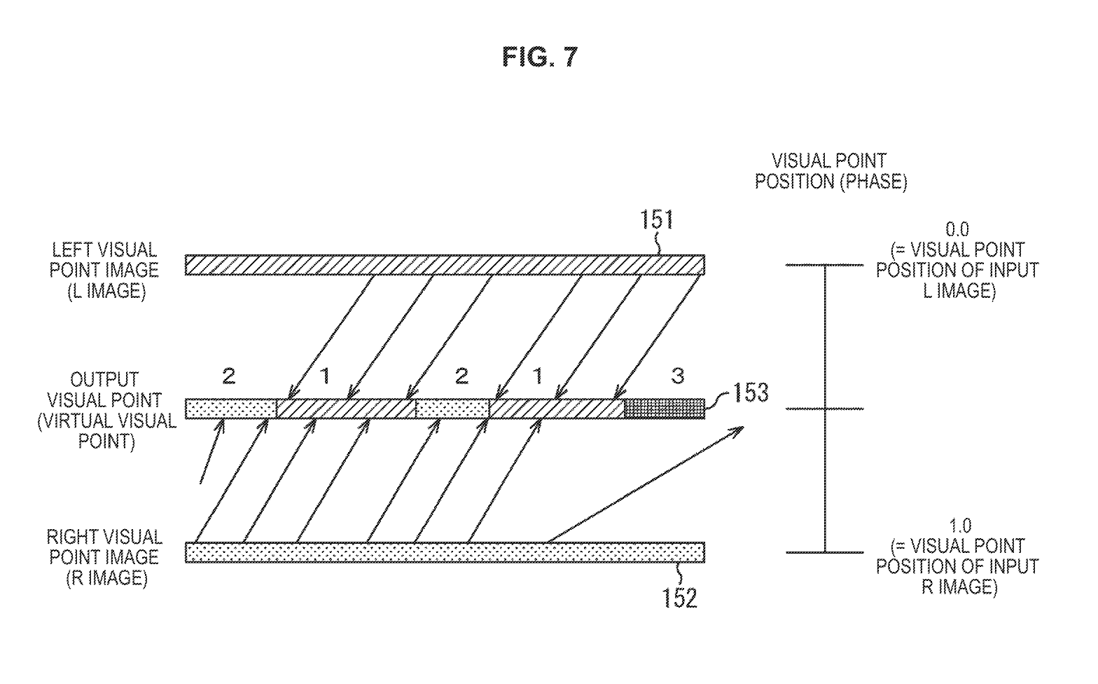

In an example of FIG. 7, a horizontal line 151 of the left visual point image (L image), a horizontal line 152 of the right visual point image (R image), and a horizontal line 153 of the virtual visual point image are illustrated. An arrow illustrated in FIG. 7 is a line that connects a pixel position of the left visual point image (L image) and a pixel position of the right visual point image (R image) applicable to determine a pixel value of the horizontal line 153 of the virtual visual point image.

In the horizontal line 153 of the virtual visual point image illustrated in FIG. 7, 1 shows a region in which pixel values are set by constituent pixel values of the horizontal line 151 of the left visual point image (L image), 2 shows a region in which pixel values are set by constituent pixel values of the horizontal line 152 of the right visual point image (R image), and 3 shows the other region.

As such, setting of the pixel value of the virtual visual point image is executed by the following three processing.

1. A corresponding pixel position at an output visual point position is calculated with respect to each pixel of the left visual point image (L image) and a pixel value of the left visual point image (L image) is interpolated to the pixel position.
2. A corresponding pixel position at an output visual point position is calculated with respect to each pixel of the right visual point image (R image) and a pixel value of the right visual point image (R image) is interpolated to the pixel position.
3. Interpolation processing based on adjacent pixels is performed with respect to a pixel of the output visual point image that is not interpolated by the processing of 1 and 2.

The processing that is described with reference to FIGS. 6 and 7 is basic processing for generating an image from the virtual visual point different from the LR images, on the basis of the input LR images.

The virtual visual point image generating unit 105 of the image processing apparatus according to the present disclosure applies a scale value (parallax range) calculated from parallax information, on the basis of the basic processing. That is, the virtual visual point image generating unit 105 determines a generated virtual visual point position and an interpolation direction on the basis of the scale value and generates a final virtual visual point image.

[Detail of Virtual Visual point Image Generating Unit]

Next, the detail of the virtual visual point image generating unit 105 will be described.

The L image from the left visual point image (L image) input unit 101, the R image from the right visual point image (R image) input unit 102, and the parallax information from the parallax estimating unit 103 are input to the virtual visual point image generating unit 105.

The virtual visual point image generating unit 105 adjusts a parallax amount, that is, determines a generated virtual visual point position (phase), on the basis of a parallax distribution (parallax range) calculated from the input information, and selects an interpolation direction according to a scale value. The virtual visual point image generating unit 105 generates a virtual visual point image corresponding to the determined virtual visual point position (phase), on the basis of an image of the selected interpolation direction. The virtual visual point image generating unit 105 synthesizes the generated virtual visual point image, that is, an image of the adjusted visual point position and outputs a synthesis image to a rear step.

The virtual visual point image generating unit 105 generates virtual visual point images corresponding to the determined virtual visual point positions (phases), on the basis of the L image and the R image, and outputs the image of the selected interpolation direction among the generated images to the rear step.

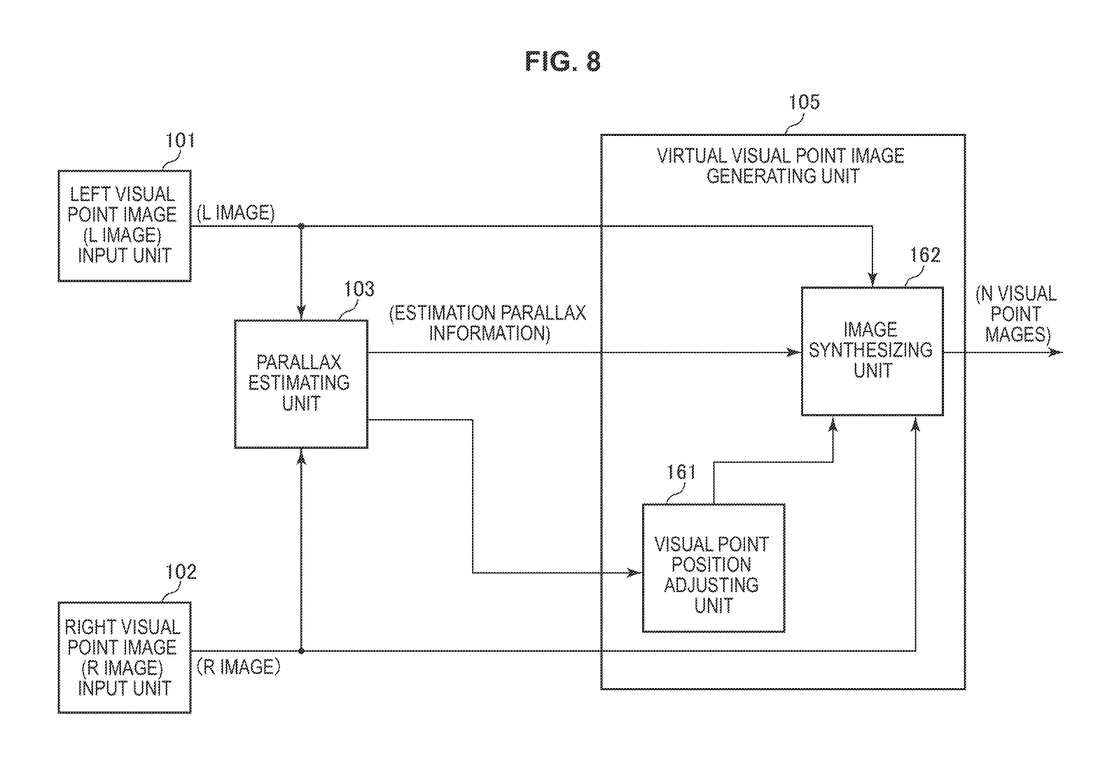

FIG. 8 is a diagram illustrating a configuration example of the virtual visual point image generating unit.

In the example of FIG. 8, the virtual visual point image generating unit 105 includes a visual point position adjusting unit 161 and an image synthesizing unit 162.

The parallax information is supplied from the parallax estimating unit 103 to the visual point position adjusting unit 161. The visual point position adjusting unit 161 adjusts the parallax amount on the basis of the parallax information from the parallax estimating unit 103 and determines the virtual visual point position (phase) and the interpolation direction. The visual point position adjusting unit 161 supplies information of the determined virtual visual point position and information of the determined interpolation direction to the image synthesizing unit 162.

The L image from the left visual point image (L image) input unit 101, the R image from the right visual point image (R image) input unit 102, the parallax information from the parallax estimating unit 103, and the information of the virtual visual point position and the interpolation direction from the visual point position adjusting unit 161 are input to the image synthesizing unit 162.

The image synthesizing unit 162 synthesizes the LR images with the image of the adjusted visual point position, on the basis of the input information, and outputs N visual point images after the synthesis to the display control unit 106 of a rear step.

### [Operation of Visual Point Position Adjusting Unit]

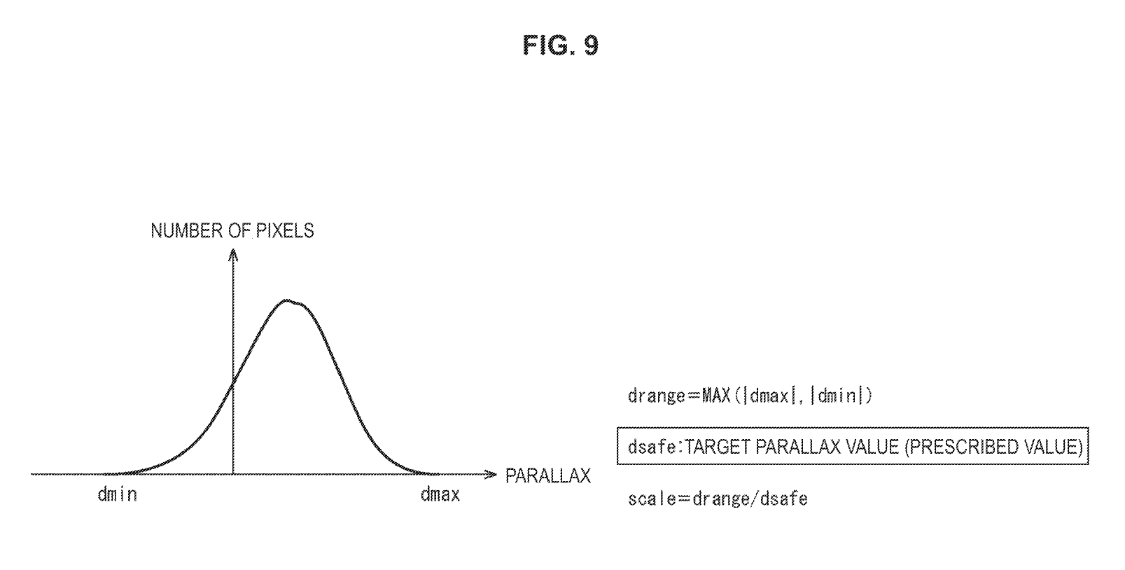

Next, visual point position adjustment processing of the visual point position adjusting unit 161 will be described with reference to FIG. 9.

The visual point position adjusting unit 161 generates a histogram of parallax illustrated in FIG. 9 for each frame of the parallax information from the parallax estimating unit 103 and executes the following processing. In the histogram of the parallax, a horizontal axis shows the parallax and a vertical axis shows the number of pixels (frequency).

First, the visual point position adjusting unit 161 calculates a maximum value dmax and a minimum value dmin of the parallax, on the basis of the histogram of the parallax. Next, the visual point position adjusting unit 161 sets a larger value of |dmax| and |dmin| as a parallax range drange and calculates a scale value scale=drange/dsafe.

In this case, dsafe shows a target parallax value (prescribed value) and is previously set from the following information: parallax in which crosstalk is settled within an allowable range (display device dependency) or a comfortable parallax range (3D consortium security guideline).

The visual point position adjusting unit 161 calculates an output phase of each visual point and calculates an interpolation direction. That is, the visual point position adjusting unit 161 calculates a scale value as a parameter showing a degree of a variation (in this case, a time variation) based on the parallax information and executes visual point position adjustment processing according to the variation shown by the scale value.

### [Calculation Processing of Output Phase]

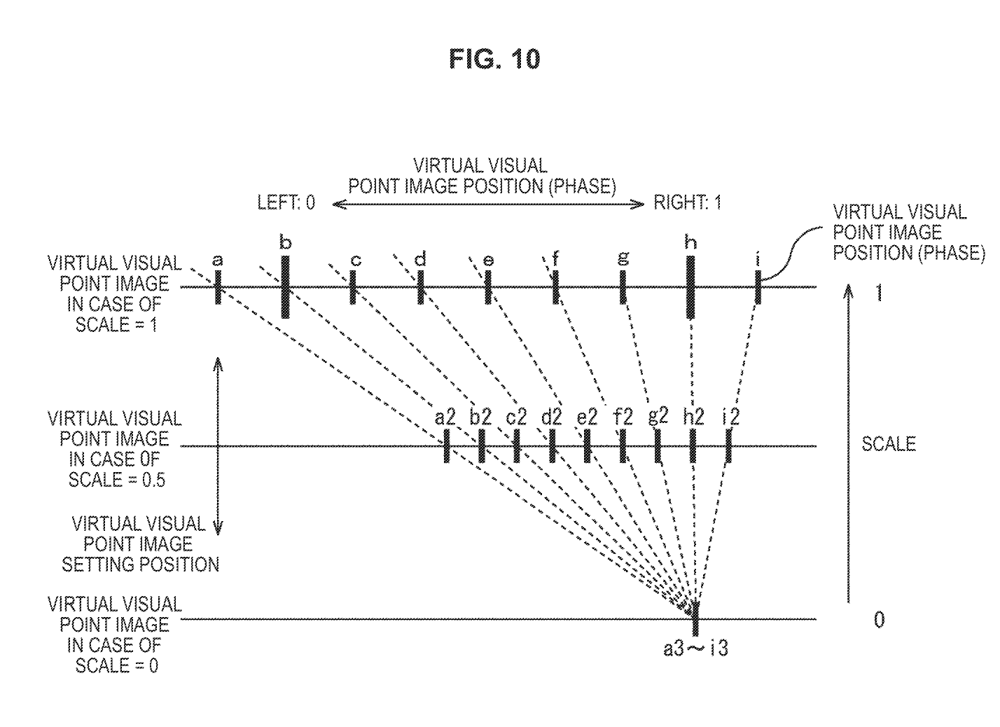

First, calculation processing of an output phase will be described with reference to FIG. 10. The visual point position adjusting unit 161 determines parallax of a virtual visual point image to be generated, that is, a position (phase) of the virtual visual point image to be generated, according to the calculated scale value.

Specifically, the visual point position adjusting unit 161 executes determination processing of the virtual visual point position illustrated in FIG. 10, according to the scale value of 0 to 1. If the scale value (parallax range) is small, a time variation, that is, mismatching is likely to be small and if the scale value is large, the time variation, that is, the mismatching is likely to be large.

FIG. 10 is a diagram illustrating a setting example of the virtual visual point image position when the scale value is 0 to 1. The visual point position=0 is a visual point position corresponding to the input L image and the visual point position=1 is a visual point position corresponding to the input R image.

That is, an image b on a line of the scale value=1 corresponds to the input L image input from the left visual point image (L image) input unit 101 and an image h corresponds to an input R image input from the right visual point image (R image) input unit 102.

The other vertical lines on the line of the scale value=1 show positions (phases) of virtual visual point images generated in the virtual visual point image generating unit 105, when the scale value is 1 (the mismatching is likely to be large). In this example, a total of nine different visual point images of a to i including the input LR images are generated and output.

In the case of the scale value=1, the visual point position adjusting unit 161 determines the images a to i at an upper stage of FIG. 10 as the setting positions of the virtual visual point images and outputs virtual visual point position information to the image synthesizing unit 162. The generation processing of the virtual visual point image is executed according to the processing described above with reference to FIGS. 5 to 7.

In the case of the scale value=0.5, that is, a middle value, the visual point position adjusting unit 161 determines images a2 to i2 at an middle stage of FIG. 10 as the setting positions of the virtual visual point images and outputs virtual visual point position information to the image synthesizing unit 162.

In the case of the middle scale value=0.5, as illustrated in FIG. 10, a parallax range of the virtual visual point images a2 to i2 becomes narrower than a parallax range of the virtual visual point images a to i in the case of the scale value=1.

In the case of the scale value=0, that is, in the case where the mismatching is rarely generated, the visual point position adjusting unit 161 determines images a3 to i3 at a lower stage of FIG. 10 as the setting positions of the virtual visual point images and outputs virtual visual point position information to the image synthesizing unit 162.

The image positions of the images a3 to i3 at the lower stage of FIG. 10 correspond to the image position of the input R image. That is, in this case, the input R image is output as it is without generating a new virtual visual point image. The virtual visual point image generating unit 105 outputs the input L image as it is and only the input LR images are output to the display unit.

The visual point position adjusting unit 161 executes calculation processing of the setting position (phase) of the virtual visual point image according to the following algorithm.

The virtual visual point images that are generated in the case of the scale value =1 are determined in advance. For example, the virtual visual point images are the virtual visual point images at the positions of a to i illustrated in FIG. 10. The calculated scale value is set as S (0≦S). When an original visual point position is set as V0 and the visual point position is converged into the right at the scale value=0, a virtual visual point image position (phase) V that is set according to the scale value is represented by the following expression 2.

V=(V0−1)·S+1 [Expression 2]

### [Selection Processing of Interpolation Direction]

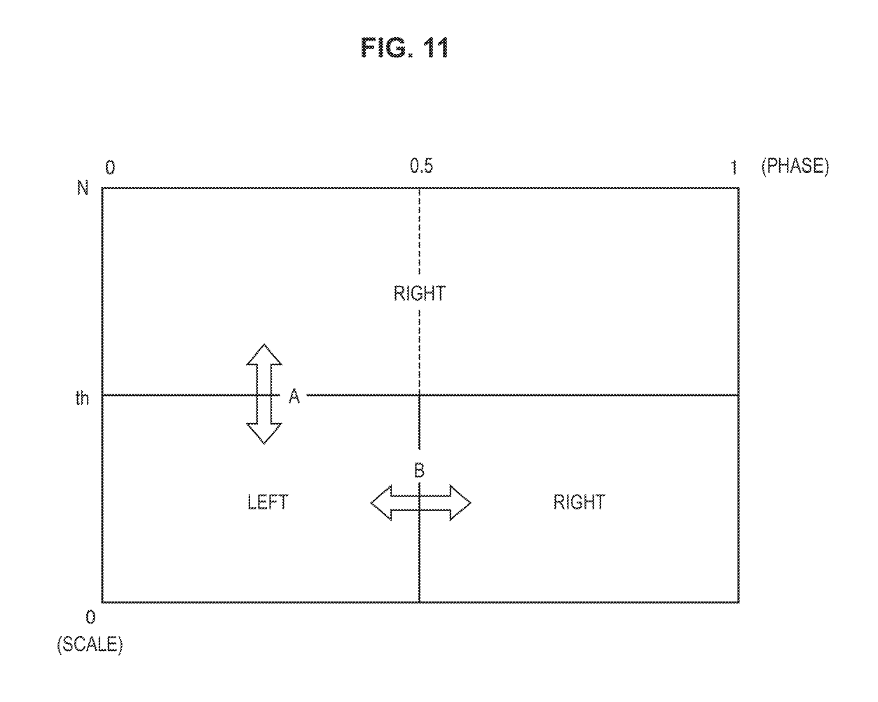

Next, selection processing of an interpolation direction of the visual point position adjusting unit 161 will be described with reference to FIG. 11. In an example of FIG. 11, a horizontal axis shows a phase and a vertical axis shows a scale value S. The scale value is a value that is equal to or more than 0 and is not limited to 0 to 1. In the example of FIG. 11, N is illustrated as a value more than th. However, N may have a value that is more than 1. In the example of FIG. 11, the case in which the position converged at the scale value S=0 is the right (1) will be described.

The visual point position adjusting unit 161 selects an interpolation direction according to the scale value. At this time, as described above, when the scale value (parallax range) is small, the mismatching of left and right images is small. For this reason, the visual point position adjusting unit 161 sets the right as a temporary interpolation direction, when the scale value is more than a predetermined threshold value th. That is, in this case, the visual point position adjusting unit 161 prohibits changing of the interpolation direction to the left.

Meanwhile, in the case in which the scale value is equal to or smaller than the predetermined threshold value th, the visual point position adjusting unit 161 sets the temporary interpolation direction, such that the interpolation is performed from an image of the close side. That is, when a visual point phase is 0.5 or less, the visual point position adjusting unit 161 sets the left as the temporary interpolation direction and when the visual point phase is more than 0.5, the visual point position adjusting unit 161 sets the right as the temporary interpolation direction. In this case, the visual point position adjusting unit 161 performs changing of the interpolation direction (permits the changing of the interpolation direction).

Thereby, the changing of the interpolation direction when the mismatching of the left and right images is large can be prevented.

The visual point position adjusting unit 161 executes time stabilization processing as follows. That is, when the temporary interpolation direction is the left for a constant time, the visual point position adjusting unit 161 sets the interpolation direction as the left and when the temporary interpolation direction is the right for the constant time, the visual point position adjusting unit 161 sets the interpolation direction as the right. In the other cases, the visual point position adjusting unit 161 sets the same direction as a previous frame to the interpolation direction.

In the case of a start frame, the temporary interpolation direction (close image) is set to the interpolation direction.

Thereby, the changing of the interpolation direction shown by an arrow A or B can be suppressed from being frequently generated. That is, the time variation of the high frequency of the interpolation direction and the variations at different timings of both eyes of the left and right eyes can be suppressed.

In the above description, the example of the case in which the position converged at the scale value S=0 is the right (1) has been described. However, the position converged at the scale value S=0 may be the left (0). When the position converged at the scale value S=0 is the left (0) and the scale value is more than the predetermined threshold value th, the left is set as the temporary interpolation direction.

### [Configuration of Image Synthesizing Unit]

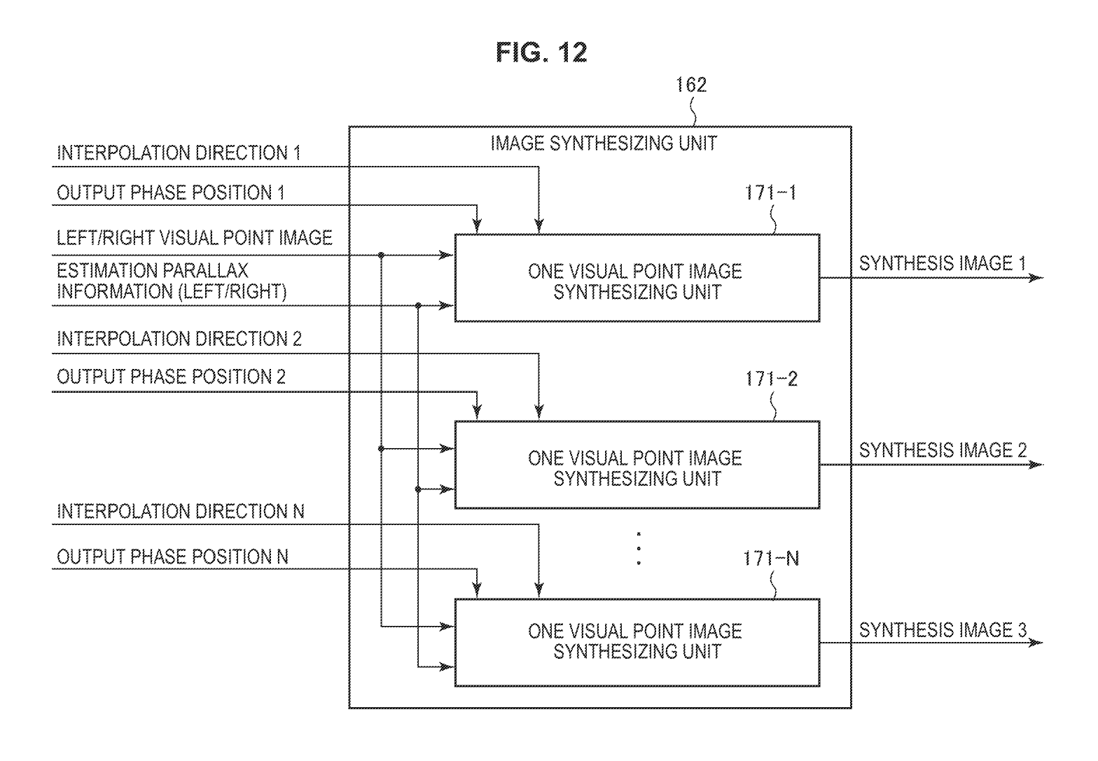

FIG. 12 is a diagram illustrating a configuration example of the image synthesizing unit 162.

In the example of FIG. 12, the image synthesizing unit 162 includes one visual point image synthesizing units 171-1 to 171-N corresponding to the generated virtual visual point images including the input LR images.

The L image from the left visual point image (L image) input unit 101, the R image from the right visual point image (R image) input unit 102, and the parallax information (left/right) from the parallax estimating unit 103 are input to the one visual point image synthesizing units 171-1 to 171-N.

An interpolation direction 1 and an output phase position 1 of a visual point 1 are input from the visual point position adjusting unit 161 to the one visual point image synthesizing unit 171-1. The one visual point image synthesizing unit 171-1 generates a virtual visual point image corresponding to the output phase position 1, on the basis of the parallax information, using the input L image and the input R image. The one visual point image synthesizing unit 171-1 selects the virtual visual point image generated using the image of the direction (the left or the right) corresponding to the interpolation direction 1 and outputs the virtual visual point image as a synthesis image 1 to the display control unit 106 of the rear step.

An interpolation direction 2 and an output phase position 2 of a visual point 2 are input from the visual point position adjusting unit 161 to the one visual point image synthesizing unit 171-2. The one visual point image synthesizing unit 171-2 generates a virtual visual point image corresponding to the output phase position 2, on the basis of the parallax information, using the input L image and the input R image. The one visual point image synthesizing unit 171-2 selects the virtual visual point image generated using the image of the direction (the left or the right) corresponding to the interpolation direction 2 and outputs the virtual visual point image as a synthesis image 2 to the display control unit 106 of the rear step.

An interpolation direction N and an output phase position N of a visual point N are input from the visual point position adjusting unit 161 to the one visual point image synthesizing unit 171-N. The one visual point image synthesizing unit 171-N generates a virtual visual point image corresponding to the output phase position N, on the basis of the parallax information, using the input L image and the input R image. The one visual point image synthesizing unit 171-N selects the virtual visual point image generated using the image of the direction (the left or the right) corresponding to the interpolation direction N and outputs the virtual visual point image as a synthesis image N to the display control unit 106 of the rear step.

Hereinafter, the one visual point image synthesizing units 171-1 to 171-N are collectively described as the one visual point image synthesizing units 171, when it is not necessary to distinguish the one visual point image synthesizing units 171-1 to 171-N in particular.

### [Configuration of One Visual Point Image Synthesizing Unit]

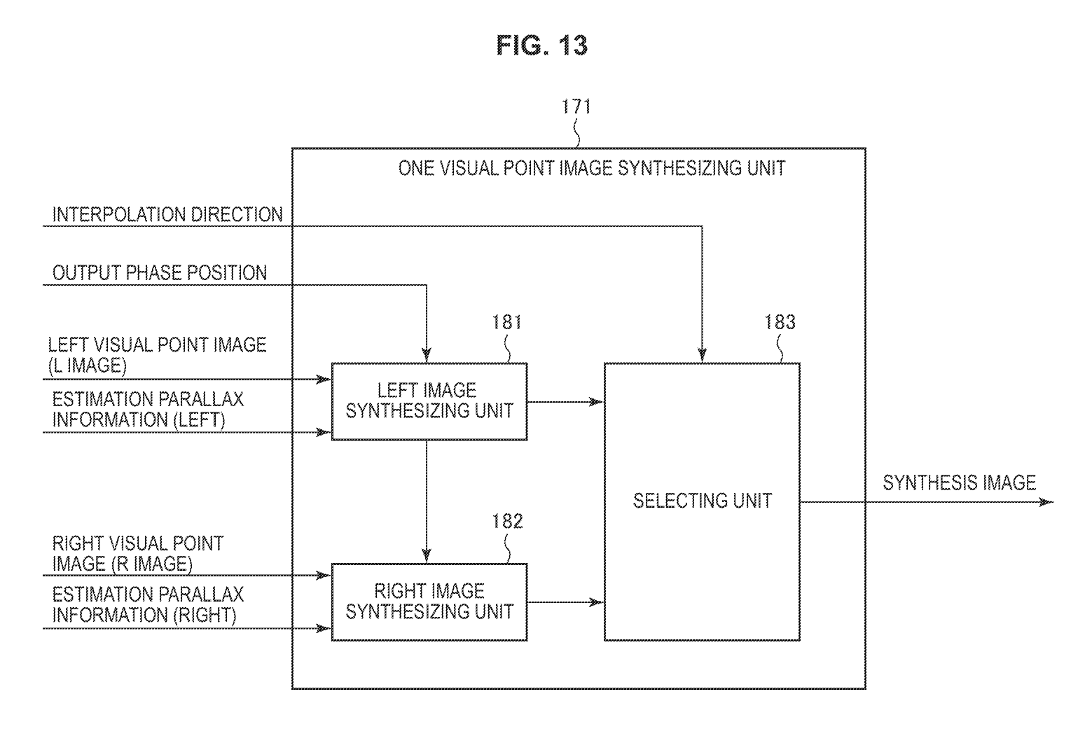

FIG. 13 is a diagram illustrating a configuration example of the one visual point image synthesizing unit 171.

The one visual point image synthesizing unit 171 includes a left image synthesizing unit 181, a right image synthesizing unit 182, and a selecting unit 183.

The L image from the left visual point image (L image) input unit 101, the parallax information (left) from the parallax estimating unit 103, and the output phase position from the visual point position adjusting unit 161 are input to the left image synthesizing unit 181. The left image synthesizing unit 181 generates the virtual visual point image corresponding to the output phase position, on the basis of the parallax information (left), using the input L image, and outputs the virtual visual point image to the selecting unit 183.

The R image from the right visual point image (R image) input unit 102, the parallax information (right) from the parallax estimating unit 103, and the output phase position from the visual point position adjusting unit 161 are input to the right image synthesizing unit 182. The right image synthesizing unit 182 generates the virtual visual point image corresponding to the output phase position, on the basis of the parallax information (right), using the input R image, and outputs the virtual visual point image to the selecting unit 183.

The interpolation direction from the visual point position adjusting unit 161, the virtual visual point image generated using the L image from the left image synthesizing unit 181, and the virtual visual point image generated using the R image from the right image synthesizing unit 182 are input to the selecting unit 183.

The selecting unit 183 selects the virtual visual point image generated using the image of the direction corresponding to the interpolation direction from the visual point position adjusting unit 161 and outputs the virtual visual point image as a synthesis image to the display control unit 106 of the rear step.

### [Processing Example of Image Processing Apparatus]

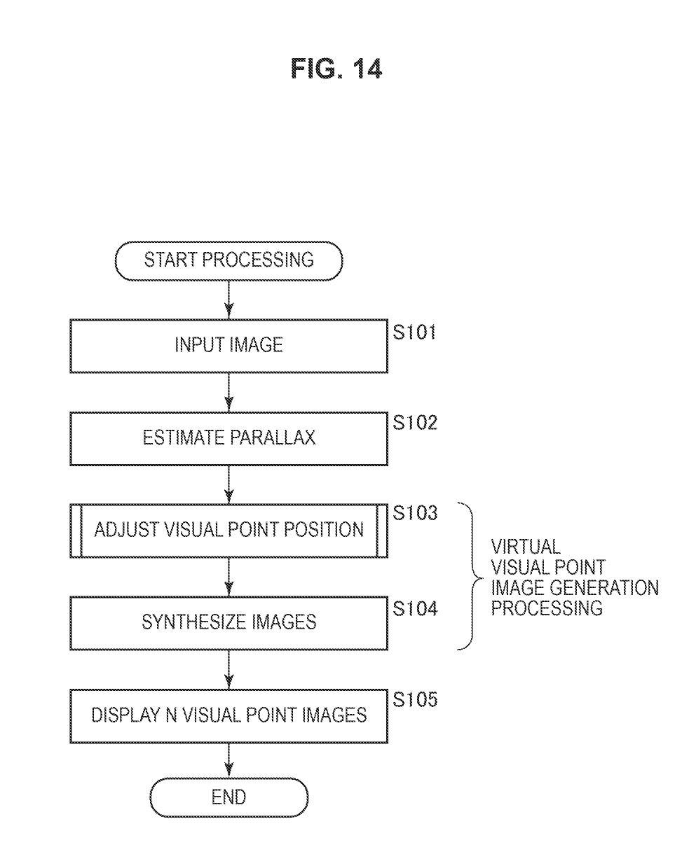

Next, image processing of the image processing apparatus 100 of FIG. 2 will be described with reference to a flowchart of FIG. 14.

In step S101, the left visual point image (L image) input unit 101 and the right visual point image (R image) input unit 102 input the left visual point image (L image) and the right visual point image (R image), respectively.

The input left visual point image (L image) and right visual point image (R image) are supplied to the parallax estimating unit 103 and the virtual visual point image generating unit 105.

In step S102, the parallax estimating unit 103 estimates the parallax using the supplied left visual point image (L image) and right visual point image (R image), as described above with reference to FIGS. 3 and 4. The parallax information of the estimation result by the parallax estimating unit 103 is supplied to the virtual visual point image generating unit 105.

In steps S103 and S104, the virtual visual point image generating unit 105 executes the virtual visual point image generation processing.

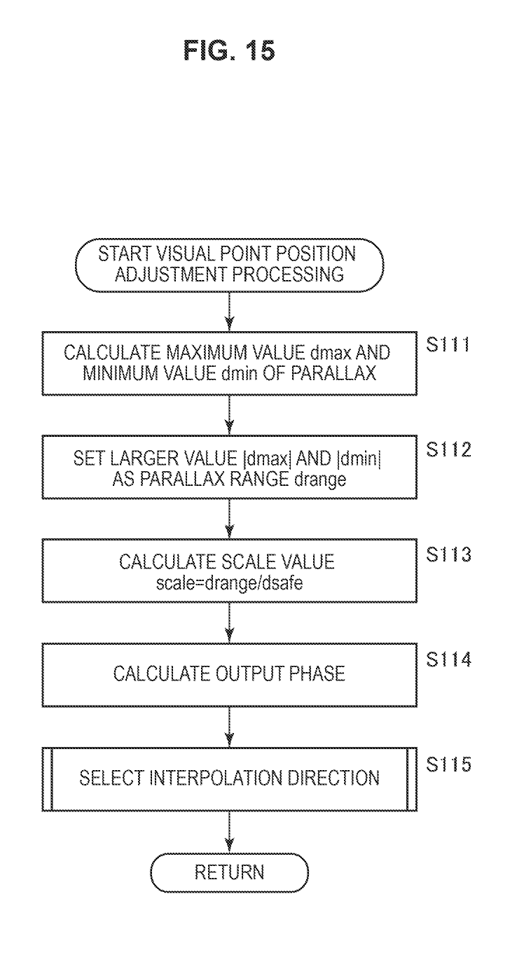

That is, in step S103, the visual point position adjusting unit 161 adjusts the visual point position. The visual point position adjustment processing is described below with reference to FIG. 15. The information of the output phase positions of the N visual points and the information of the interpolation directions of the N visual points are generated by step S103 and are supplied to the image synthesizing unit 162.

The L image from the left visual point image (L image) input unit 101, the R image from the right visual point image (R image) input unit 102, and the parallax information from the parallax estimating unit 103 are input to the image synthesizing unit 162.

In step S104, the image synthesizing unit 162 synthesizes the LR images with the image of the adjusted visual point position, on the basis of the input information.

That is, as described above with reference to FIGS. 12 and 13, the image synthesizing unit 162 generates the virtual visual point image corresponding to the output phase position, on the basis of the parallax information, using the input L image and the input R image. The one visual point image synthesizing unit 171 selects the virtual visual point image generated using the image of the direction (the left or the right) corresponding to the interpolation direction and outputs the virtual visual point image as the synthesis image to the display control unit 106 of the rear step.

In step S105, the display control unit 106 displays the N visual point images on the display unit 110.

### [Example of Visual Point Position Adjustment Processing]

Next, an example of the visual point position adjustment processing in step S103 of FIG. 14 will be described with reference to a flowchart of FIG. 15. In the example of FIG. 15, the visual point position is converged into the right, when the scale value is 0.

In step S111, the visual point position adjusting unit 161 calculates the maximum value dmax of the parallax and the minimum value dmin of the parallax, on the basis of the histogram of the parallax.

In step S112, the visual point position adjusting unit 161 sets a larger value of |dmax| and |dmin| as a parallax range drange. In step S113, the visual point position adjusting unit 161 calculates the scale value scale=drange/dsafe.

In step S114, the visual point position adjusting unit 161 calculates the output phase on the basis of the scale value, as described above with reference to FIG. 10. The output phase position that is calculated by the processing of step S114 is output to the image synthesizing unit 162.

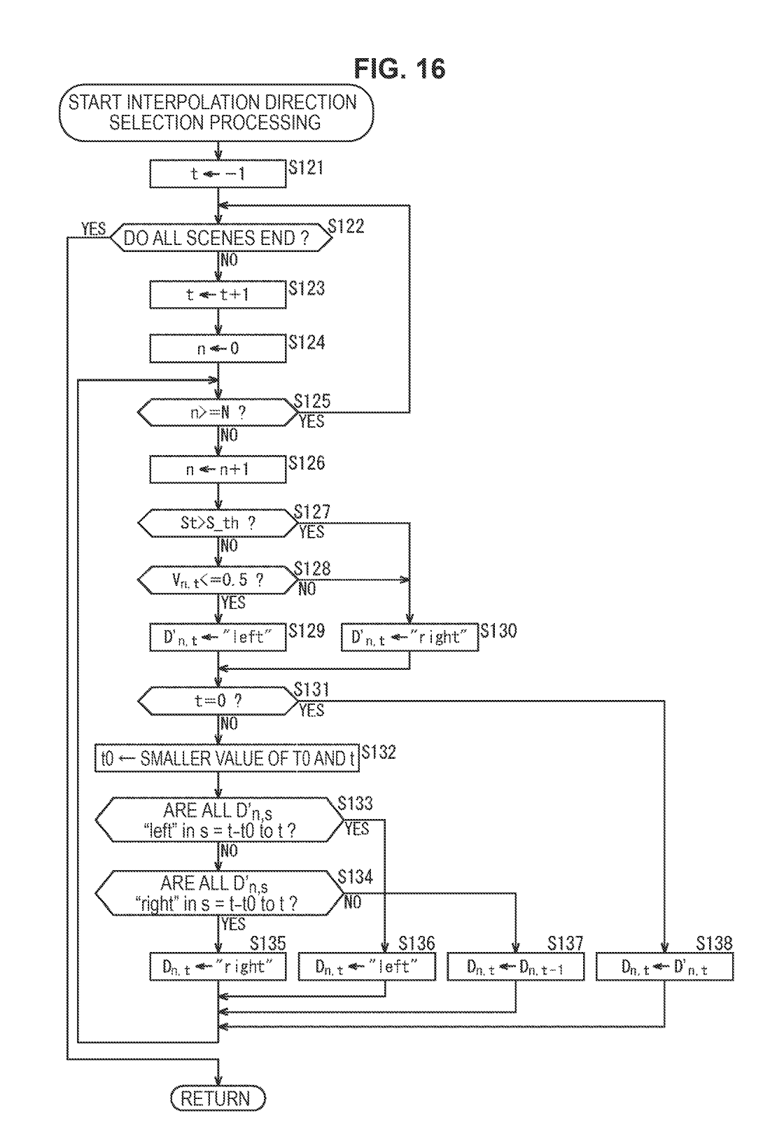

In step S115, the visual point position adjusting unit 161 executes the selection processing of the interpolation direction described above with reference to FIG. 11. The selection processing of the interpolation direction will be described with reference to a flowchart of FIG. 16.

In this case, n shows a visual point number, N shows the total number of visual points, St shows a scale value, S_th shows a threshold value (parameter), t shows a time (frame), t0 shows a certain time (parameter), Vn,t shows a visual point phase, Dn,t shows an interpolation direction, and D′n,t shows a temporary interpolation direction.

In step S121, the visual point position adjusting unit 161 substitutes −1 for t. In step S122, the visual point position adjusting unit 161 determines whether all scenes end. When it is determined that all of the scenes end, the visual point position adjusting unit 161 ends the interpolation direction selection processing.

When it is determined in step S122 that all of the scenes do not end, the processing proceeds to step S123. In step S123, the visual point position adjusting unit 161 substitutes t+1 for t. In step S124, the visual point position adjusting unit 161 substitutes 0 for n.

In step S125, the visual point position adjusting unit 161 determines whether n is equal to or more than N. When it is determined that n is equal to or more than N, the processing returns to step S122 and the following processing is repeated.

When it is determined in step S125 that n is smaller than N, the processing proceeds to step S126. In step S126, the visual point position adjusting unit 161 substitutes n+1 for n. In step S127, the visual point position adjusting unit 161 determines whether St is more than S_th. When it is determined in step S127 that St is equal to or smaller than S_th, the processing proceeds to step S128.

In step S128, the visual point position adjusting unit 161 determines whether Vn,t is equal to or smaller than 0.5. When it is determined that Vn,t is equal to smaller than 0.5, the processing proceeds to step S129 and the visual point position adjusting unit 161 substitutes “left” for D′n,t. That is, in step S129, the left is set to the temporary interpolation direction.

When it is determined in step S127 that St is more than S_th, the processing proceeds to step S130. When it is determined in step S128 that Vn,t is more than 0.5, the processing proceeds to step S130.

In step S130, the visual point position adjusting unit 161 substitutes “right” for D′n,t. That is, in step S130, the right is set to the temporary interpolation direction.

In step S131, the visual point position adjusting unit 161 determines whether t is 0. When it is determined that t is not 0, the processing proceeds to step S132. In step S132, the visual point position adjusting unit 161 substitutes a smaller value of T0 and t for t0.

In step S133, the visual point position adjusting unit 161 determines whether all D′n,s are “left” in s=t−t0 to t. When it is determined in step S133 that all D′n,s are not “left” in s=t−t0 to t, the processing proceeds to step S134.

In step S134, the visual point position adjusting unit 161 determines whether all D′n,s are “right” in s=t−t0 to t. When it is determined in step S134 that all D′n,s are “right” in s=t−t0 to t, the processing proceeds to step S135. In step S135, the visual point position adjusting unit 161 substitutes “right” for Dn,t. That is, in step S135, the right is set to the interpolation direction.

When it is determined in step S133 that all D′n,s are “left”, the processing proceeds to step S136. In step S136, the visual point position adjusting unit 161 substitutes “left” for Dn,t. That is, in step S136, the left is set to the interpolation direction.

When it is determined in step S134 that all D′n,s are not “right” in s=t−t0 to t, the processing proceeds to step S137. In step S137, the visual point position adjusting unit 161 substitutes Dn,t−1 for Dn,t. That is, in step S137, an interpolation direction of a previous frame is set to the interpolation direction.

Meanwhile, when it is determined in step S131 that t is 0, the processing proceeds to step S138. In step S138, the visual point position adjusting unit 161 substitutes D′n,t for Dn,t. That is, in step S138, the temporary interpolation direction is set to the interpolation direction.

In an example of FIG. 16, the processing after step S131 is the time stabilization processing.

As described above, because the interpolation direction is set according to the scale value (parallax range), changing of the interpolation direction when mismatching of the left and right images is large can be prevented.

Because the time stabilization processing is executed, the changing of the interpolation direction can be suppressed from being frequently generated. That is, the time variation of the high frequency of the interpolation direction and the variations at different timings of both eyes of the left and right eyes can be suppressed.

### 3. Second Embodiment

### Reliability

### [Configuration Example of Image Processing Apparatus]

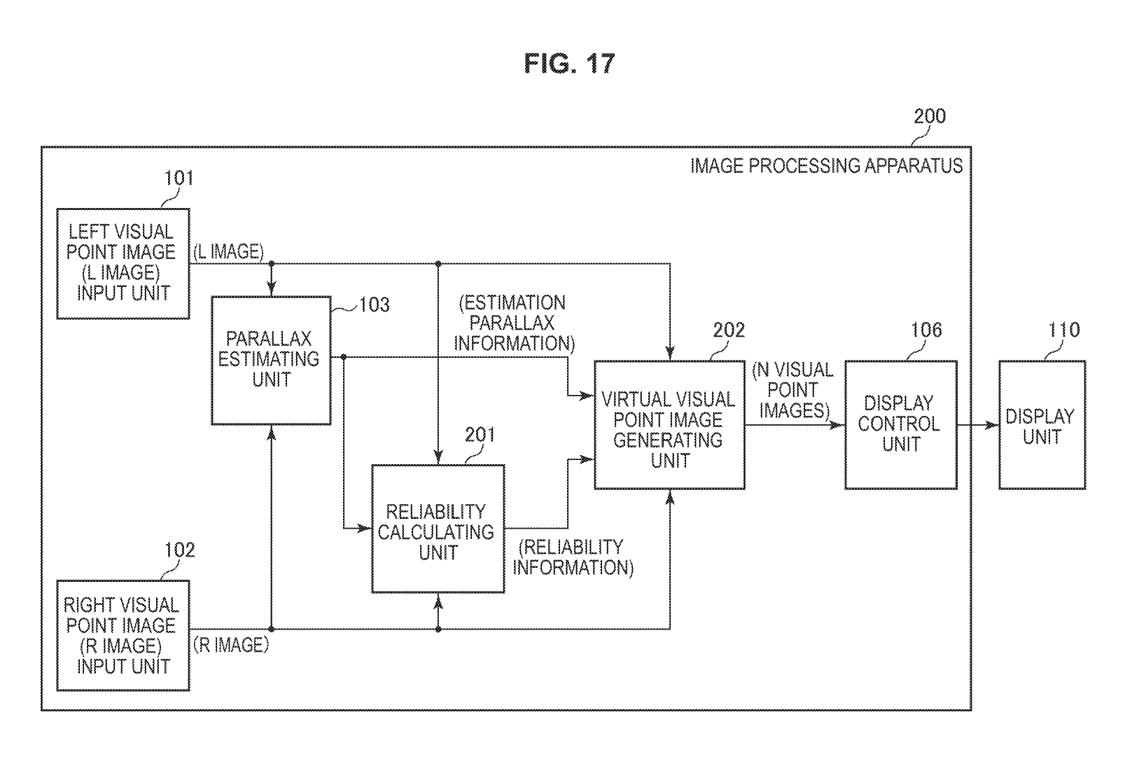

FIG. 17 is a block diagram illustrating another configuration example of an image processing apparatus to which the present disclosure is applied. In the example of FIG. 17, instead of the scale value described above with reference to FIG. 9, reliability is calculated as a parameter showing a degree of a variation (in this case, a time variation) based on the parallax information and visual point position adjustment processing is executed according to the variation shown by the reliability.

In the example of FIG. 17, an image processing apparatus 200 includes a left visual point image (L image) input unit 101, a right visual point image (R image) input unit 102, a parallax estimating unit 103, a reliability calculating unit 201, a virtual visual point image generating unit 202, and a display control unit 106. An image that is generated in the image processing apparatus 200 is output to the display unit 110.

The image processing apparatus 200 of FIG. 17 is the same as the image processing apparatus 100 of FIG. 2 in that the left visual point image (L image) input unit 101, the right visual point image (R image) input unit 102, the parallax estimating unit 103, and the display control unit 106 are provided. However, the image processing apparatus 200 of FIG. 17 is different from the image processing apparatus 100 of FIG. 2 in that the reliability calculating unit 201 is additionally provided and the virtual visual point image generating unit 105 is replaced by the virtual visual point image generating unit 202.

That is, an L image from the left visual point image (L image) input unit 101, an R image from the right visual point image input unit (R image) input unit 102, and parallax information from the parallax estimating unit 103 are supplied to the reliability calculating unit 201.

The reliability calculating unit 201 calculates reliability of parallax information of each pixel unit or each pixel region unit that is estimated by the parallax estimating unit 103 on the basis of the input LR images. The reliability calculating unit 201 supplies information of the calculated reliability to the virtual visual point image generating unit 202.

The virtual visual point image generating unit 202 executes determination processing of a virtual visual point position, according to reliability information input from the reliability calculating unit 201, and generates a virtual visual point image corresponding to the determined virtual visual point position.

The virtual visual point image generating unit 105 executes generation processing of the virtual visual point image based on the reliability information. That is, a total of N visual point images that are obtained by adding the other visual point images to the two visual point images of the input LR images are generated and output. For example, the virtual visual point image generating unit 105 calculates output phases corresponding to the N visual points, selects an interpolation direction according to the reliability information, and generates a virtual visual point image of the selected interpolation direction. This processing will be described in detail below.

### [Processing of Reliability Calculating Unit]

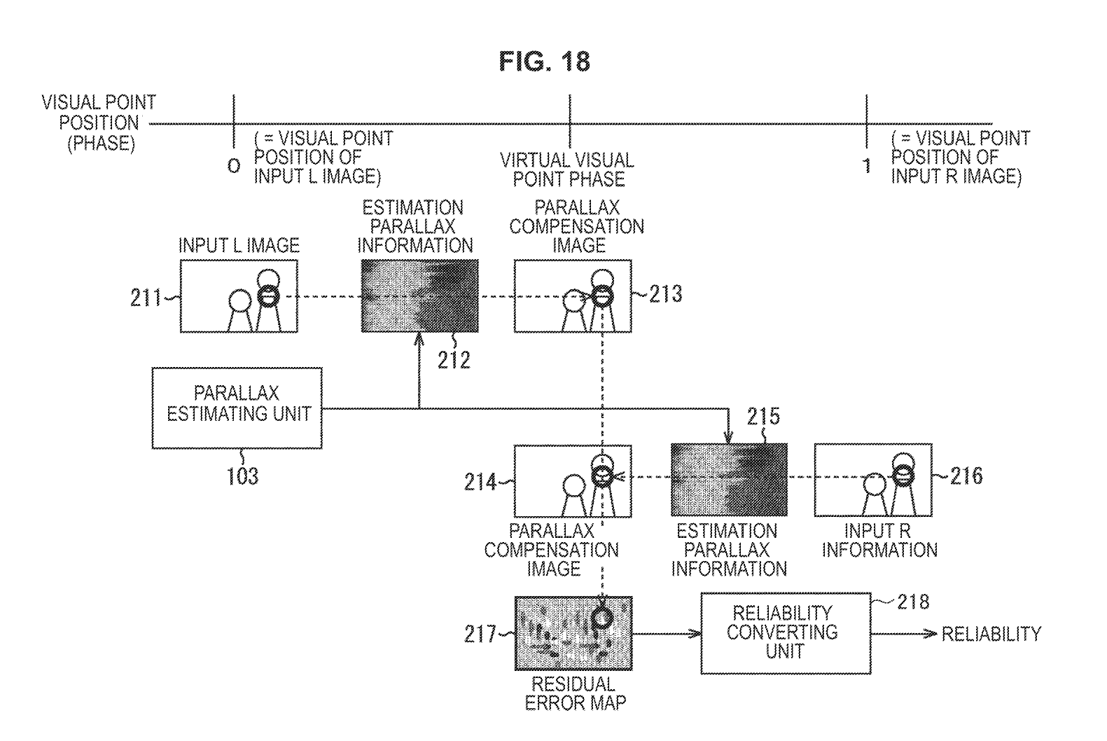

The processing of the reliability calculating unit 201 will be described with reference to FIG. 18.

First, the reliability calculating unit 201 applies estimation parallax information 212 of a pixel unit input from the parallax estimating unit 103 to an L image 211 input from the left visual point image (L image) input unit 101 and generates a parallax compensation image 213.

The estimation parallax information 212 is called a parallax map and is image data in which parallax information generated by the parallax estimating unit 103 is expressed with brightness. The parallax map is an image in which parallax (object distance) is expressed by brightness of a pixel unit. For example, a high-brightness region shows a close object (object close to the camera) and a low-brightness region shows a remote object (object remote from the camera). That is, the parallax map is an image in which the object distance is shown by the brightness.

The parallax compensation image 213 is a virtual visual point image in a virtual visual point phase that is generated by applying the estimation parallax information 212 of the pixel unit input from the parallax estimating unit 103 to the L image 211.

Next, the reliability calculating unit 201 applies estimation parallax information 215 of a pixel unit input from the parallax estimating unit 103 to an R image 216 input from the right visual point image (R image) input unit 102 and generates a parallax compensation image 214.

The estimation parallax information 215 is called a parallax map and is image data in which parallax information generated by the parallax estimating unit 103 is expressed with brightness. The parallax map is an image in which parallax (object distance) is expressed by brightness of a pixel unit. For example, a high-brightness region shows a close object (object close to the camera) and a low-brightness region shows a remote object (object remote from the camera). That is, the parallax map is an image in which the object distance is shown by the brightness.

The parallax compensation image 214 is a virtual visual point image in a virtual visual point phase that is generated by applying the estimation parallax information 215 of the pixel unit input from the parallax estimating unit 103 to the R image 216.

If the estimation parallax information 212 and the estimation parallax information 215 of the pixel unit generated by the parallax estimating unit 103 are corrected, the parallax compensation image 213 generated by applying the estimation parallax information 212 and the parallax compensation image 214 generated by applying the estimation parallax information 215 are matched with each other.

In actuality, however, estimation error is included in the estimation parallax information 212 and the estimation parallax information 215 generated by the parallax estimating unit 103 and a difference is generated in the parallax compensation image 213 generated on the basis of the L image 211 and the parallax compensation image 214 generated on the basis of the R image 216.

A map in which a pixel value difference of correspondence pixel units of the parallax compensation image 213 and the parallax compensation image 214 is calculated in a pixel unit, that is, a residual error map 217 illustrated in FIG. 18 is generated. The residual error map 217 is a map in which the pixel value difference of the correspondence pixel units of the parallax compensation image 213 and the parallax compensation image 214 is expressed with shading information. For example, a black portion shows a portion in which the difference is large.

In the example of FIG. 18, the reliability calculating unit 201 includes a reliability converting unit 218 that compares residual error to be a difference of a pixel unit from the residual error map 217 and a preset threshold value (Th) and counts the number of pixels having the residual error more than the threshold value (Th). The reliability converting unit 218 sets a count value as N and determines reliability R of the estimation parallax information generated by the parallax estimating unit 103, according to a value of N.

That is, when the number N of pixels having the residual error more than the threshold value (Th) is large, the reliability converting unit 218 determines that the reliability R of the estimation parallax information generated by the parallax estimating unit 103 is low. Meanwhile, when the number N of pixels having the residual error more than the threshold value (Th) is small, the reliability converting unit 218 determines that the reliability R of the estimation parallax information generated by the parallax estimating unit 103 is high.

The threshold value (Th) can be changed according to a region of an image. For example, the threshold value decreases in a flat region and the threshold value increases in a region having a texture or an edge.

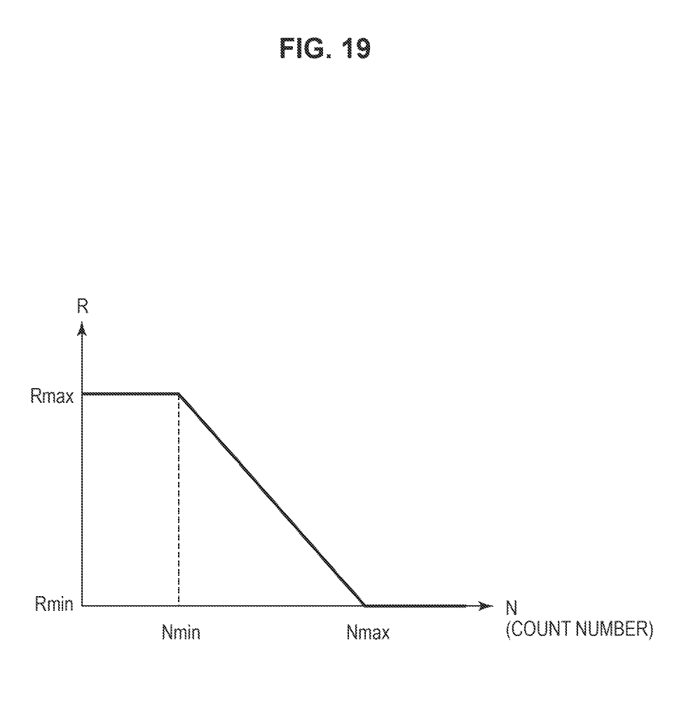

A correspondence relation of the number N of pixels having the residual error more than the threshold value (Th) and the reliability R of the estimation parallax information generated by the parallax estimating unit 103 is specifically prescribed as a correspondence relation illustrated in FIG. 19.

That is, the reliability converting unit 218 calculates a value of the reliability R of the estimation parallax information generated by the parallax estimating unit 103, according to a value of the number N of pixels having the residual error more than the threshold value (Th), as represented by the following expression 3.

0≦N≦Nmin:Reliability R=Rmax

Nmin≦N≦Nmax:Reliability R=Rmax to Rmin

Nmax≦N:Reliablity R=Rmin [Expression 3]

In this case, prescribed values are used as the values of Nmin, Nmax, Rmin, and Rmax. In a range of Nmin≦N≦Nmax, the reliability R linearly changes between Rmax and Rmin.

The example of the case in which the parallax compensation image is generated from the parallax information has been described. However, the visual point compensation image may be acquired from the virtual visual point image generating unit 202. The processing described above may be executed with respect to all of a plurality of virtual visual points and a result of one virtual visual point phase (for example, a result at a right visual point position) may be used in the other visual points. These may be selected.

In the processing described with reference to FIGS. 18 and 19, the reliability calculation processing of the estimation parallax based on the residual error component to which the estimation parallax information of the pixel unit input from the parallax estimating unit 103 is applied is executed. Meanwhile, even when the virtual visual point image in which there remains error of the estimation parallax, that is, the residual error component is generated, the residual error component may be conspicuous or rarely conspicuous according to features (antecedents) of each region of the image. Therefore, when the reliability determination based on the residual error component is performed, different processing may be executed according to the feature of each region of the image.

Specifically, when the virtual visual point image in which there remains the residual error component is generated, an influence with respect to the image by the residual error component, that is, the deviation of the estimation parallax increase in a texture region and error becomes conspicuous when the image is observed. Meanwhile, the influence with respect to the image by the residual error component, that is, the deviation of the estimation parallax decreases in a flat region and error is inconspicuous when the image is observed.

In consideration of the above circumstances, the features (antecedents) of the region of the image may be detected and a derivation method of the residual error component may be adaptively changed according to the detected features of the image region unit. For example, a feature amount such as a space activity and a dynamic range may be detected as a feature amount of the image region.

The reliability that is calculated according to the residual error component is adaptively changed according to the feature amount of the image region unit. Specifically, processing for changing various parameters used for the reliability calculation processing described above with reference to FIG. 19 according to the feature amount of the image region unit is executed. As the parameters, Nmin, Nmax, Rmin, and Rmax to be parameters shown in a graph of FIG. 19 and the threshold value (Th) described above with reference to FIG. 18 are exemplified.

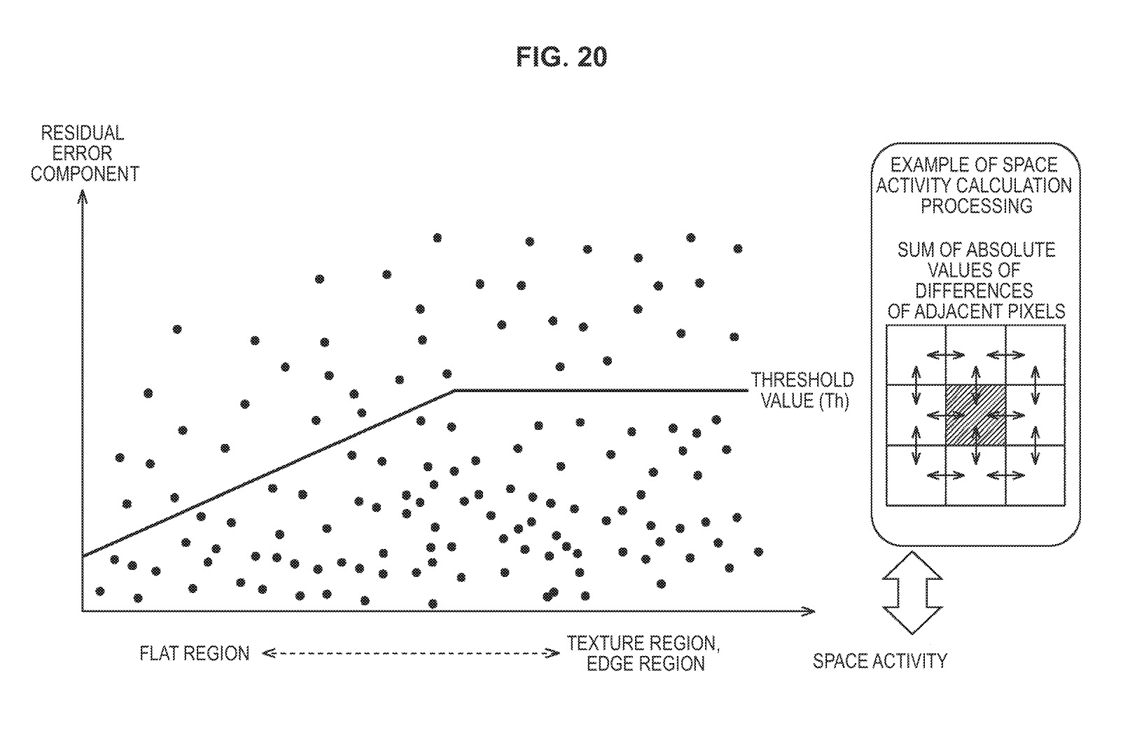

A specific example will be described with reference to FIG. 20. FIG. 20 is a diagram illustrating an example of the case in which space activity functioning as the feature amount of the pixel unit is detected with respect to the image, for example, the input L image, the threshold value (Th) described above with reference to FIG. 18 is changed according to a value of the space activity, and a count value (N) functioning as an index of the residual error component is changed.

The space activity is calculated as a total sum of absolute values of differences of pixel values between adjacent pixels in a pixel region (for example, 3×3 pixels) based on an attention pixel, as illustrated in FIG. 20 (an example of space activity calculation processing). It can be determined that a region in which a value of the total sum of the absolute values of the differences of the pixel values is large is the texture region (edge region) and a region in which the value is small is the flat region.

In a graph illustrated in FIG. 20, a horizontal axis shows the space activity, a vertical axis shows the residual error component, and individual points correspond to values of the space activity and the residual error component of the individual pixels. In this case, the threshold value (Th) described above with reference to FIG. 18, that is, the threshold value (Th) to regulate whether or not to be included as the count value of the count number N to determine that there is the residual error is changed according to the space activity of the image region. By performing the setting described above, the reliability calculation according to the features of each region of the image is performed.

The processing example described with reference to FIG. 20 is a processing example to which the space activity functioning as the feature amount of the image region is applied. As the feature amount of the image region, the dynamic range may be applied.

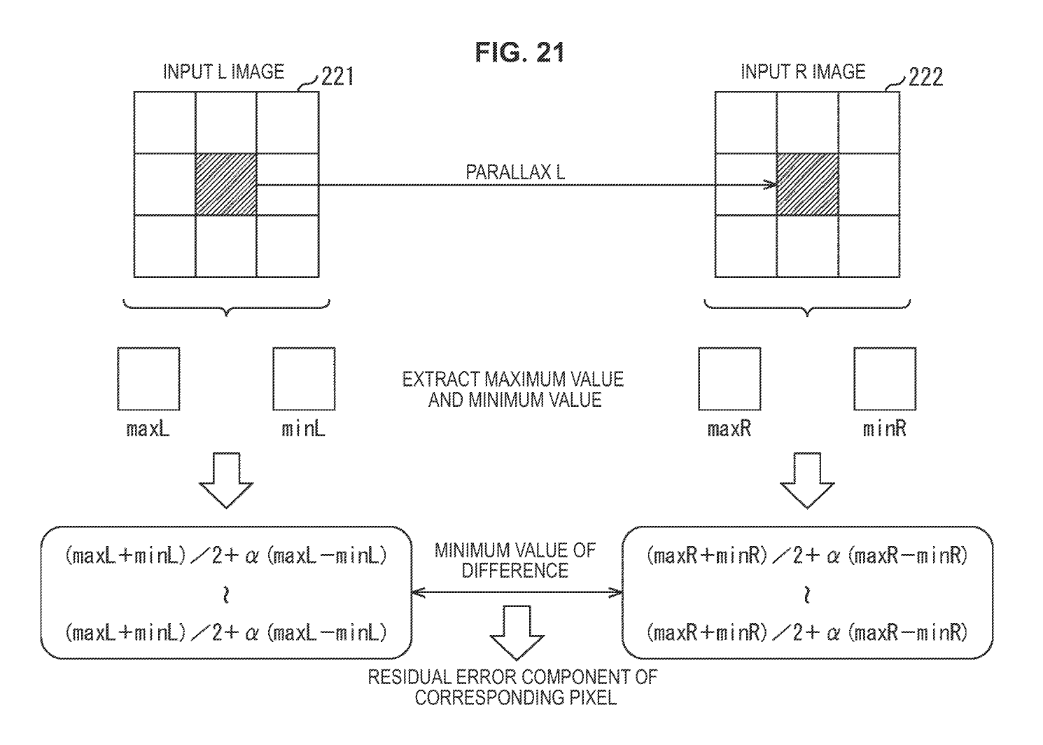

An example of the case in which the dynamic range is acquired as the feature amount of the image region and a processing aspect is changed on the basis of a value of the dynamic range will be described with reference to FIG. 21.

FIG. 21 illustrates two image regions that are input from the left visual point image (L image) input unit 101 and the right visual point image (R image) input unit 102. That is, an image region 221 of 3×3 pixels based on an attention pixel of the input L image and an image region 222 of 3×3 pixels based on an attention pixel of the input R image are illustrated.

The image regions are correspondence blocks that are extracted as corresponding pixel blocks by the parallax estimation processing in the parallax estimating unit 103. That is, if the parallax estimation is correct, images of the same object are imaged in the two pixel blocks.

First, a pixel value (maxL) of a pixel having a maximum pixel value (brightness value) and a pixel value (minL) of a pixel having a minimum pixel value (brightness value) are acquired from nine pixels included in the image region 221 of 3×3 pixels based on the attention pixel of the input L image.

Likewise, a pixel value (maxR) having a maximum pixel value (brightness value) and a pixel value (minR) having a minimum pixel value (brightness value) are acquired from nine pixels included in the image region 222 of 3×3 pixels based on the attention pixel of the input R image.

A calculation value (Lx) using an intermediate value of the pixel value of the pixel block of the L image and the dynamic range and a calculation value (Rx) using an intermediate value of the pixel value of the pixel block of the R image and the dynamic range are calculated as represented by the following expressions 4 and 5.

Lx=(maxL+minL)/2+α(maxL−minL)˜(maxL+minL)/2−α(maxL−minL) [Expression 4]

Rx=(maxR+minR)/2+α(maxR−minR)˜(maxR+minR)/2−α(maxR−minR) [Expression 5]

In this case, (maxL+minL)/2 corresponds to the intermediate value of the pixel value of the pixel block of the L image and (maxL−minL) corresponds to the dynamic range of the pixel value of the pixel block of the L image. In addition, (maxR+minR)/2 corresponds to the intermediate value of the pixel value of the pixel block of the R image and (maxR−minR) corresponds to the dynamic range of the pixel value of the pixel block of the R image. α is a coefficient.

A minimum value of the difference of Lx and Rx is calculated and the difference becomes the residual error component of the attention pixel. At this time, the minimum value of the difference of Lx and Rx changes according to the dynamic range of each pixel block. As a result, the residual error component that is calculated according to the dynamic range of the pixel block unit is adaptively adjusted.

The reliability calculation according to the value of the dynamic range of each region of the image can be performed using the dynamic range as the feature amount of the image region.

### [Configuration of Virtual Visual Point Image Generating Unit]

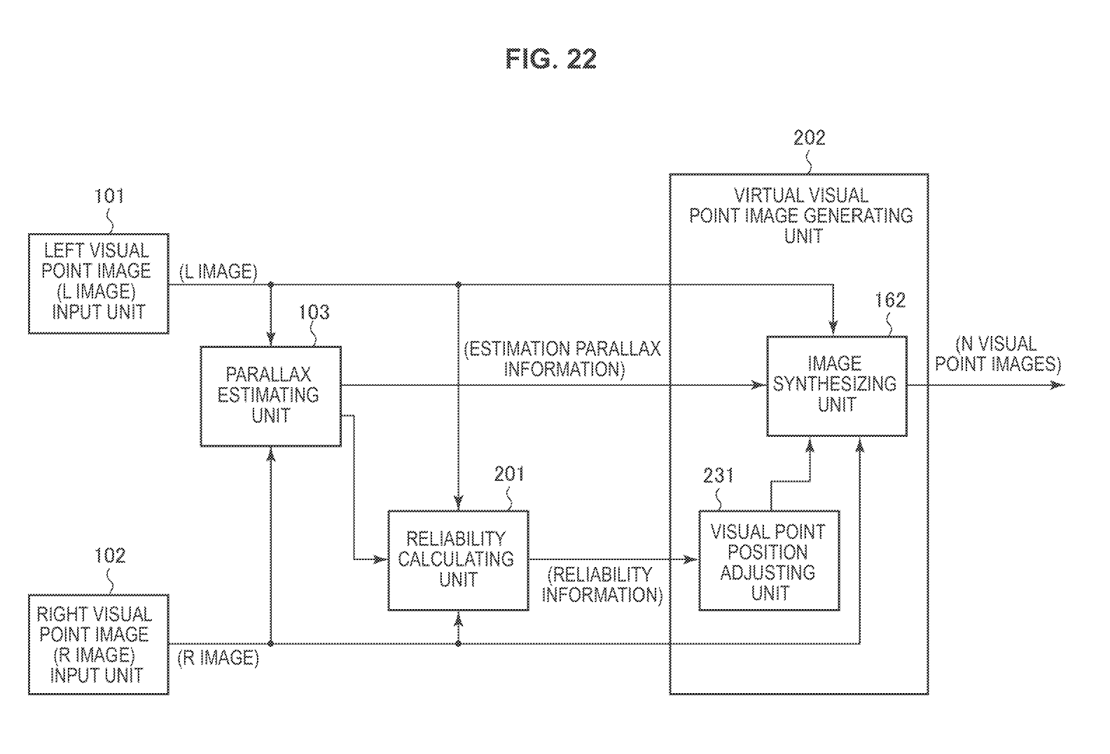

FIG. 22 is a diagram illustrating a configuration example of the virtual visual point image generating unit 202.

In the example of FIG. 22, the virtual visual point image generating unit 202 includes a visual point position adjusting unit 231 and an image synthesizing unit 162. The virtual visual point image generating unit 202 of FIG. 22 is different from the virtual visual point image generating unit 105 of FIG. 8 in that the visual point position adjusting unit 161 is replaced by the visual point position adjusting unit 231.

That is, reliability information is supplied from the reliability calculating unit 201 to the visual point position adjusting unit 231. The visual point position adjusting unit 231 adjusts a parallax amount on the basis of the reliability information from the reliability calculating unit 201 and determines a virtual visual point position (phase) and an interpolation direction. The visual point position adjusting unit 161 supplies information of the determined virtual visual point position and information of the determined interpolation direction to the image synthesizing unit 162.

The L image from the left visual point image (L image) input unit 101, the R image from the right visual point image (R image) input unit 102, the parallax information from the parallax estimating unit 103, and the information of the virtual visual point position and the interpolation direction from the visual point position adjusting unit 161 are input to the image synthesizing unit 162.

The image synthesizing unit 162 synthesizes the LR images with the image of the adjusted visual point position, on the basis of the input information, and outputs the synthesized N visual point images to the display control unit 106 of the rear step.

### [Calculation Processing of Output Phase]

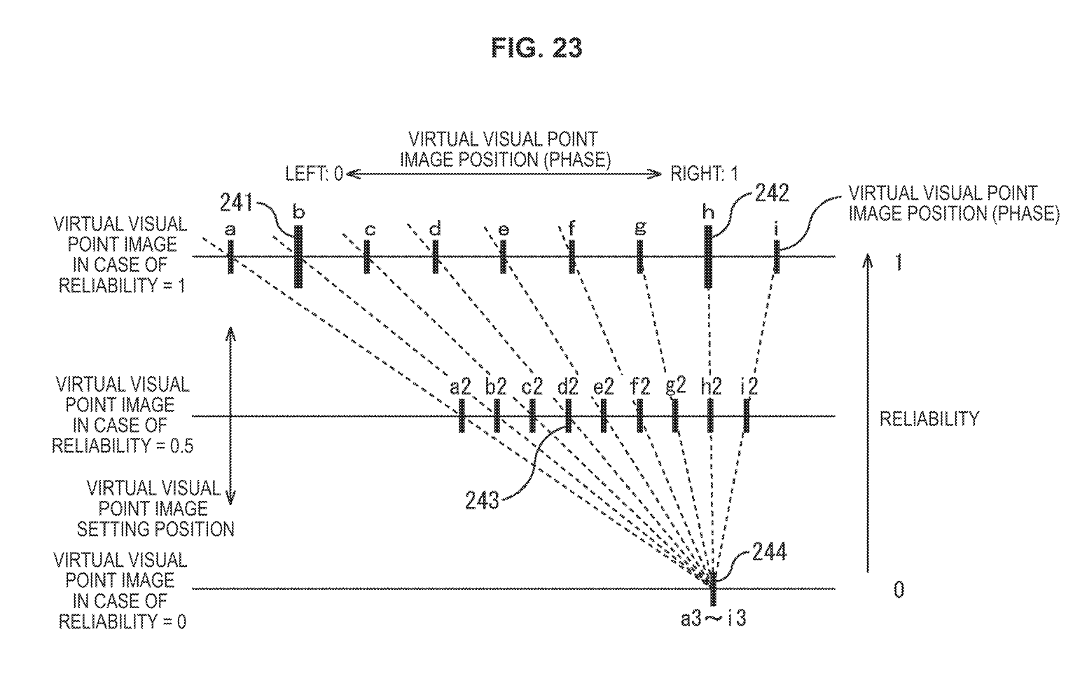

First, calculation processing of an output phase of the visual point position adjusting unit 161 will be described with reference to FIG. 23. The visual point position adjusting unit 231 determines parallax of a virtual visual point image to be generated, that is, a position (phase) of a generated virtual visual point image, according to the reliability from the reliability calculating unit 201.

Specifically, the visual point position adjusting unit 231 executes the determination processing of the virtual visual point position illustrated in FIG. 23, according to the reliability having a value of 0 to 1. If the value of the reliability is large, the reliability is high and if the value of the reliability is small, the reliability is low.

FIG. 23 is a diagram illustrating a setting example of the virtual visual point image position in the case of the reliability=0 to 1. A visual point position=0 is a visual point position corresponding to the input L image and a visual point position=1 is a visual point position corresponding to the input R image.

That is, an image 241 (image b) on a line of the reliability=1 corresponds to the input L image input from the left visual point image (L image) input unit 101 and an image 242 (image h) corresponds to the input R image input from the right visual point image (R image) input unit 102.

The other vertical lines on the line of the reliability=1 show positions (phases) of virtual visual point images generated in the virtual visual point image generating unit 202, when the reliability is 1. In this example, a total of nine different visual point images of a to i including the input LR images are generated and output.

In the case of the reliability=1, the visual point position adjusting unit 231 determines the images a to i at an upper stage of FIG. 23 as the setting positions of the virtual visual point images and outputs virtual visual point position information to the image synthesizing unit 162.

The generation processing of the virtual visual point image is executed according to the processing described above with reference to FIGS. 5 to 7.

In the case of the reliability=0.5, that is, a middle value, the visual point position adjusting unit 231 determines images 243 (images a2 to i2) at an middle stage of FIG. 23 as the setting positions of the virtual visual point images and outputs virtual visual point position information to the image synthesizing unit 162.

In the case of the middle reliability=0.5, as illustrated in FIG. 23, a parallax range of the virtual visual point images a2 to i2 becomes narrower than a parallax range of the virtual visual point images a to i in the case of the reliability=1.

In the case of the reliability=0, the visual point position adjusting unit 231 determines images 244 (images a3 to i3) at a lower stage of FIG. 23 as the setting positions of the virtual visual point images and outputs virtual visual point position information to the image synthesizing unit 162.

The image positions of the images a3 to i3 at the lower stage of FIG. 23 correspond to the image position of the input R image. That is, in this case, the input R image is output as it is without generating a new virtual visual point image. The virtual visual point image generating unit 202 outputs the input L image as it is and only the input L image is output to the display unit.

The visual point position adjusting unit 231 executes calculation processing of the setting position (phase) of the virtual visual point image according to the following algorithm.

The virtual visual point images that are generated in the case of the reliability R=1 are determined in advance. For example, the virtual visual point images are the virtual visual point images at the positions of a to i illustrated in FIG. 23. The calculated reliability is set as R (0≦R≦1). When an original visual point position is set as V0 and the visual point position is converged into the right at the reliability R=0, the virtual visual point image position (phase) V that is set according to the reliability R is represented by the following expression 6.

V=(V0−1)·R+1 [Expression 6]

### [Selection Processing of Interpolation Direction]

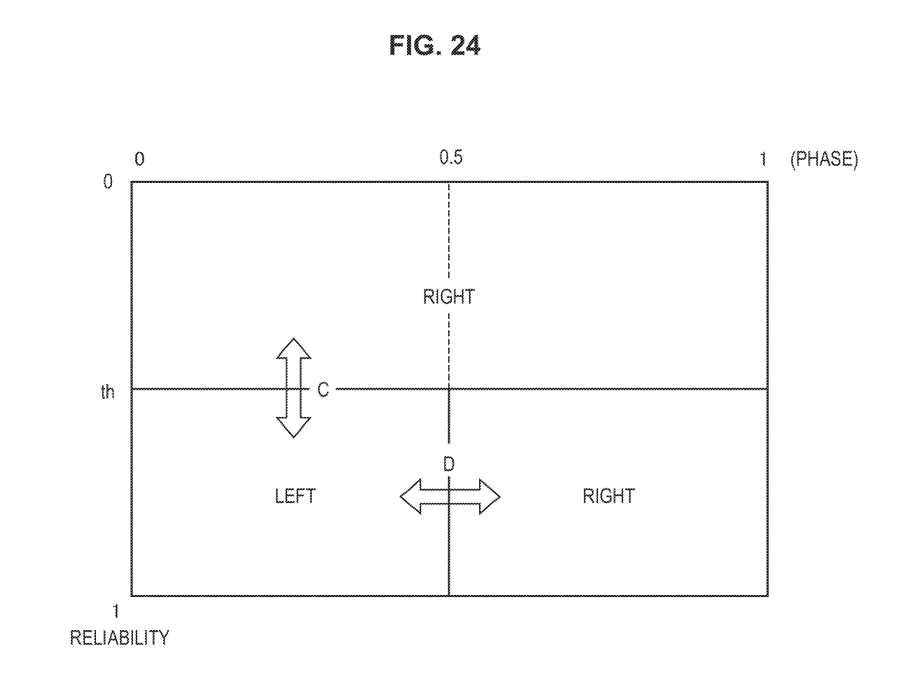

Next, selection processing of an interpolation direction of the visual point position adjusting unit 231 will be described with reference to FIG. 24. In an example of FIG. 24, a horizontal axis shows a phase and a vertical axis shows reliability R. In the example of FIG. 24, the case in which the position converged at the reliability R=0 is right (1) will be described.

The visual point position adjusting unit 231 selects an interpolation direction, according to the reliability. At this time, as described above, when the reliability is large, the mismatching of left and right images is small. For this reason, the visual point position adjusting unit 231 sets the right as a temporary interpolation direction, when the reliability is smaller than a predetermined threshold value. That is, in this case, the visual point position adjusting unit 231 prohibits changing of the interpolation direction to the left.

Meanwhile, in the case in which the reliability is equal to or more than the predetermined threshold value, the visual point position adjusting unit 231 sets the temporary interpolation direction, such that the interpolation is performed from an image of the close side. That is, when a visual point phase is 0.5 or less, the visual point position adjusting unit 231 sets the left as the temporary interpolation direction and when the visual point phase is more than 0.5, the visual point position adjusting unit 231 sets the right as the temporary interpolation direction. In this case, the visual point position adjusting unit 231 performs the changing of the interpolation direction (permits the changing of the interpolation direction).

Thereby, the changing of the interpolation direction when the mismatching of the left and right images is large can be prevented.

The visual point position adjusting unit 231 executes time stabilization processing, similar to the visual point position adjusting unit 161 described above with reference to FIG. 11. That is, when the temporary interpolation direction is the left for a constant time, the visual point position adjusting unit 231 sets the interpolation direction as the left and when the temporary interpolation direction is the right for the constant time, the visual point position adjusting unit 231 sets the interpolation direction as the right. In the other cases, the visual point position adjusting unit 231 sets the same direction as the previous frame to the interpolation direction.

In the case of a start frame, the temporary interpolation direction (close image) is set to the interpolation direction.

Thereby, the changing of the interpolation direction shown by an arrow C or D can be suppressed from being frequently generated. That is, the time variation of the high frequency of the interpolation direction and the variations at different timings of both eyes of the left and right eyes can be suppressed.

In the above description, the example of the case in which the position converged at the reliability R=0 is the right (1) has been described. However, the position converged at the reliability R=0 may be the left (0). When the position converged at the reliability R=0 is the left (0) and the reliability is smaller than the predetermined threshold value th, the left is set as the temporary interpolation direction.

### [Processing Example of Image Processing Apparatus]

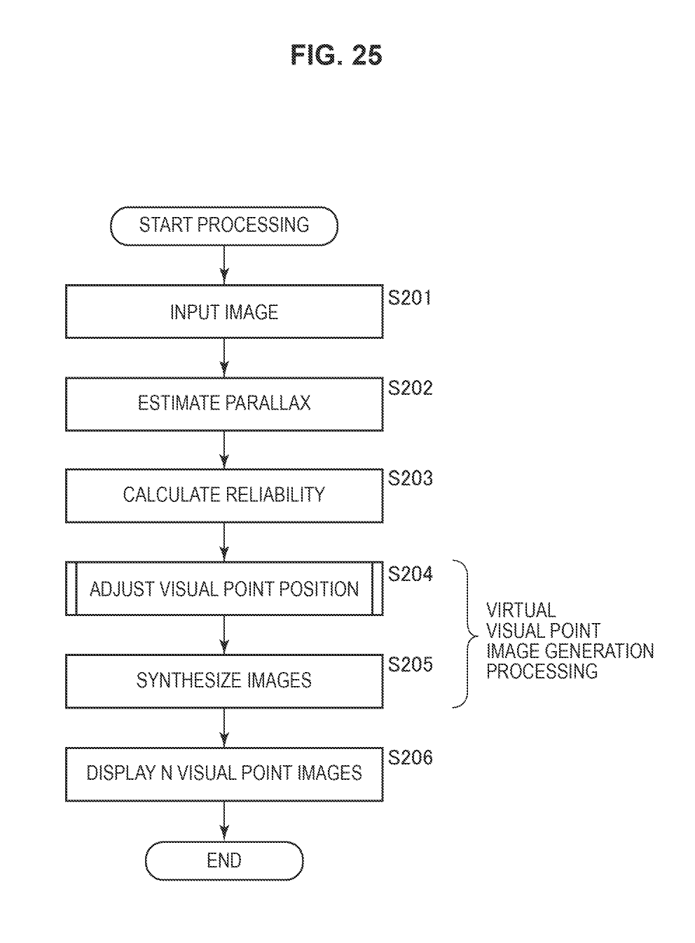

Next, image processing of the image processing apparatus 200 of FIG. 17 will be described with reference to a flowchart of FIG. 25. The processing of steps S201, S202, S205, and S206 of FIG. 25 is basically the same as the processing of steps S101, S102, S104, and S105 of FIG. 14.

In step S201, the left visual point image (L image) input unit 101 and the right visual point image (R image) input unit 102 input the left visual point image (L image) and the right visual point image (R image), respectively. The input left visual point image (L image) and right visual point image (R image) are supplied to the parallax estimating unit 103, the reliability calculating unit 201, and the virtual visual point image generating unit 202.

In step S202, the parallax estimating unit 103 estimates the parallax using the supplied left visual point image (L image) and right visual point image (R image), as described above with reference to FIGS. 3 and 4. The parallax information of the estimation result by the parallax estimating unit 103 is supplied to the reliability calculating unit 201 and the virtual visual point image generating unit 202.

In step S203, the reliability calculating unit 201 calculates the reliability of the parallax information of each pixel unit or each pixel region unit estimated by the parallax estimating unit 103 on the basis of the input LR images, as described above with reference to FIGS. 18 to 21. The reliability calculating unit 201 supplies information of the calculated reliability to the virtual visual point image generating unit 202.

In steps S204 and S205, the virtual visual point image generating unit 202 executes the virtual visual point image generation processing.

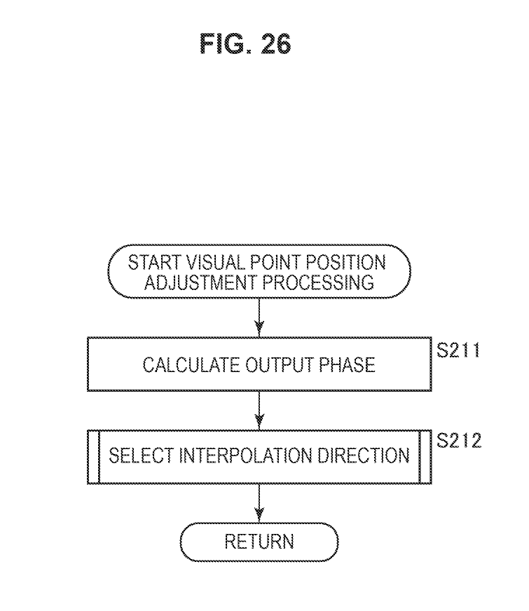

That is, in step S204, the visual point position adjusting unit 231 adjusts the visual point position. The visual point position adjustment processing is described below with reference to FIG. 26. The information of the output phase positions of the N visual points and the information of the interpolation directions of the N visual points are generated by step S204 and are supplied to the image synthesizing unit 162.

The L image from the left visual point image (L image) input unit 101, the R image from the right visual point image (R image) input unit 102, and the parallax information from the parallax estimating unit 103 are input to the image synthesizing unit 162.

In step S205, the image synthesizing unit 162 synthesizes the LR images with the image of the adjusted visual point position, on the basis of the input information.

That is, as described above with reference to FIGS. 12 and 13, the one visual point image synthesizing unit 171 of the image synthesizing unit 162 generates the virtual visual point image corresponding to the output phase position, on the basis of the parallax information, using the input L image and the input R image. The one visual point image synthesizing unit 171 selects the virtual visual point image generated using the image of the direction (the left or the right) corresponding to the interpolation direction and outputs the virtual visual point image as a synthesis image to the display control unit 106 of the rear step.

In step S206, the display control unit 106 displays the N visual point images on the display unit 110.

### [Example of Visual Point Position Adjustment Processing]

Next, an example of the visual point position adjustment processing in step S204 of FIG. 25 will be described with reference to a flowchart of FIG. 26. In the example of FIG. 26, the visual point position is converged into the right, when the reliability is 0.

In step S211, the visual point position adjusting unit 231 calculates the output phase on the basis of the reliability, as described above with reference to FIG. 23. The output phase position that is calculated by the processing of step S211 is output to the image synthesizing unit 162.

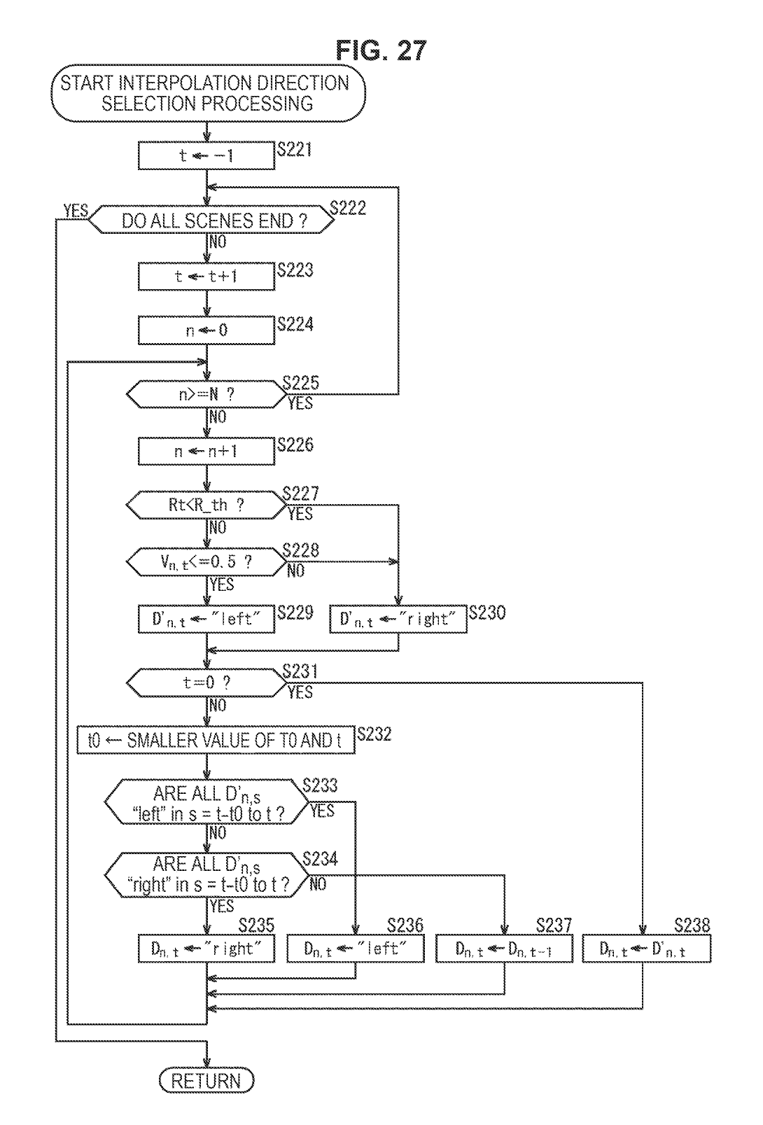

In step S212, the visual point position adjusting unit 231 executes the selection processing of the interpolation direction described above with reference to FIG. 24. The selection processing of the interpolation direction will be described with reference to a flowchart of FIG. 27.

In this case, n shows a visual point number, N shows the total number of visual points, Rt shows reliability, R_th shows a threshold value (parameter), t(0≦t≦T0) shows a time (frame), T0 shows a certain time (parameter), and t0 shows min(T0, t). In addition, Vn,t shows a visual point phase, Dn,t shows an interpolation direction, and D′n,t shows a temporary interpolation direction.

In step S221, the visual point position adjusting unit 231 substitutes −1 for t. In step S222, the visual point position adjusting unit 231 determines whether all scenes end. When it is determined that all scenes end, the visual point position adjusting unit 231 ends the interpolation direction selection processing.

In step S222, when it is determined that all scenes do not end, the processing proceeds to step S223. In step S223, the visual point position adjusting unit 231 substitutes t+1 for t. In step S224, the visual point position adjusting unit 231 substitutes 0 for n.

In step S225, the visual point position adjusting unit 231 determines whether n is equal to or more than N. When it is determined that n is equal to or more than N, the processing returns to step S222 and the following processing is repeated.

When it is determined in step S225 that n is smaller than N, the processing proceeds to step S226. In step S226, the visual point position adjusting unit 231 substitutes n+1 for n. In step S227, the visual point position adjusting unit 231 determines whether Rt is smaller than R_th. When it is determined in step S227 that Rt is equal to or more than R_th, the processing proceeds to step S228.

In step S228, the visual point position adjusting unit 231 determines whether Vn,t is equal to or smaller than 0.5. When it is determined that Vn,t is equal to smaller than 0.5, the processing proceeds to step S229 and the visual point position adjusting unit 231 substitutes “left” for D′n,t. That is, in step S229, the left is set to the temporary interpolation direction.

When it is determined in step S227 that Rt is smaller than R_th, the processing proceeds to step S230. When it is determined in step S228 that Vn,t is more than 0.5, the processing proceeds to step S230.

In step S230, the visual point position adjusting unit 231 substitutes “right” for D′n,t. That is, in step S230, the right is set to the temporary interpolation direction.

In step S231, the visual point position adjusting unit 231 determines whether t is 0. When it is determined that t is not 0, the processing proceeds to step S232. In step S232, the visual point position adjusting unit 231 substitutes a smaller value of T0 and t for t0.

In step S233, the visual point position adjusting unit 231 determines whether all D′n,s are “left” in s=t−t0 to t. When it is determined in step S233 that all D′n,s are not “left” in s=t−t0 to t, the processing proceeds to step S234.

In step S234, the visual point position adjusting unit 231 determines whether all D′n,s are “right” in s=t−t0 to t. When it is determined in step S234 that all D′n,s are “right” in s=t−t0 to t, the processing proceeds to step S235. In step S235, the visual point position adjusting unit 231 substitutes “right” for Dn,t. That is, in step S235, the right is set to the interpolation direction.

When it is determined in step S233 that all D′n,s are “left”, the processing proceeds to step S236. In step S236, the visual point position adjusting unit 231 substitutes “left” for Dn,t. That is, in step S236, the left is set to the interpolation direction.

When it is determined in step S234 that all D′n,s are not “right” in s=t−t0 to t, the processing proceeds to step S237. In step S237, the visual point position adjusting unit 231 substitutes Dn,t−1 for Dn,t. That is, in step S237, an interpolation direction of a previous frame is set to the interpolation direction.

Meanwhile, when it is determined in step S231 that t is 0, the processing proceeds to step S238. In step S238, the visual point position adjusting unit 231 substitutes D′n,t for Dn,t. That is, in step S238, the temporary interpolation direction is set to the interpolation direction.

In an example of FIG. 27, the processing after step S231 is the time stabilization processing.

As described above, because the interpolation direction is set according to the reliability, changing of the interpolation direction when mismatching of the left and right images is large can be prevented.

Because the time stabilization processing is executed, the changing of the interpolation direction can be suppressed from being frequently generated. That is, the time variation of the high frequency of the interpolation direction and the variations at different timings of both eyes of the left and right eyes can be suppressed.

### 4. Third Embodiment

### Motion Parallax

### [Example of Display Unit of Image Processing Apparatus]

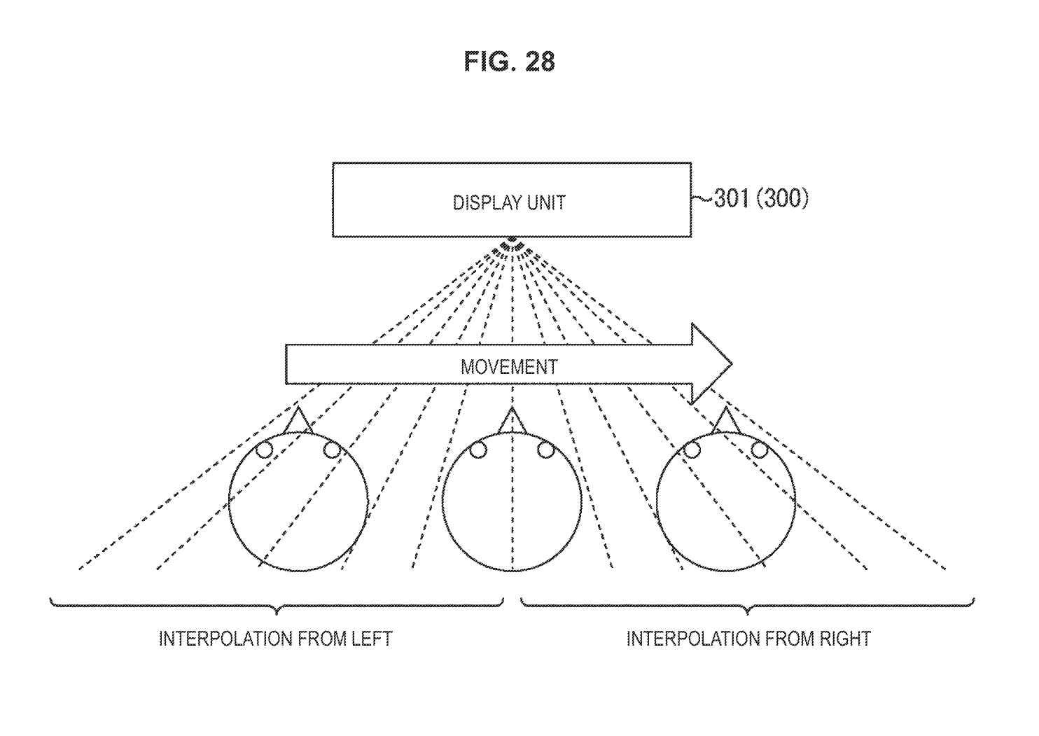

FIG. 28 is a diagram illustrating a configuration example of an image processing apparatus to which the present disclosure is applied.

In the example of FIG. 28, a display unit 301 of which display is controlled by an image processing apparatus 300 is configured using a multiple visual point glasses-free 3D display.

In this case, if a viewing position of a user with respect to the display unit 301 is moved from the left to the right, a visual point changes and it is necessary to provide a different visual point image according to a position to make the visual point change experienced as motion parallax.

For example, if the interpolation is performed from the left (L image) from the left to a center position with respect to the display unit 301 and the interpolation is performed from the right (R image) from the center position to the right with respect to the display unit 301, there is a place (for example, the center position) in which the interpolation direction of the visual point changes. Therefore, in the case of the example of FIG. 28, error becomes conspicuous by the changing of the interpolation direction.

Meanwhile, similar to the image processing apparatus 100 of FIG. 2, the image processing apparatus 300 adjusts a parallax amount on the basis of a parallax distribution obtained from parallax information of the L image and the R image and executes determination processing of the virtual visual point position or selection processing of the interpolation direction.

### [Configuration Example of Image Processing Apparatus]

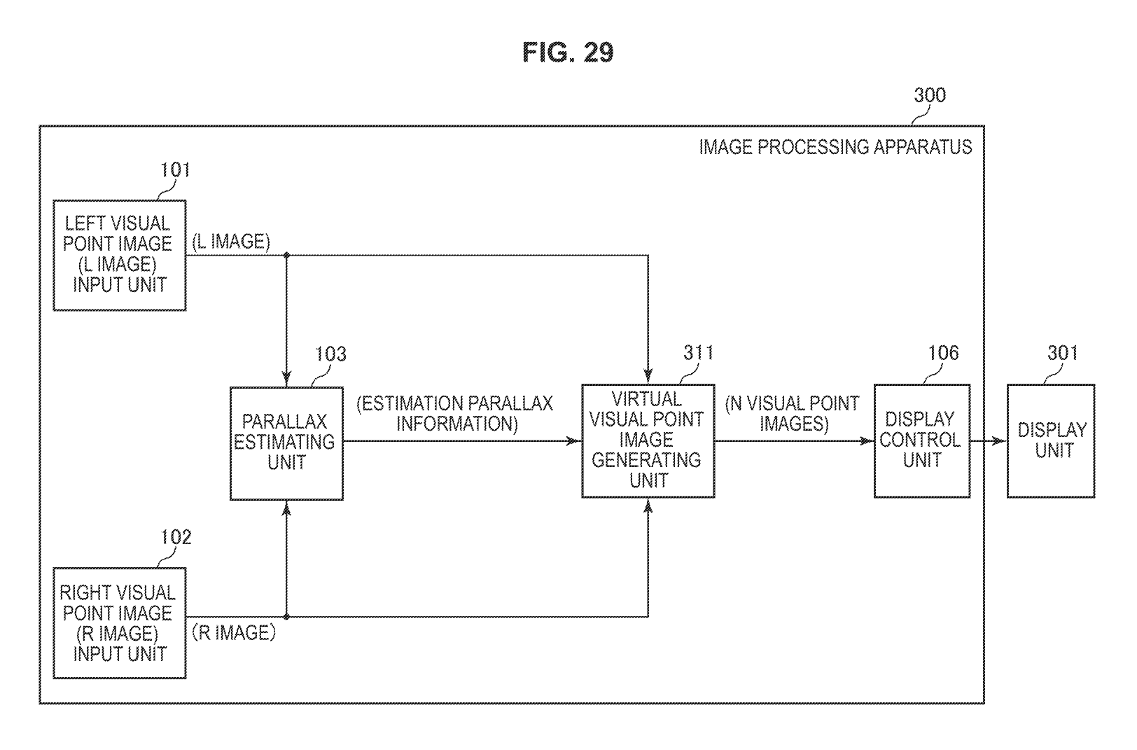

FIG. 29 is a block diagram illustrating a configuration example of the image processing apparatus of FIG. 28.

In the example of FIG. 29, an image processing apparatus 300 includes a left visual point image (L image) input unit 101, a right visual point image (R image) input unit 102, a parallax estimating unit 103, a virtual visual point image generating unit 311, and a display control unit 106. An image that is generated in the image processing apparatus 300 is output to the display unit 301.

The image processing apparatus 300 of FIG. 29 is the same as the image processing apparatus 100 of FIG. 2 in that the left visual point image (L image) input unit 101, the right visual point image (R image) input unit 102, the parallax estimating unit 103, and the display control unit 106 are provided. However, the image processing apparatus 300 of FIG. 29 is different from the image processing apparatus 100 of FIG. 2 in that the virtual visual point image generating unit 105 is replaced by the virtual visual point image generating unit 311 and the display unit 110 is replaced by the display unit 301.

An L image from the left visual point image (L image) input unit 101, an R image from the right visual point image input unit (R image) input unit 102, and parallax information from the parallax estimating unit 103 are supplied to the virtual visual point image generating unit 311.

The virtual visual point image generating unit 311 receives each information and generates a virtual visual point image. In the virtual visual point image generating unit 105 of FIG. 2, the selection processing of the interpolation direction described above with reference to FIGS. 11 and 16 is executed with respect to the case in which the interpolation direction is also temporally changed by the time change (time variation) of the scale value. Meanwhile, in the case of the virtual visual point image generating unit 311 of FIG. 29, the selection processing of the interpolation direction described above with reference to FIGS. 11 and 16 is executed with respect to the case in which the time change of the interpolation direction is not generated and the visual point position moves and the interpolation direction changes. The movement of the visual point position is a space variation (position variation) with respect to the time variation.

That is, with respect to the case in which the interpolation direction is changed by the space variation (position variation), the virtual visual point image generating unit 311 adjusts a parallax amount on the basis of a parallax distribution obtained from the parallax information from the parallax estimating unit 103 and executes determination processing of the virtual visual point position or selection processing of the interpolation direction.

### [Configuration Example of Virtual Visual Point Image Generating Unit]

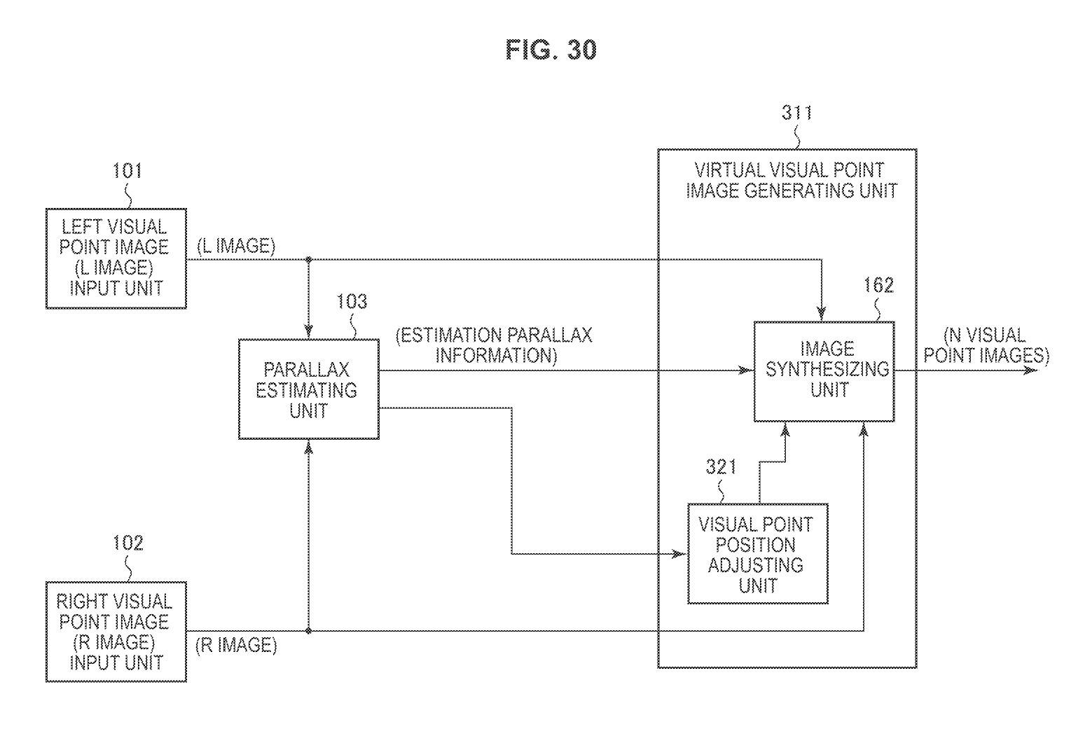

FIG. 30 is a diagram illustrating a configuration example of the virtual visual point image generating unit.

In the example of FIG. 30, the virtual visual point image generating unit 311 includes a visual point position adjusting unit 321 and an image synthesizing unit 162. The virtual visual point image generating unit 311 of FIG. 30 is different from the virtual visual point image generating unit 105 of FIG. 8 in that the visual point position adjusting unit 161 is replaced by the visual point position adjusting unit 321.

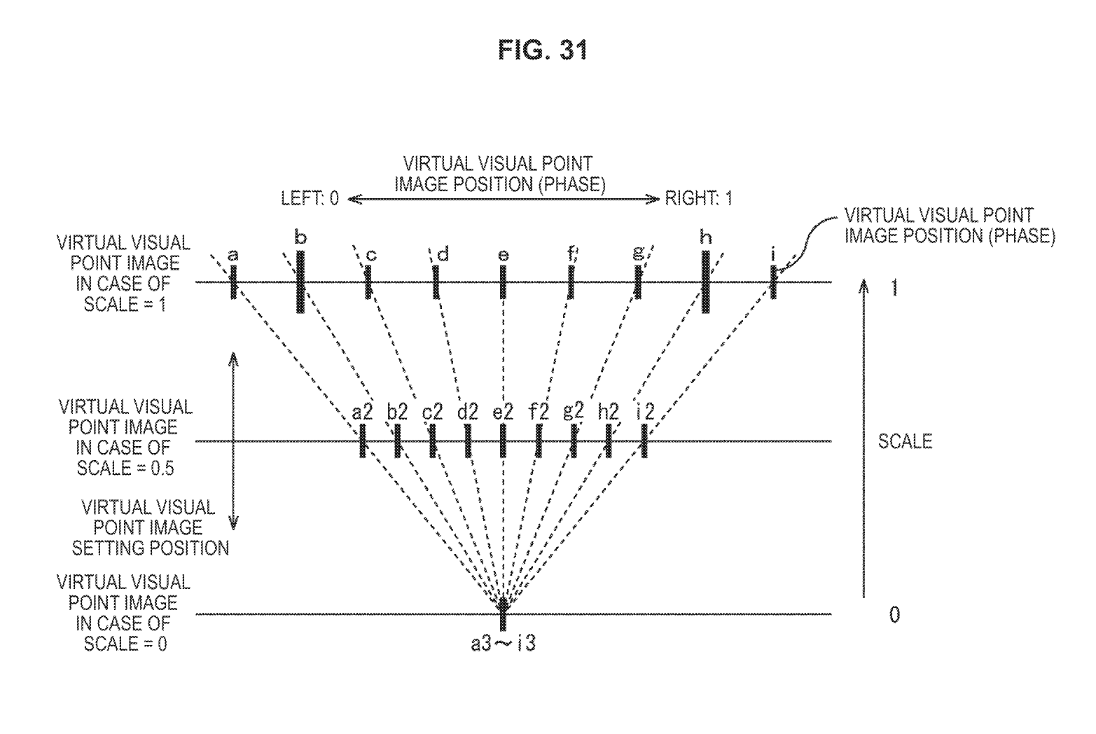

That is, the parallax information is supplied from the parallax estimating unit 103 to the visual point position adjusting unit 321. The visual point position adjusting unit 321 adjusts a parallax amount on the basis of the parallax information from the parallax estimating unit 103 and determines a virtual visual point position (phase) and an interpolation direction. At this time, the visual point position adjusting unit 321 is different from the visual point position adjusting unit 161 in that a convergence point when a scale value is 0 may not be the right (left), as illustrated in FIG. 31.

That is, the visual point position adjusting unit 321 executes calculation processing of the setting position (phase) of the virtual visual point image according to the following algorithm.

The virtual visual point images that are generated in the case of the scale value =1 are determined in advance. For example, the virtual visual point images are the virtual visual point images at the positions of a to i illustrated in FIG. 31. The calculated scale value is set as S (0≦S). When an original visual point position is set as V0 and the visual point position is converged into the center at the scale value=0, the virtual visual point image position (phase) V that is set according to the scale value is represented by the following expression 7.

V=(V0−0.5)·S+1 [Expression 7]

Even though the visual point position is converged into the center (0.5) when the scale value is 0, if a position of a face of a user who views the display unit 301 moves, the interpolation direction may change. Therefore, the visual point position adjusting unit 321 selects the interpolation direction according to the scale value, similar to the visual point position adjusting unit 161 described above with reference to FIG. 11.

At this time, when the scale value (parallax range) is small, the mismatching of the left and right images is small. For this reason, the visual point position adjusting unit 321 sets the right as a temporary interpolation direction, when the scale value is more than a predetermined threshold value. That is, in this case, the visual point position adjusting unit 321 prohibits changing of the interpolation direction to the left.

Meanwhile, in the case in which the scale value is equal to or smaller than the predetermined threshold value, the visual point position adjusting unit 321 sets the temporary interpolation direction, such that the interpolation is performed from an image of the close side. That is, when a visual point phase is 0.5 or less, the visual point position adjusting unit 321 sets the left as the temporary interpolation direction and when the visual point phase is more than 0.5, the visual point position adjusting unit 321 sets the right as the temporary interpolation direction. In this case, the visual point position adjusting unit 321 performs the changing of the interpolation direction (permits the changing of the interpolation direction).

Similar to the visual point position adjusting unit 161, the visual point position adjusting unit 321 executes time stabilization processing. For example, when the temporary interpolation direction is the left for a constant time, the interpolation direction is set to the left and when the temporary interpolation direction is the right for the constant time, the interpolation direction is set to the right. In the other cases, the visual point position adjusting unit 321 sets the same direction as the previous frame to the interpolation direction.

Because the processing of the image processing apparatus 300 of FIG. 29 is basically the same as the processing of the image processing apparatus 100 of FIG. 2 described above with reference to FIGS. 14 to 16, a processing example of the image processing apparatus 300 is omitted.

As described above, in the case of the motion parallax, the changing of the interpolation direction when the mismatching of the left and right images is large can be prevented.

### 5. Fourth Embodiment

### Motion Parallax+Face Detection

### [Example of Display Unit of Image Processing Apparatus]

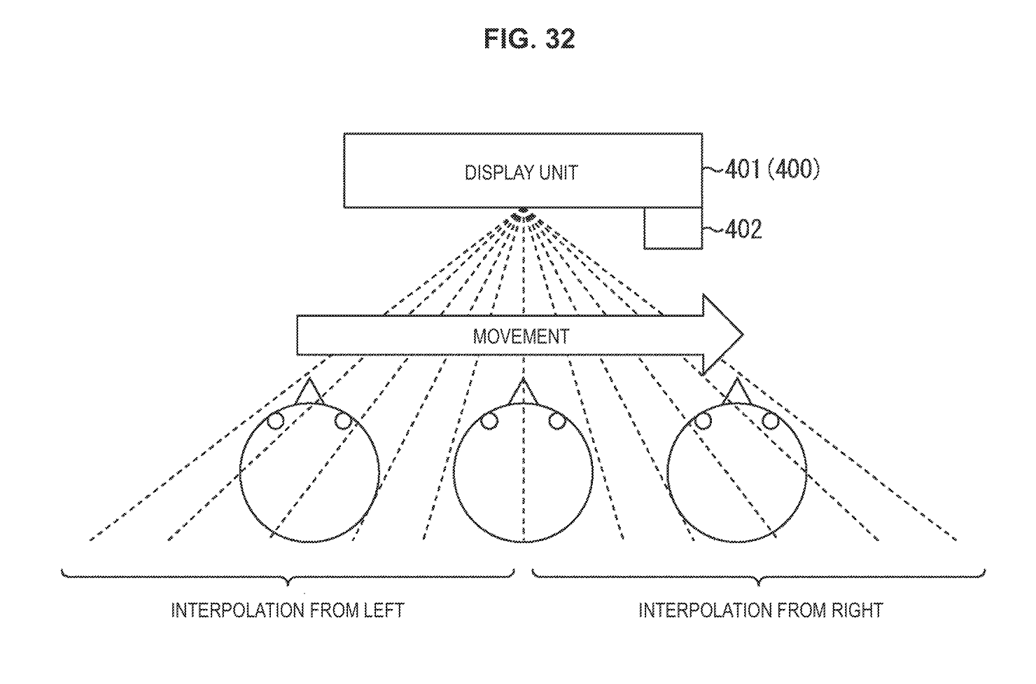

FIG. 32 is a diagram illustrating a configuration example of an image processing apparatus to which the present disclosure is applied.

In the example of FIG. 32, a display unit 401 of which display is controlled by an image processing apparatus 400 is configured using a multiple visual point glasses-free 3D display, similar to the display unit 301 of FIG. 28.

In a casing (screen side) of the display unit 401, a face detection camera 402 that estimates a position of a face of a user is provided. An arrangement position of the face detection camera 402 may be an upper side of a screen. However, the arrangement position is not limited.

In this case, if a viewing position of a user with respect to the display unit 401 is moved from the left to the right, a visual point changes and it is necessary to provide a different visual point image according to a position to make the visual point change experienced as motion parallax.

For example, if the interpolation is performed from the left (L image) from the left to a center position with respect to the display unit 401 and the interpolation is performed from the right (R image) from the center position to the right with respect to the display unit 401, there is a place (for example, the center position) in which the interpolation direction of the visual point changes. Therefore, in the case of the example of FIG. 32, error becomes conspicuous by the changing of the interpolation direction.

Meanwhile, the image processing apparatus 400 adjusts a parallax amount on the basis of a parallax distribution obtained from parallax information of the L image and the R image and executes determination processing of the virtual visual point position or selection processing of the interpolation direction. At this time, the image processing apparatus 400 executes the selection processing of the interpolation direction according to a position of a face detected from the face detection camera 402.

In the example of FIG. 32, the face detection camera 402 is provided. However, instead of the face detection camera, another apparatus such a sensor that can detect the face of the user may be provided.

### [Configuration Example of Image Processing Apparatus]

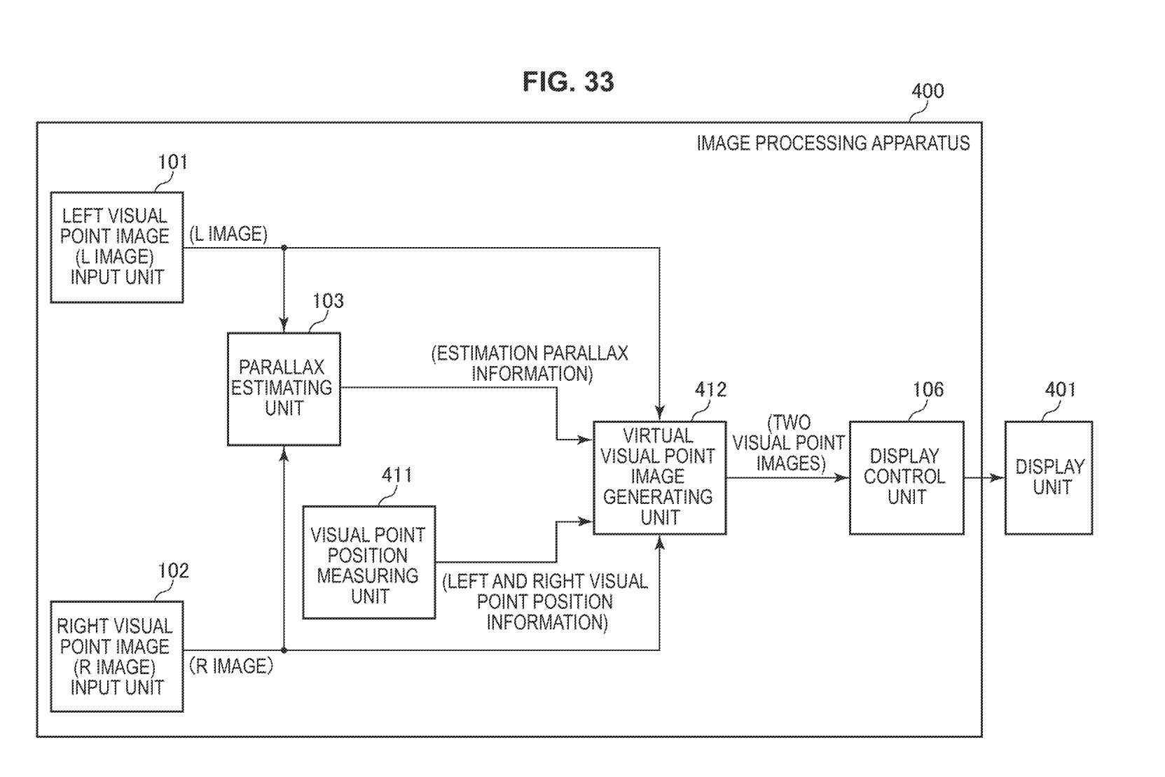

FIG. 33 is a block diagram illustrating a configuration example of the image processing apparatus of FIG. 32.

In the example of FIG. 33, an image processing apparatus 400 includes a left visual point image (L image) input unit 101, a right visual point image (R image) input unit 102, a parallax estimating unit 103, a visual point position measuring unit 411, a virtual visual point image generating unit 412, and a display control unit 106. An image that is generated in the image processing apparatus 400 is output to the display unit 401.

The image processing apparatus 400 of FIG. 33 is the same as the image processing apparatus 100 of FIG. 2 in that the left visual point image (L image) input unit 101, the right visual point image (R image) input unit 102, the parallax estimating unit 103, and the display control unit 106 are provided. However, the image processing apparatus 400 of FIG. 33 is different from the image processing apparatus 100 of FIG. 2 in that the visual point position measuring unit 411 is additionally provided and the virtual visual point image generating unit 105 is replaced by the virtual visual point image generating unit 412. In addition, the image processing apparatus 400 of FIG. 33 is different from the image processing apparatus 100 of FIG. 2 in that the display unit 110 is replaced by the display unit 401.

That is, the visual point position measuring unit 411 detects a position of a face of a user using an image input from the face detection camera 402 and estimates a visual point input to a right eye and a visual point input to a left eye, on the basis of the detected position of the face. The visual point position measuring unit 411 supplies estimated left and right visual point position information to the virtual visual point image generating unit 412.

The L image from the left visual point image (L image) input unit 101, the R image from the right visual point image input unit (R image) input unit 102, the parallax information from the parallax estimating unit 103, and the visual point position information from the visual point position measuring unit 411 are input to the virtual visual point image generating unit 412.

The virtual visual point image generating unit 412 receives each information and generates a virtual visual point image. In the virtual visual point image generating unit 105 of FIG. 2, the selection processing of the interpolation direction described above with reference to FIGS. 11 and 16 is executed with respect to the case in which the interpolation direction is also temporally changed by the time change (time variation) of the scale value. Meanwhile, in the case of the virtual visual point image generating unit 412 of FIG. 33, the same interpolation direction calculation processing as the virtual visual point image generating unit 311 of FIG. 29 is executed. That is, in the virtual visual point image generating unit 412 of FIG. 33, the selection processing of the interpolation direction described above with reference to FIGS. 11 and 16 is executed with respect to the case in which the time change of the interpolation direction is not generated and the visual point position moves and the interpolation direction changes. The movement of the visual point position is a space variation (position variation) with respect to the time variation.

Therefore, similar to the virtual visual point image generating unit 311 of FIG. 29, with respect to the case in which the interpolation direction is changed by the space variation (position variation), the virtual visual point image generating unit 412 adjusts a parallax amount on the basis of a parallax distribution obtained from the parallax information from the parallax estimating unit 103 and executes determination processing of the virtual visual point position or selection processing of the interpolation direction.

At this time, different from the virtual visual point image generating unit 311 of FIG. 29, the virtual visual point image generating unit 412 executes determination processing of the virtual visual point position and selection processing of the interpolation direction, using the left and right visual point position information from the visual point position measuring unit 411. The virtual visual point image generating unit 412 supplies two visual point images based on the left and right visual point position information obtained from the visual point position measuring unit 411 to the display control unit 106.

The display control unit 106 outputs the two visual point images generated by the virtual visual point image generating unit 412 to the display unit 401.

### [Operation of Visual Point Position Measuring Unit]

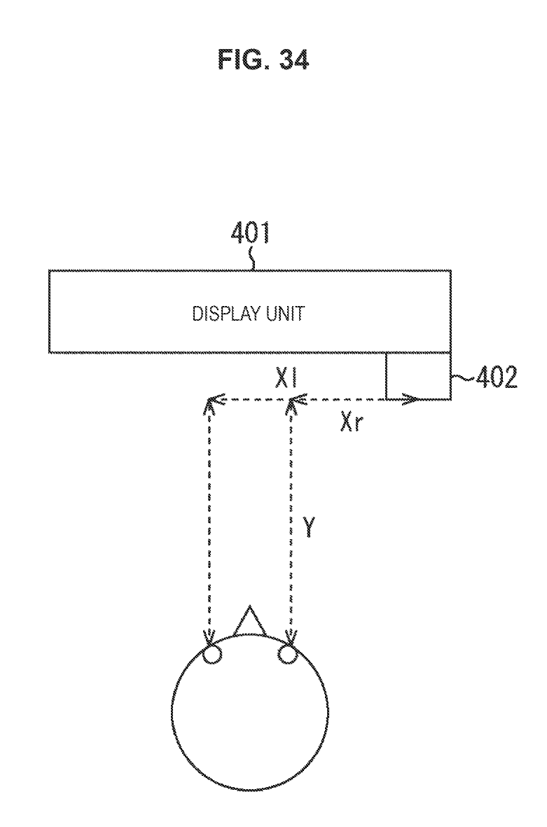

Next, an operation of the visual point position measuring unit 411 will be described with reference to FIG. 34. The visual point position measuring unit 411 detects a position of a face from the image input from the face detection camera 402, using a high-speed face detection algorithm.

For example, the visual point position measuring unit 411 detects a distance XI from a center position of the face detection camera 402 to a position of the left eye of the user and a distance XR from the center position of the face detection camera 402 to a position of the right eye of the user, as the position of the face.

For example, a face detection algorithm that is described in P. Viola, M. Jones, “Rapid Object Detection Using a Boosted Cascade of Simple Features”, IEEE Conf. on CVPR 2001 or C. Huang et al., “High-Performance Rotation Invariant Multiview Face Detection”, IEEE PAMI 2007 is used. However, the present disclosure is not limited to the face detection algorithm.

Next, the visual point position measuring unit 411 estimates a distance Y from a size of the detected face and estimates the visual points input to the right eye and the left eye, from the positions XI and XR of the face and the distance Y. The visual point position measuring unit 411 supplies estimated left and right visual point position information to the virtual visual point image generating unit 412.

### [Configuration of Virtual Visual Point Image Generating Unit]

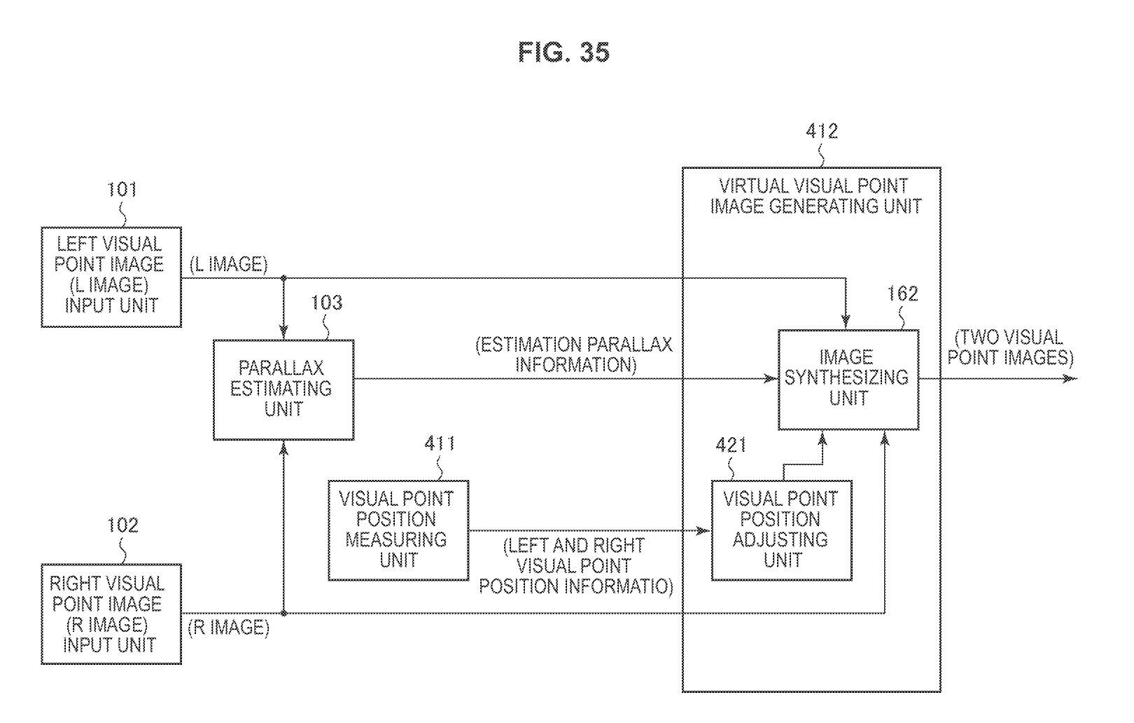

FIG. 35 is a diagram illustrating a configuration example of the virtual visual point image generating unit 412.

In the example of FIG. 35, the virtual visual point image generating unit 412 includes a visual point position adjusting unit 421 and an image synthesizing unit 162. The virtual visual point image generating unit 412 of FIG. 35 is different from the virtual visual point image generating unit 105 of FIG. 8 in that the visual point position adjusting unit 161 is replaced by the visual point position adjusting unit 421.

The left and right visual point position information is supplied from the visual point position measuring unit 411 to the visual point position adjusting unit 421. The visual point position adjusting unit 421 determines a virtual visual point position (phase) and an interpolation direction, on the basis of the left and right visual point position information from the visual point position measuring unit 411.

That is, the visual point position adjusting unit 421 determines the two visual points obtained from the visual point position measuring unit 411 as the output visual point positions. The visual point position adjusting unit 421 sets a temporary interpolation direction according to a visual point phase, executes time stabilization processing according to a movement of the position of the face, and determines the interpolation direction.

Specifically, when the movement of the position of the face is smaller than a predetermined threshold value, the same interpolation direction as a previous frame is selected. That is, in this case, changing of the interpolation direction is prohibited. When the movement of the position of the face is more than the predetermined threshold value, the changing of the interpolation direction is permitted. In this case, when the time stabilization processing is executed, the temporary interpolation direction is the left, and the left is continued for a constant time, the left is set to the interpolation direction. When the temporary interpolation direction is the right and the right is continued for the constant time, the right is set to the interpolation direction. In the other cases, the same interpolation direction as the previous frame is set.

The visual point position adjusting unit 421 supplies information of the virtual visual point positions of the determined two visual points and information of the determined interpolation direction to the image synthesizing unit 162.

The L image from the left visual point image (L image) input unit 101, the R image from the right visual point image (R image) input unit 102, the parallax information (right) from the parallax estimating unit 103, and the information of the virtual visual point positions of the two visual points and the interpolation direction from the visual point position adjusting unit 421 are input to the image synthesizing unit 162.

The image synthesizing unit 162 synthesizes the LR images with the images of the adjusted two visual point positions, on the basis of the input information, and outputs the synthesis image to the display control unit 106 of the rear step.

### [Processing Example of Image Processing Apparatus]

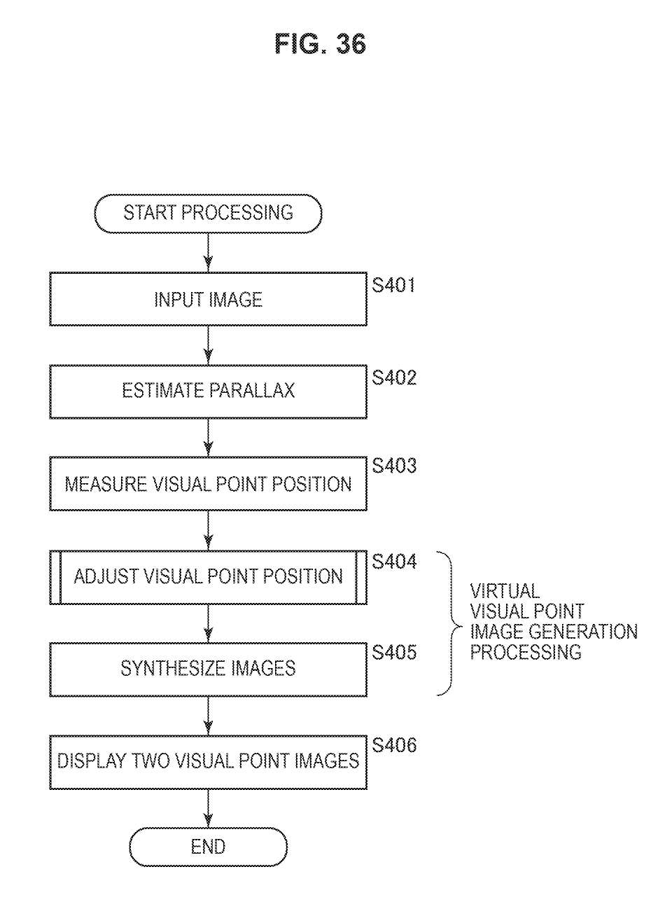

Next, image processing of the image processing apparatus 400 of FIG. 33 will be described with reference to a flowchart of FIG. 36. Processing of steps S401 and S402 of FIG. 36 is basically the same as the processing of steps S101 and S102 of FIG. 14.

In step S401, the left visual point image (L image) input unit 101 and the right visual point image (R image) input unit 102 input the left visual point image (L image) and the right visual point image (R image), respectively. The input left visual point image (L image) and right visual point image (R image) are supplied to the parallax estimating unit 103 and the virtual visual point image generating unit 412.

In step S402, the parallax estimating unit 103 estimates the parallax using the supplied left visual point image (L image) and right visual point image (R image), as described above with reference to FIGS. 3 and 4. The parallax information of the estimation result by the parallax estimating unit 103 is supplied to the virtual visual point image generating unit 412.

In step S403, the visual point position measuring unit 411 measures a visual point position using an image input from the face detection camera 402. That is, the visual point position measuring unit 411 detects a position of the face of the user, using the image input from the face detection camera 402, as described above with reference to FIG. 34, and estimates a visual point input to the right eye and a visual point input to the left eye, on the basis of the detected position of the face. The visual point position measuring unit 411 supplies estimated left and right visual point position information to the virtual visual point image generating unit 412.

In steps S404 and S405, the virtual visual point image generating unit 412 executes the virtual visual point image generation processing.

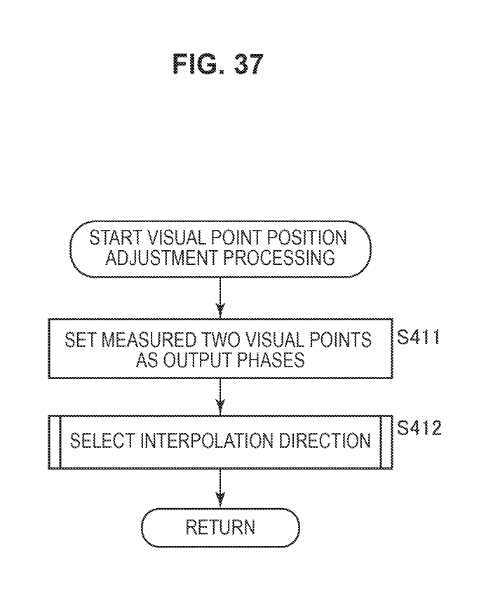

That is, in step S404, the visual point position adjusting unit 421 adjusts a visual point position. The visual point position adjustment processing is described below with reference to FIG. 37. The information of the output phase positions of the two visual points and the information of the interpolation directions of the two visual points are generated by step S404 and are supplied to the image synthesizing unit 162.

The L image from the left visual point image (L image) input unit 101, the R image from the right visual point image (R image) input unit 102, and the parallax information from the parallax estimating unit 103 are input to the image synthesizing unit 162.

In step S405, the image synthesizing unit 162 synthesizes the LR images with the images of the adjusted two visual point positions, on the basis of the input information.

That is, as described above with reference to FIGS. 12 and 13, one visual point image synthesizing units 171-1 and 171-2 of the image synthesizing unit 162 generate the virtual visual point images corresponding to the output phase positions, on the basis of the parallax information, using the input L image and R image. The one visual point image synthesizing units 171-1 and 171-2 select the virtual visual point image generated using the image of the direction (the left or the right) corresponding to the interpolation direction and outputs the virtual visual point image as the synthesis image of the two visual points to the display control unit 106 of the rear step.

In step S406, the display control unit 106 displays the two visual point images on the display unit 401.

### [Example of Visual Point Position Adjustment Processing]

Next, an example of the visual point position adjustment processing in step S404 of FIG. 36 will be described with reference to a flowchart of FIG. 37.

In step S411, the visual point position adjusting unit 421 sets the two visual points measured by the visual point position measuring unit 411 as the output phases, on the basis of the visual point position information from the visual point position measuring unit 411. The output phase positions of the two visual points set by the processing of step S411 are output to the image synthesizing unit 162.

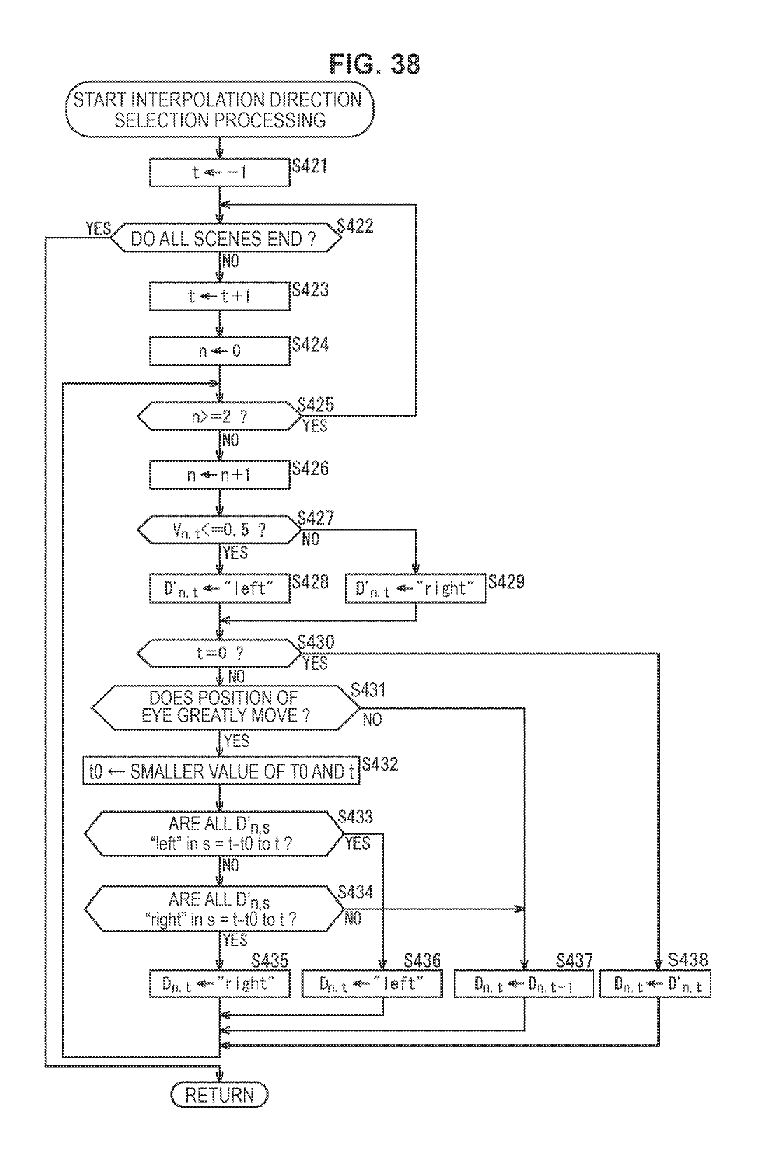

In step S412, the visual point position adjusting unit 421 executes the selection processing of the interpolation direction, on the basis of the visual point position information from the visual point position measuring unit 411. The selection processing of the interpolation direction will be described with reference to a flowchart of FIG. 38.

In this case, n shows a visual point number, Pn,t shows a position of an eye, P-th shows a threshold value (parameter), t(0≦t<T0) shows a time (frame), T0 shows a certain time (parameter), and t0 shows min(T0, t). In addition, Vn,t shows a visual point phase, Dn,t shows an interpolation direction, and D′n,t shows a temporary interpolation direction.

In step S421, the visual point position adjusting unit 421 substitutes −1 for t. In step S422, the visual point position adjusting unit 421 determines whether all scenes end. When it is determined that all scenes end, the visual point position adjusting unit 421 ends the interpolation direction selection processing.

In step S422, when it is determined that all scenes do not end, the processing proceeds to step S423. In step S423, the visual point position adjusting unit 421 substitutes t+1 for t. In step S424, the visual point position adjusting unit 421 substitutes 0 for n.

In step S425, the visual point position adjusting unit 421 determines whether n is equal to or more than 2. When it is determined that n is equal to or more than 2, the processing returns to step S422 and the following processing is repeated. In this case, 2 is the number of visual points.

When it is determined in step S425 that n is smaller than 2, the processing proceeds to step S426. In step S426, the visual point position adjusting unit 421 substitutes n+1 for n.

In step S427, the visual point position adjusting unit 421 determines whether Vn,t is equal to or smaller than 0.5. When it is determined that Vn,t is equal to smaller than 0.5, the processing proceeds to step S428 and the visual point position adjusting unit 421 substitutes “left” for D′n,t. That is, in step S428, the left is set to the temporary interpolation direction.

When it is determined in step S427 that Vn,t is more than 0.5, the processing proceeds to step S429. In step S429, the visual point position adjusting unit 421 substitutes “right” for D′n,t. That is, in step S429, the right is set to the temporary interpolation direction.

In step S430, the visual point position adjusting unit 421 determines whether t is 0. When it is determined that t is not 0, the processing proceeds to step S431. In step S431, the visual point position adjusting unit 421 determines whether the position of the eye greatly moves, on the basis of the visual point position information from the visual point position measuring unit 411.

When it is determined in step S431 that the position of the eye does not greatly move, the processing proceeds to step S432. In step S432, the visual point position adjusting unit 421 substitutes a smaller value of T0 and t for t0.

In step S433, the visual point position adjusting unit 421 determines whether all D′n,s are “left” in s=t−t0 to t. When it is determined in step S433 that all D′n,s are not “left” in s=t−t0 to t, the processing proceeds to step S434.

In step S434, the visual point position adjusting unit 421 determines whether all D′n,s are “right” in s=t−t0 to t. When it is determined in step S434 that all D′n,s are “right” in s=t−t0 to t, the processing proceeds to step S435. In step S435, the visual point position adjusting unit 421 substitutes “right” for Dn,t. That is, in step S435, the right is set to the interpolation direction.

When it is determined in step S433 that all D′n,s are “left”, the processing proceeds to step S436. In step S436, the visual point position adjusting unit 421 substitutes “left” for Dn,t. That is, in step S436, the left is set to the interpolation direction.

When it is determined in step S434 that all D′n,s are not “right” in s=t−t0 to t, the processing proceeds to step S437. When it is determined in step S431 that the position of the eye greatly moves, the processing proceeds to step S437. In step S437, the visual point position adjusting unit 421 substitutes Dn,t−1 for Dn,t. That is, in step S437, an interpolation direction of a previous frame is set to the interpolation direction.

Meanwhile, when it is determined in step S430 that t is 0, the processing proceeds to step S438. In step S438, the visual point position adjusting unit 421 substitutes D′n,t for Dn,t. That is, in step S438, the temporary interpolation direction is set to the interpolation direction.

In an example of FIG. 38, the processing after step S430 is time stabilization processing.

As described above, because the interpolation direction is set according to the detected position of the face, changing of the interpolation direction when mismatching of the left and right images is large can be prevented.

Because the time stabilization processing is executed, changing of the interpolation direction can be suppressed from being frequently generated. That is, the time variation of the high frequency of the interpolation direction and the variations at different timings of both eyes of the left and right eyes can be suppressed.

The example of the case in which the number of users who view the display unit 401 is 1 has been described. In this case, only the images of the two visual points input to the left and right eyes may be synthesized as described above. Meanwhile, when a plurality of users view the display unit 401, the same processing as the processing in the case of the two visual points is executed with respect to each of the plurality of users. When the visual point positions are overlapped, priority may be given to a person who has viewed the display unit earlier, a person who has viewed the display unit before, or a person close to the center of the screen.

### 6. Fifth Embodiment

### Head-Mounted Display

### [Example of Display Unit of Image Processing Apparatus]

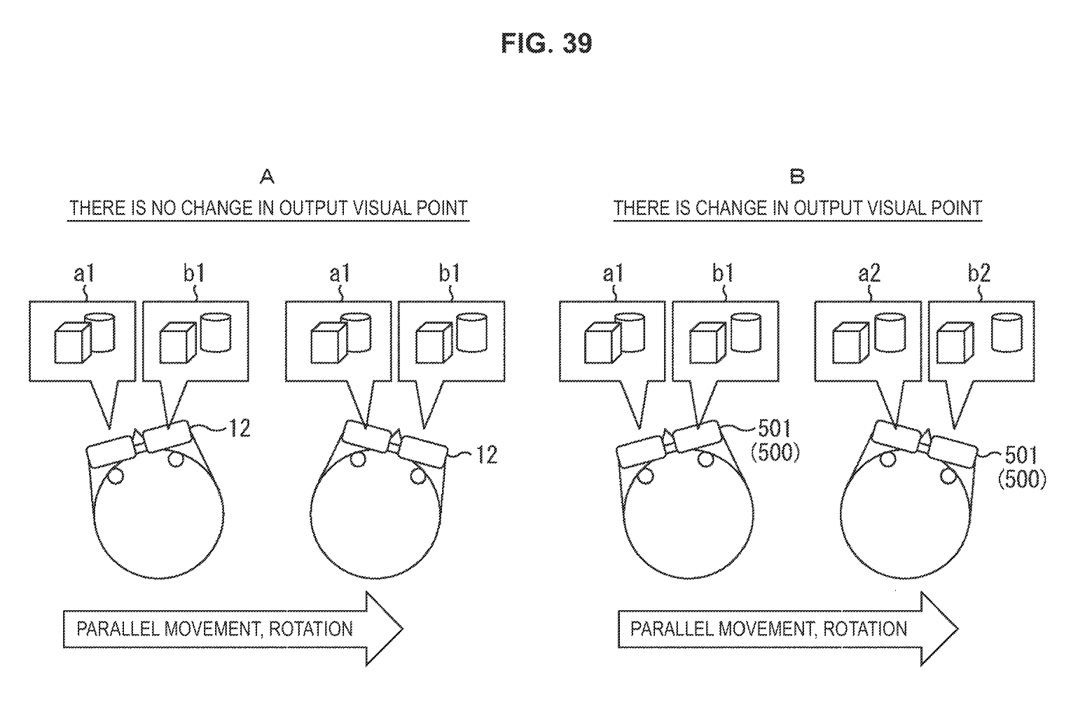

FIG. 39 is a diagram illustrating an image processing apparatus to which the present disclosure is applied.

In FIG. 39A, a display unit 12 of which display is controlled by an image processing apparatus according to the related art is illustrated. In FIG. 39B, a display unit 501 of which display is controlled by an image processing apparatus 500 to which the present disclosure is applied is illustrated.

Each of the display units 12 and 501 is configured using a head-mounted display and is mounted to a head of a user.

As illustrated in FIG. 39A, even if the user mounts the display unit 12 to the head and moves in parallel or rotates, there is no change in output visual points processed by the image processing apparatus according to the related art and a left visual point image a1 and a right visual point image b1 that are displayed on the display unit 12 according to the related art are the same.

Meanwhile, as illustrated in FIG. 39B, if the user mounts the display unit 501 to the head and moves in parallel or rotates, a visual point changes and the visual point change can be experienced as motion parallax, similar to the case of the example of FIG. 32. For this reason, it is necessary to provide a different visual point image according to a position, in the image processing apparatus 500.

For example, when the user turns to the left, if the interpolation is performed from the left (L image), the left visual point image a1 and the right visual point image b1 are displayed on the display unit 501. When the user turns to the right, if the interpolation is performed from the right (R image), a left visual point image a2 and a right visual point image b2 are displayed on the display unit 501.

In this case, similar to the case of the example of FIG. 32, there is a place (center position) in which the interpolation direction of the visual point changes and error becomes conspicuous by the change of the interpolation direction.

Meanwhile, the image processing apparatus 500 adjusts a parallax amount on the basis of a parallax distribution obtained from parallax information of the L image and the R image and executes determination processing of the virtual visual point position or selection processing of the interpolation direction. At this time, the image processing apparatus 500 executes the selection processing of the interpolation direction according to a visual point position (a position and a direction of a face of the user) detected from a visual point position measuring unit 511 to be described below with reference to FIG. 33.

### [Configuration Example of Image Processing Apparatus]

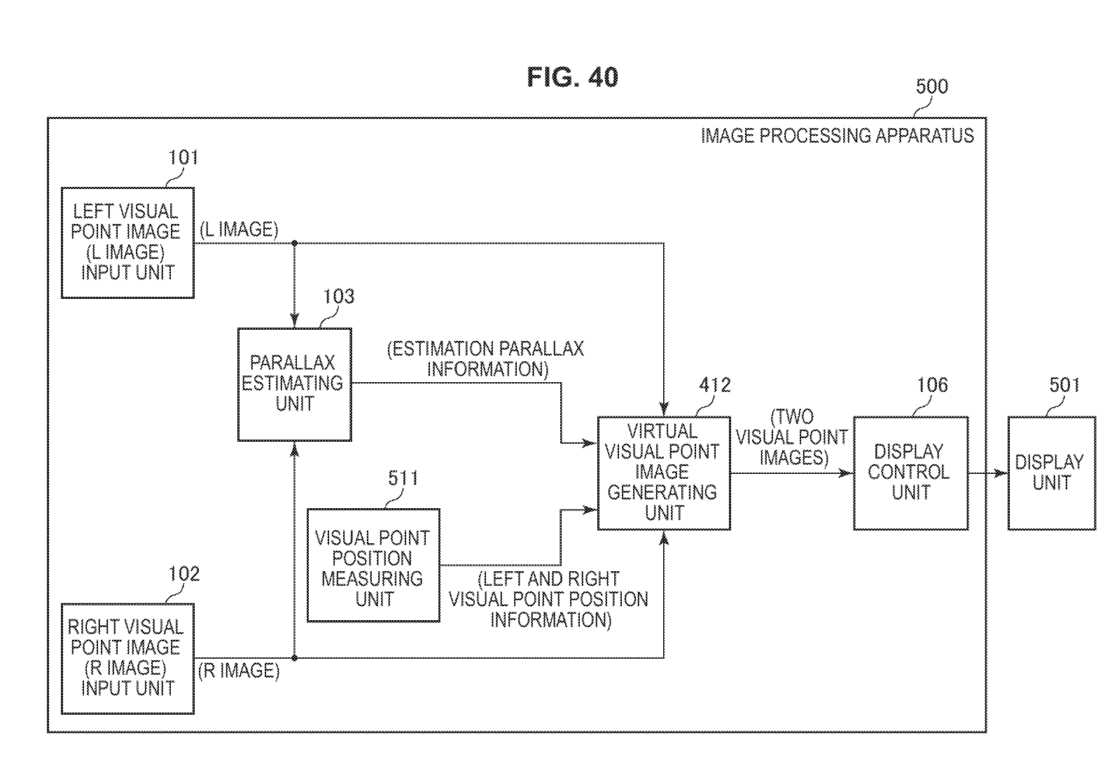

FIG. 40 is a block diagram illustrating a configuration example of the image processing apparatus 500 of FIG. 39.

In the example of FIG. 40, the image processing apparatus 500 includes a left visual point image (L image) input unit 101, a right visual point image (R image) input unit 102, a parallax estimating unit 103, a visual point position measuring unit 511, a virtual visual point image generating unit 412, and a display control unit 106. An image that is generated in the image processing apparatus 500 is output to the display unit 501.

The image processing apparatus 500 of FIG. 40 is the same as the image processing apparatus 400 of FIG. 33 in that the left visual point image (L image) input unit 101, the right visual point image (R image) input unit 102, the parallax estimating unit 103, the display control unit 106, and the virtual visual point image generating unit 412 are provided. However, the image processing apparatus 500 of FIG. 40 is different from the image processing apparatus 400 of FIG. 33 in that the visual point position measuring unit 411 is replaced by the visual point position measuring unit 511. In addition, the image processing apparatus 500 of FIG. 40 is different from the image processing apparatus 400 of FIG. 33 in that the display unit 401 is replaced by the display unit 501.

That is, the visual point position measuring unit 511 is configured using a position (acceleration) sensor. The visual point position measuring unit 511 detects a motion of the user (a position and a direction of a face of the user) and estimates a visual point input to a right eye and a visual point input to a left eye, on the basis of the detected motion. The visual point position measuring unit 511 supplies estimated left and right visual point position information to the virtual visual point image generating unit 412.

The L image from the left visual point image (L image) input unit 101, the R image from the right visual point image input unit (R image) input unit 102, the parallax information from the parallax estimating unit 103, and the visual point position information from the visual point position measuring unit 511 are input to the virtual visual point image generating unit 412.

The virtual visual point image generating unit 412 receives each information and generates a virtual visual point image. As described above with reference to FIG. 33, with respect to the case in which the interpolation direction changes due to the movement of the visual point position, the virtual visual point image generating unit 412 adjusts the parallax amount on the basis of the parallax distribution obtained from the parallax information from the parallax estimating unit 103 and executes determination processing of the virtual visual point position or selection processing of the interpolation direction.

At this time, the virtual visual point image generating unit 412 executes the determination processing of the virtual visual point position or the selection processing of the interpolation direction, using the left and right visual point position information from the visual point position measuring unit 511. The virtual visual point image generating unit 412 supplies two visual point images based on the left and right visual point position information obtained from the visual point position measuring unit 411 to the display control unit 106.

The display control unit 106 outputs the two visual point images generated by the virtual visual point image generating unit 412 to the display unit 501.

Because the processing of the image processing apparatus 500 of FIG. 40 is basically the same as the processing of the image processing apparatus 400 of FIG. 33 described above with reference to FIGS. 36 to 38, an example of the processing of the image processing apparatus 500 is omitted.

As described above, in the case of the motion parallax in the head-mounted display, the changing of the interpolation direction when the mismatching of the left and right images is large can be prevented.

The example of the real-time processing has been described. However, the present disclosure can be applied to off-line processing to be described below.

### 7. Sixth Embodiment

### Off-Line Processing

### [Configuration Example of Image Processing Apparatus]

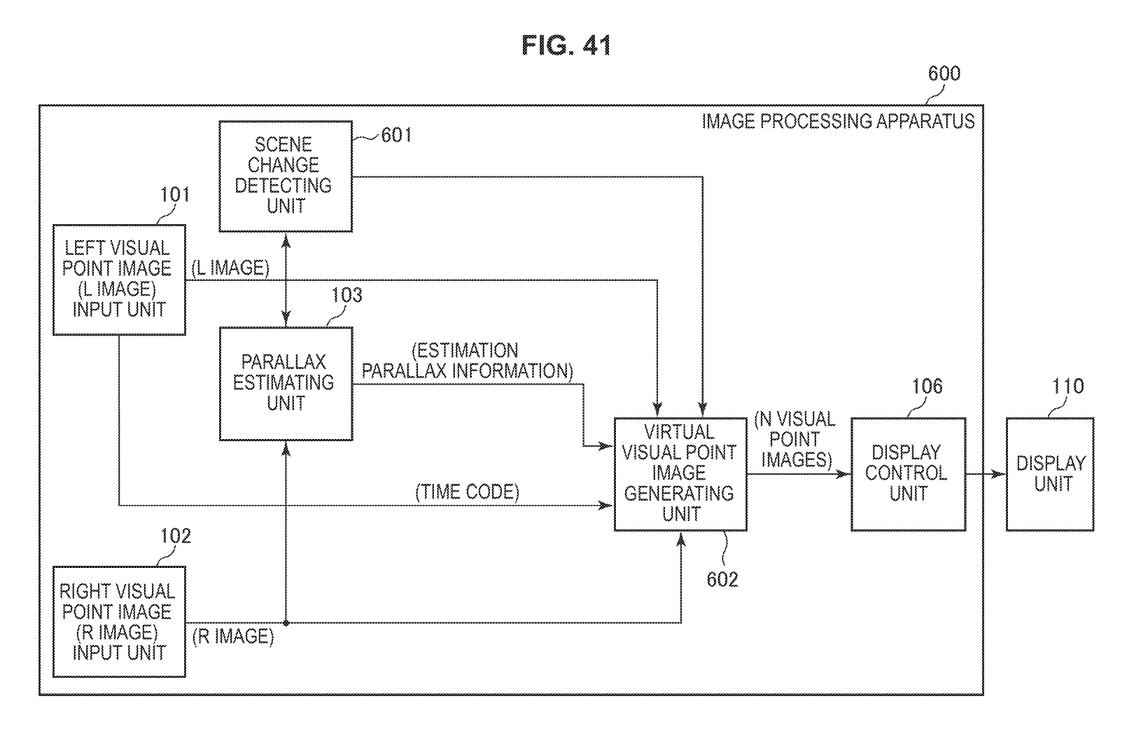

FIG. 41 is a block diagram illustrating another configuration example of an image processing apparatus to which the present disclosure is applied.

In the example of FIG. 41, an image processing apparatus 600 includes a left visual point image (L image) input unit 101, a right visual point image (R image) input unit 102, a parallax estimating unit 103, a scene change detecting unit 601, a virtual visual point image generating unit 602, and a display control unit 106. An image that is generated in the image processing apparatus 600 is output to the display unit 110.

The image processing apparatus 600 of FIG. 41 is the same as the image processing apparatus 100 of FIG. 2 in that the left visual point image (L image) input unit 101, the right visual point image (R image) input unit 102, the parallax estimating unit 103, and the display control unit 106 are provided. However, the image processing apparatus 600 of FIG. 41 is different from the image processing apparatus 100 of FIG. 2 in that the scene change detecting unit 601 is additionally provided and the virtual visual point image generating unit 105 is replaced by the virtual visual point image generating unit 602.

That is, an L image from the left visual point image (L image) input unit 101 is supplied to the scene change detecting unit 601.

The scene change detecting unit 601 detects whether the scene changes, using the L image from the left visual point image (L image) input unit 101, and supplies detected information of the scene change to the virtual visual point image generating unit 602.

The L image from the left visual point image (L image) input unit 101, the R image from the right visual point image input unit (R image) input unit 102, the parallax information from the parallax estimating unit 103, and the information of the scene change from the scene change detecting unit 601 are supplied to the virtual visual point image generating unit 602.

A time code is supplied from the left visual point image (L image) input unit 101 to the virtual visual point image generating unit 602.

The virtual visual point image generating unit 602 executes analysis processing of the scene. The virtual visual point image generating unit 602 measures a parallax range for each scene using the scene change information from the scene change detecting unit 601 and the parallax information from the parallax estimating unit 103 and records the parallax range.

The virtual visual point image generating unit 602 adjusts the parallax amount, that is, determines a generated virtual visual point position (phase), on the basis of the parallax distribution (parallax range) calculated from the input information. The virtual visual point image generating unit 602 executes the selection processing of the interpolation direction according to a scale value for each scene when the scene changes, using the recorded information of the parallax range for each scene.

The virtual visual point image generating unit 602 generates a virtual visual point image corresponding to the determined virtual visual point position (phase), on the basis of the image of the selected interpolation direction. The virtual visual point image generating unit 105 synthesizes the generated virtual visual point image, that is, the image of the adjusted visual point position and outputs the synthesis image to the display control unit 106 of the rear step.

### [Processing of Scene Change Detecting Unit]

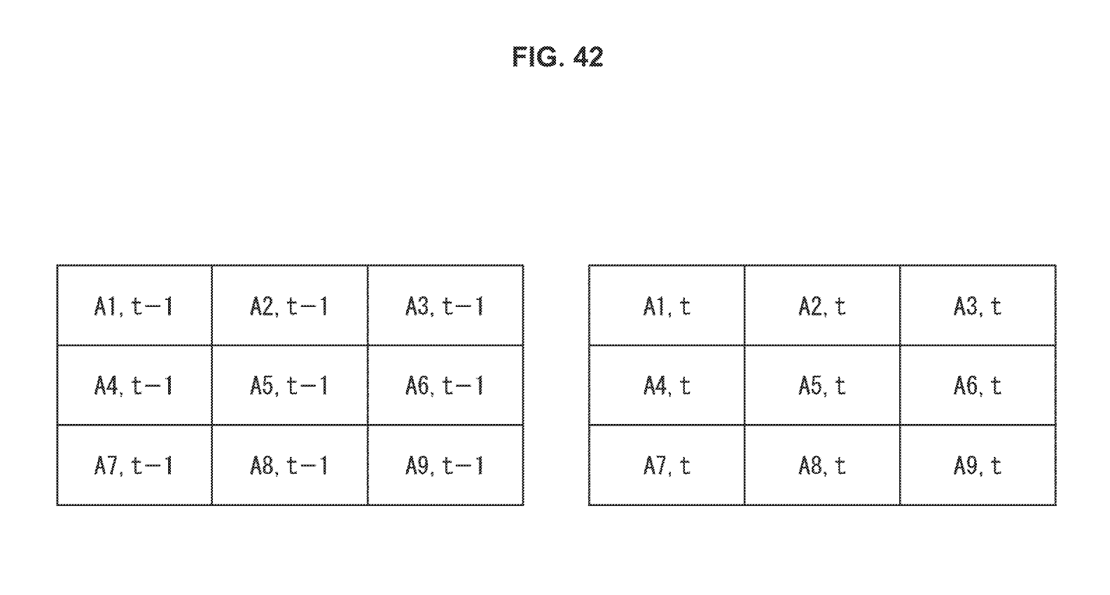

The processing of the scene change detecting unit 601 will be described with reference to FIG. 42.

The scene change detecting unit 601 divides a screen into a plurality of regions (in the case of the example of FIG. 42, nine regions).

The scene change detecting unit 601 calculates a time change amount (≧0) of brightness for each pixel, with respect to each region, and sets a total value of the time change amounts as Dm [m=1, . . . , 9]. In the case of the example of FIG. 42, in an A1 region at a time t−1 and an A1 region at a time t, a total value D1 of a time change amount of brightness for each pixel is calculated. In an A2 region at the time t−1 and an A2 region at the time t, a total value D2 of a time change amount of brightness for each pixel is calculated. In an A3 region at the time t−1 and an A3 region at the time t, a total value D3 of a time change amount of brightness for each pixel is calculated.

In an A4 region at the time t−1 and an A4 region at the time t, a total value D4 of a time change amount of brightness for each pixel is calculated. In an A5 region at the time t−1 and an A5 region at the time t, a total value D5 of a time change amount of brightness for each pixel is calculated. In an A6 region at the time t−1 and an A6 region at the time t, a total value D6 of a time change amount of brightness for each pixel is calculated.

In an A7 region at the time t−1 and an A7 region at the time t, a total value D7 of a time change amount of brightness for each pixel is calculated. In an A8 region at the time t−1 and an A8 region at the time t, a total value D8 of a time change amount of brightness for each pixel is calculated. In an A9 region at the time t−1 and an A9 region at the time t, a total value D9 of a time change amount of brightness for each pixel is calculated.

The scene change detecting unit 601 calculates the number M of regions in which Dm<D_th (threshold value) is satisfied. In the case of M>M_th (threshold value), the scene change detecting unit 601 determines that the scene change is generated and in the other cases, the scene change detecting unit 601 determines that the scene change is not generated.

When the scene change is generated, the scene change detecting unit 601 supplies a number of the scene and a time code of the scene as scene change information to the virtual visual point image generating unit 602.

### [Configuration of Virtual Visual Point Image Generating Unit]

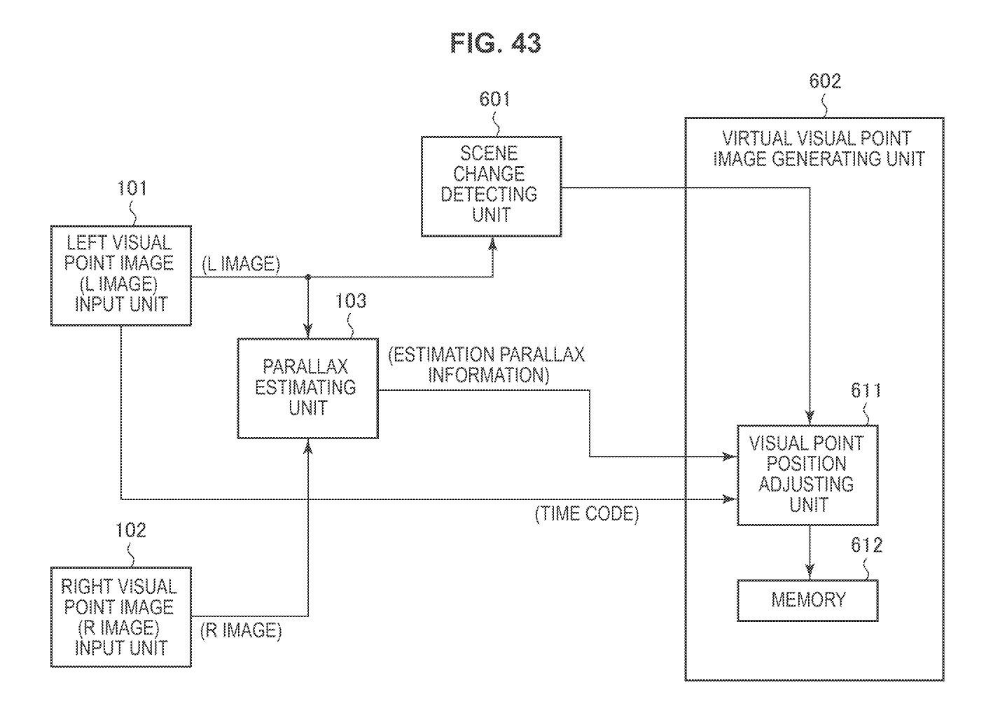

FIG. 43 is a diagram illustrating a configuration example of the virtual visual point image generating unit 602 that executes the analysis processing of the scene.

In the example of FIG. 43, the virtual visual point image generating unit 602 that executes the analysis processing of the scene includes a visual point position adjusting unit 611 and a memory 612.

The scene change information from the scene change detecting unit 601, the time code from the left visual point image (L image) input unit 101, and the parallax information from the parallax estimating unit 103 are supplied to the visual point position adjusting unit 611.

The visual point position adjusting unit 611 calculates a maximum value of the scale value for each scene, using the supplied information, and records the maximum value of the scale value for each scene, the time code of the scene, and a maximum of the scene number in the memory 612.

The memory 612 accumulates the maximum value of the scale value for each scene, the time code of the scene, and the maximum value of the scene number.

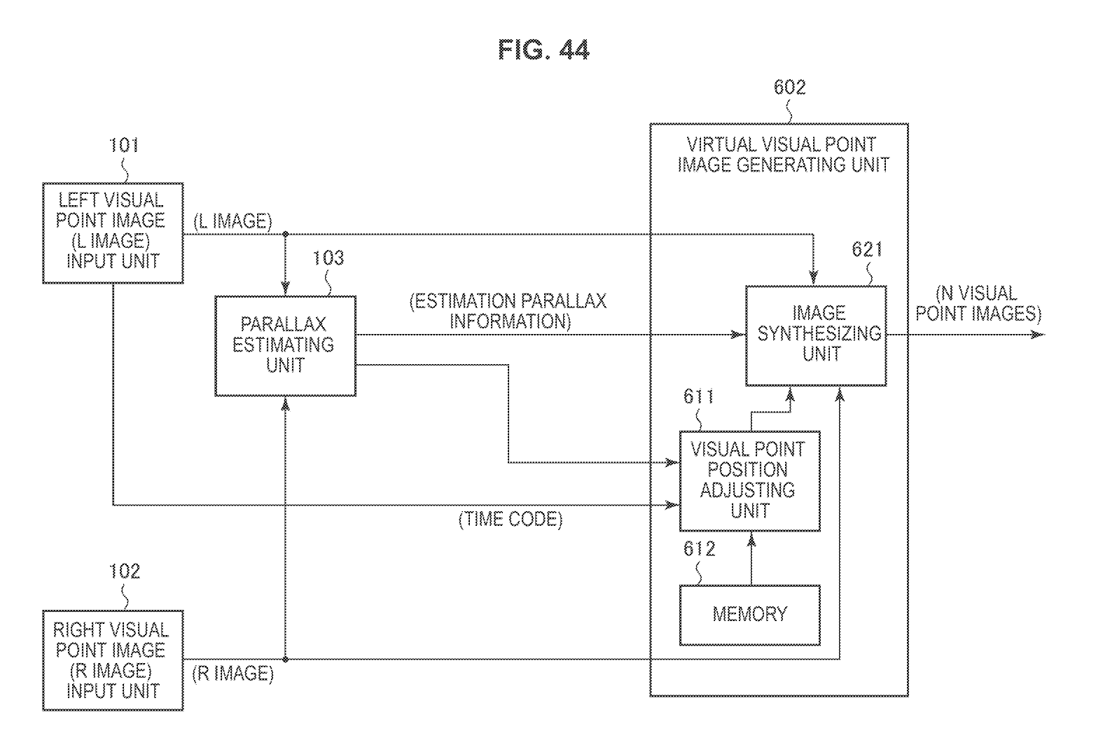

FIG. 44 is a diagram illustrating a configuration example of the virtual visual point image generating unit 602 that executes the selection processing of the interpolation direction and the image synthesis processing.

In the example of FIG. 44, the virtual visual point image generating unit 602 that executes the selection processing of the interpolation direction and the image synthesis processing includes a visual point position adjusting unit 611, a memory 612, and an image synthesizing unit 621.

The time code from the left visual point image (L image) input unit 101 and the parallax information from the parallax estimating unit 103 are supplied to the visual point position adjusting unit 611.

The visual point position adjusting unit 611 adjusts the parallax amount on the basis of the parallax information from the parallax estimating unit 103 and determines the virtual visual point position (phase). The visual point position adjusting unit 611 selects the interpolation direction according to the maximum value of the scale value for each scene, the time code of the scene, and the maximum value of the scene number, which are recorded in the memory 612.

The visual point position adjusting unit 611 supplies information of the determined virtual visual point position and information of the interpolation direction to the image synthesizing unit 621.

The image synthesizing unit 621 basically has the same configuration as the image synthesizing unit 162 of FIG. 8. The L image from the left visual point image (L image) input unit 101, the R image from the right visual point image input unit (R image) input unit 102, the parallax information from the parallax estimating unit 103, and the information of the virtual visual point position and the information of the interpolation direction from the visual point position adjusting unit 611 are input to the image synthesizing unit 621.

The image synthesizing unit 621 synthesizes the LR images with the image of the adjusted visual point position, on the basis of the input information, and outputs the synthesis image to the display control unit 106 of the rear step.

### [Processing Example of Image Processing Apparatus]

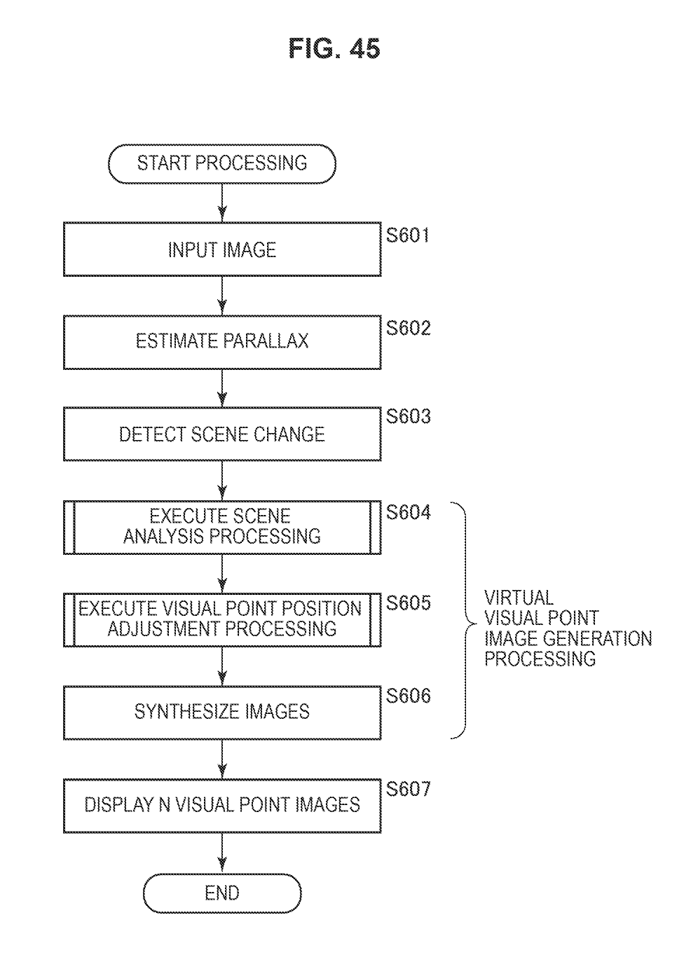

Next, image processing of an image processing apparatus 600 of FIG. 41 will be described with reference to a flowchart of FIG. 45. Processing of steps S601, S602, S606, and S607 of FIG. 45 is basically the same as the processing of steps S101, S102, S104, and S105 of FIG. 14.

In step S601, the left visual point image (L image) input unit 101 and the right visual point image (R image) input unit 102 input the left visual point image (L image) and the right visual point image (R image), respectively.

The input left visual point image (L image) and right visual point image (R image) are supplied to the parallax estimating unit 103 and the virtual visual point image generating unit 602.

In step S602, the parallax estimating unit 103 estimates the parallax using the supplied left visual point image (L image) and right visual point image (R image), as described above with reference to FIGS. 3 and 4. The parallax information of the estimation result by the parallax estimating unit 103 is supplied to the virtual visual point image generating unit 602.

In step S603, the scene change detecting unit 601 detects the scene change, as described above with reference to FIG. 42. When the scene change is generated, the scene change detecting unit 601 supplies the number of the scene and the time code of the scene as the scene change information to the virtual visual point image generating unit 602.

In steps S604, S605, and S606, the virtual visual point image generating unit 602 executes the virtual visual point image generation processing.

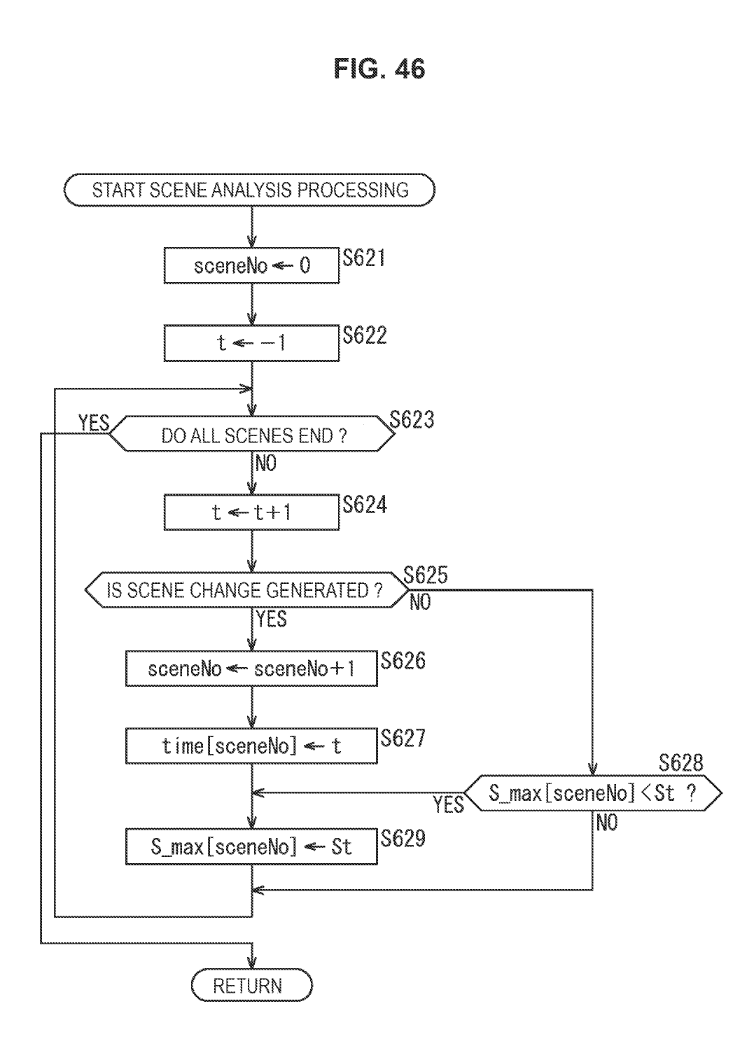

That is, in step S604, the visual point position adjusting unit 611 executes scene analysis processing. The scene analysis processing is described below with reference to FIG. 46. The scene is analyzed by the processing of step S604 and the maximum value of the scale value for each scene, the time code of the scene, and the maximum value of the scene number are stored in the memory 612.

In step S605, the visual point position adjusting unit 611 adjusts the visual point position. The information of the output phase positions of the N visual points and the information of the interpolation directions of the N visual points are generated by the adjustment processing of the visual point position and are supplied to the image synthesizing unit 621.

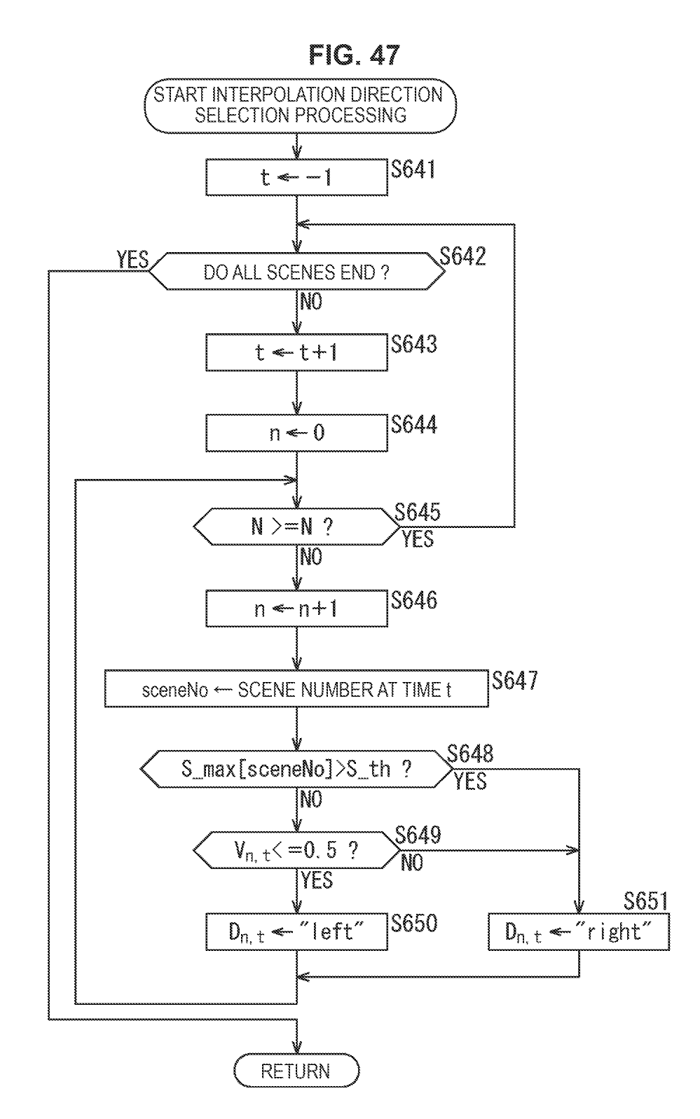

Because the visual point position adjustment processing is basically the same as the processing described above with reference to FIG. 15, except for the interpolation direction selection processing in step S115, explanation thereof is omitted. The different interpolation direction selection processing will be described below with reference to FIG. 47.

The L image from the left visual point image (L image) input unit 101, the R image from the right visual point image (R image) input unit 102, and the parallax information from the parallax estimating unit 103 are input to the image synthesizing unit 621.

In step S606, the image synthesizing unit 621 synthesizes the LR images with the image of the adjusted visual point position, on the basis of the input information, and supplies the synthesized N visual point images to the display control unit 106.

In step S607, the display control unit 106 displays the N visual point images on the display unit 110.

### [Example of Scene Analysis Processing]

Next, an example of the scene analysis processing in step S604 of FIG. 45 will be described with reference to a flowchart of FIG. 46.

In this case, sceneChange shows scene change information, sceneNo shows a scene number (initial value 0), S_max[s] shows a maximum value of a scale value of a scene s, and St shows a scale value. In addition, time_code shows a time code, time[s] shows a time code of the scene s, and scene_max shows a maximum value of the scene number.

In step S621, the visual point position adjusting unit 611 substitutes 0 for sceneNo. In step S622, the visual point position adjusting unit 611 substitutes −1 for t.

In step S623, the visual point position adjusting unit 611 determines whether sceneNo becomes scene_max, that is, whether all scenes end. When it is determined that all scenes end, the visual point position adjusting unit 611 ends the scene analysis processing.

In step S623, when it is determined that all scenes do not end, the processing proceeds to step S624. In step S624, the visual point position adjusting unit 611 substitutes t+1 for t. In step S625, the visual point position adjusting unit 611 determines whether the scene change is generated, by referring to the scene change information sceneChange from the scene change detecting unit 601.

In step S625, when it is determined that the scene change is generated, the processing proceeds to step S626. In step S626, the visual point position adjusting unit 611 substitutes sceneNo+1 for sceneNo. In step S627, the visual point position adjusting unit 611 substitutes t for time[sceneNo] and the processing proceeds to step S629.

Meanwhile, when it is determined in step S625 that the scene change is not generated, the processing proceeds to step S628. In step S628, the visual point position adjusting unit 611 determines whether S_max[sceneNo] is smaller than St. When it is determined that S_max[sceneNo] is smaller than St, the processing proceeds to step S629.

In step S629, the visual point position adjusting unit 611 substitutes St for S_max[sceneNo]. The processing returns to the processing of step S623, and the following processing is repeated.

When it is determined in step S628 that S_max[sceneNo] is not smaller than St, the processing of step S629 is skipped, the processing returns to step S623, and the following processing is repeated.

By the above processing, S_max[s] to be the maximum value of the scale value of the scene s, time[s] to be the time code of the scene s, and scene_max to be the maximum value of the scene number are stored in the memory 612 by the visual point position adjusting unit 611.

### [Example of Interpolation Direction Selection Processing]

Next, the selection processing of the interpolation direction will be described with reference to a flowchart of FIG. 47. This processing is the interpolation direction selection processing of the visual point position adjustment processing of step S605 of FIG. 45 (that is, the interpolation direction selection processing in step S115 of FIG. 15).

In this case, n shows a visual point number, N shows the total number of visual points, sceneChange shows scene change information, sceneNo shows a scene number (initial value 0), S_max[s] shows a maximum value of a scale value of the scene s, and S_th shows a threshold value (parameter). In addition, Vn,t shows a visual point phase, Dn,t shows an interpolation direction, time_code shows a time code, time[s] shows a time code of the scene s, and scene_max shows a maximum value of a scene number.

In the selection processing of the interpolation direction, S_max[s] to be the maximum value of the scale value of the scene s, time[s] to be the time code of the scene s, and scene_max to be the maximum value of the scene number that are stored in the memory 612 by the scene analysis processing are used. That is, because the time code of the scene s is stored, it is not necessary to detect the scene change, when the processing of FIG. 47 is executed.

In step S641, the visual point position adjusting unit 611 substitutes −1 for t. In step S642, the visual point position adjusting unit 611 determines whether sceneNo becomes scene_max, that is, whether all scenes end. When it is determined that all scenes end, the visual point position adjusting unit 611 ends the interpolation direction selection processing.

When it is determined in step S642 that all scenes do not end, the processing proceeds to step S643. In step S643, the visual point position adjusting unit 611 substitutes t+1 for t. In step S644, the visual point position adjusting unit 611 substitutes 0 for n.

In step S645, the visual point position adjusting unit 611 determines whether n is equal to or more than N. When it is determined that n is equal to or more than N, the processing returns to step S642 and the following processing is repeated.

When it is determined in step S645 that n is smaller than N, the processing proceeds to step S646. In step S646, the visual point position adjusting unit 611 substitutes n+1 for n. In step S647, the visual point position adjusting unit 611 substitutes a scene number at a time t for sceneNo. In step S648, the visual point position adjusting unit 611 determines whether S_max[sceneNo] is more than S_th.

When it is determined in step S648 that S_max[sceneNo] is equal to or smaller than S_th, the processing proceeds to step S649.

In step S649, the visual point position adjusting unit 611 determines whether Vn,t is equal to or smaller to 0.5. When it is determined that Vn,t is equal to smaller than 0.5, the processing proceeds to step S650 and the visual point position adjusting unit 611 substitutes “left” for Dn,t. That is, in step S650, the left is set to the interpolation direction. Then, the processing returns to step S645 and the following processing is repeated.

When it is determined in step S648 that St is more than S_th, the processing proceeds to step S651. When it is determined in step S649 that Vn,t is more than 0.5, the processing proceeds to step S651.

In step S651, the visual point position adjusting unit 611 substitutes “right” for D′n,t. That is, in step S651, the right is set to the interpolation direction. Then, the processing returns to step S645 and the following processing is repeated.

As described above, it is determined whether the maximum value of the scale value is more than the threshold value, only when the scene change is detected. When the maximum value of the scale value is more than the threshold value, changing of the interpolation direction is prohibited. When the maximum value of the scale value is equal to or smaller than the threshold value, the changing of the interpolation direction is permitted.

That is, if the maximum value of the scale value is more than the threshold value, it means that mismatching of the left and right images may be conspicuous in a moment. Therefore, as described above, when the maximum value of the scale value is more than the threshold value, the changing of the interpolation direction is prohibited and the interpolation is performed from only the right over the entire scene. As a result, the mismatching of the left and right images in the scene can be suppressed.

In the example of FIG. 41, the image processing apparatus 600 has been described as an example of a combination of the image processing apparatus 100 of FIG. 2 and the scene change detecting unit 601. The combination example is not limited thereto. That is, the scene change detecting unit 601 may be combined with the image processing apparatus 200 of FIG. 17, the image processing apparatus 300 of FIG. 29, the image processing apparatus 400 of FIG. 33, and the image processing apparatus 500 of FIG. 40. For example, a configuration of the case in which the scene change detecting unit 601 of FIG. 41 is combined with the image processing apparatus 200 of FIG. 17 will be described below.

### [Configuration Example of Image Processing Apparatus]

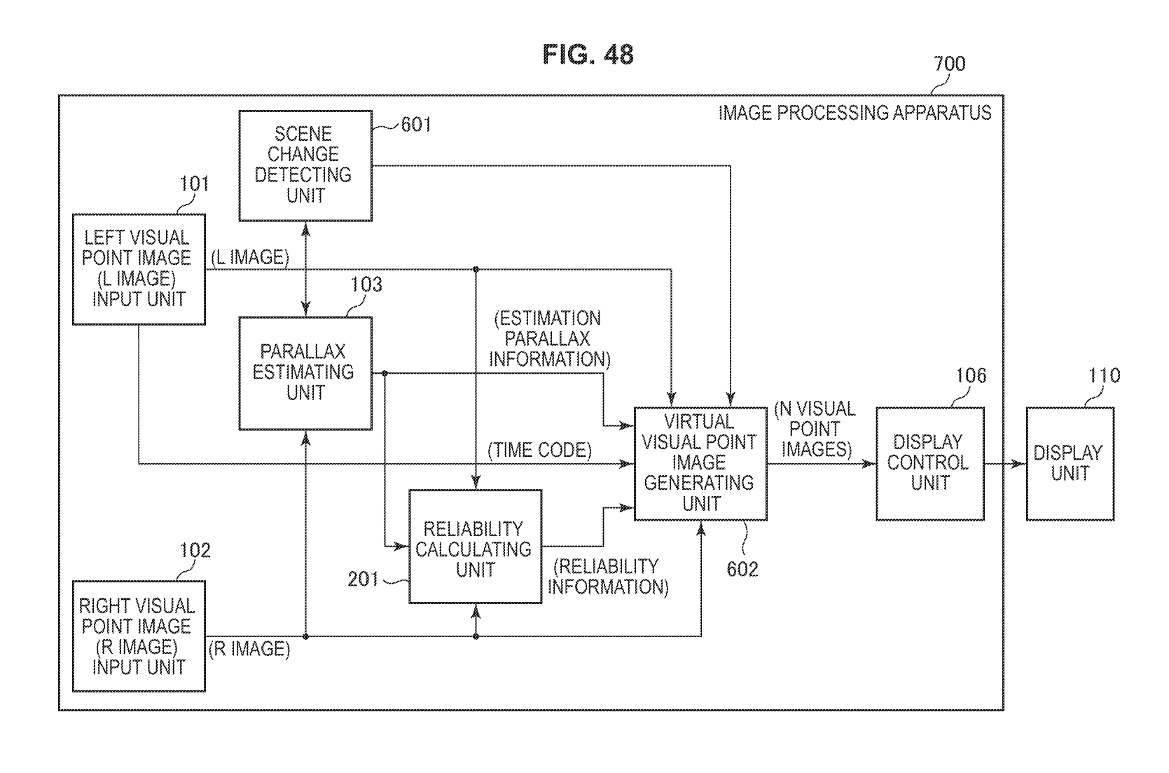

FIG. 48 is a block diagram illustrating another configuration example of an image processing apparatus to which the present disclosure is applied.

In the example of FIG. 48, an image processing apparatus 700 includes a left visual point image (L image) input unit 101, a right visual point image (R image) input unit 102, a parallax estimating unit 103, a reliability calculating unit 201, a scene change detecting unit 601, a virtual visual point image generating unit 602, and a display control unit 106. An image that is generated in the image processing apparatus 700 is output to the display unit 110.

The image processing apparatus 700 of FIG. 48 is the same as the image processing apparatus 600 of FIG. 41 in that the left visual point image (L image) input unit 101, the right visual point image (R image) input unit 102, the parallax estimating unit 103, the scene change detecting unit 601, the virtual visual point image generating unit 602, and the display control unit 106 are provided. However, the image processing apparatus 700 of FIG. 48 is different from the image processing apparatus 600 of FIG. 41 in that the reliability calculating unit 201 of FIG. 17 is additionally provided.

That is, an L image from the left visual point image (L image) input unit 101, an R image from the right visual point image input unit (R image) input unit 102, parallax information from the parallax estimating unit 103, and reliability information from the reliability calculating unit 201 are supplied to the virtual visual point image generating unit 602. In addition, information of a scene change from the scene change detecting unit 601 and a time code from the left visual point image (L image) input unit 101 are supplied to the virtual visual point image generating unit 602.

The virtual visual point image generating unit 602 executes analysis processing of the scene. The virtual visual point image generating unit 602 measures a parallax range for each scene using the scene change information from the scene change detecting unit 601 and the reliability information from the reliability calculating unit 201 and records the parallax range.

The virtual visual point image generating unit 602 adjusts the parallax amount, that is, determines a generated virtual visual point position (phase), on the basis of the reliability information from the reliability calculating unit 201, and executes the selection processing of the interpolation direction according to reliability of each scene, using the recorded information of the parallax range for each of the scenes.

The virtual visual point image generating unit 602 generates a virtual visual point image corresponding to the determined virtual visual point position (phase), on the basis of the image of the selected interpolation direction. The virtual visual point image generating unit 602 synthesizes the generated virtual visual point image, that is, the image of the adjusted visual point position and outputs the synthesis image to the display control unit 106 of the rear step.

### [Processing Example of Image Processing Apparatus]

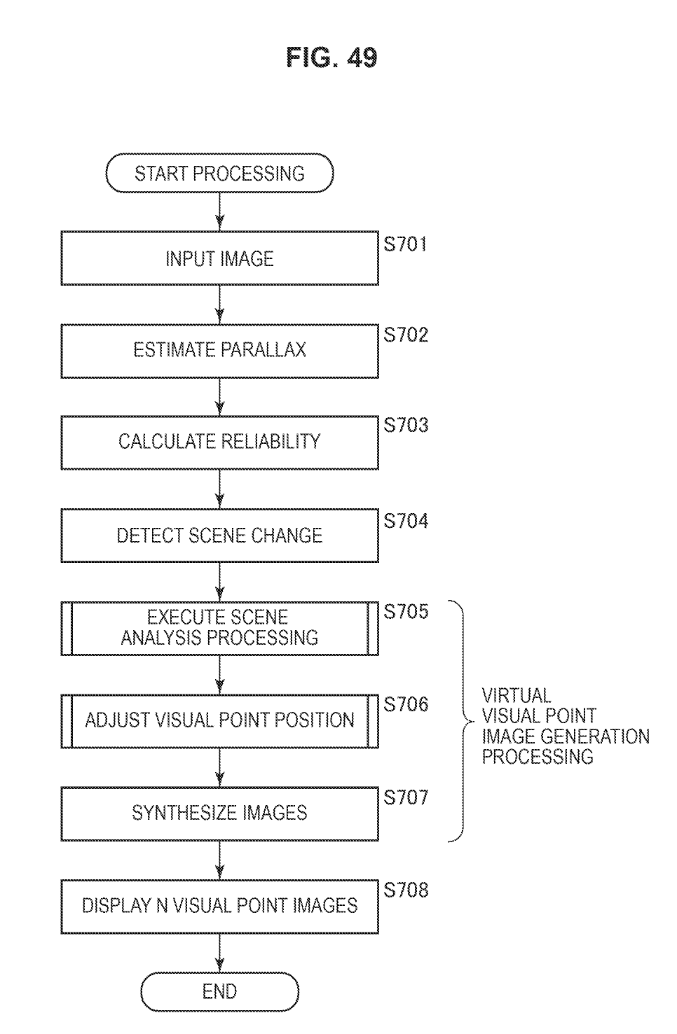

Next, image processing of an image processing apparatus 700 of FIG. 48 will be described with reference to a flowchart of FIG. 49. Processing of steps S701, S702, S704, S707, and S708 of FIG. 49 is basically the same as the processing of steps S601, S602, S603, S606, and S607 of FIG. 45. The processing of step S703 of FIG. 49 is basically the same as the processing of step S203 of FIG. 25.

In step S701, the left visual point image (L image) input unit 101 and the right visual point image (R image) input unit 102 input the left visual point image (L image) and the right visual point image (R image), respectively.

The input left visual point image (L image) and right visual point image (R image) are supplied to the parallax estimating unit 103 and the virtual visual point image generating unit 105.

In step S702, the parallax estimating unit 103 estimates the parallax using the supplied left visual point image (L image) and right visual point image (R image), as described above with reference to FIGS. 3 and 4. The parallax information of the estimation result by the parallax estimating unit 103 is supplied to the virtual visual point image generating unit 602.

In step S703, the reliability calculating unit 201 calculates reliability of parallax information of each pixel unit or each pixel region unit estimated by the parallax estimating unit 103 on the basis of the input LR images, as described above with reference to FIGS. 18 to 21. The reliability calculating unit 201 supplies information of the calculated reliability to the virtual visual point image generating unit 602.

In step S704, the scene change detecting unit 601 detects a scene change, as described above with reference to FIG. 42. When the scene change is generated, the scene change detecting unit 601 supplies a number of the scene and a time code of the scene as scene change information to the virtual visual point image generating unit 602.

In steps S705, S706, and S707, the virtual visual point image generating unit 602 executes the virtual visual point image generation processing.

That is, in step S705, the visual point position adjusting unit 611 executes scene analysis processing. The scene analysis processing is described below with reference to

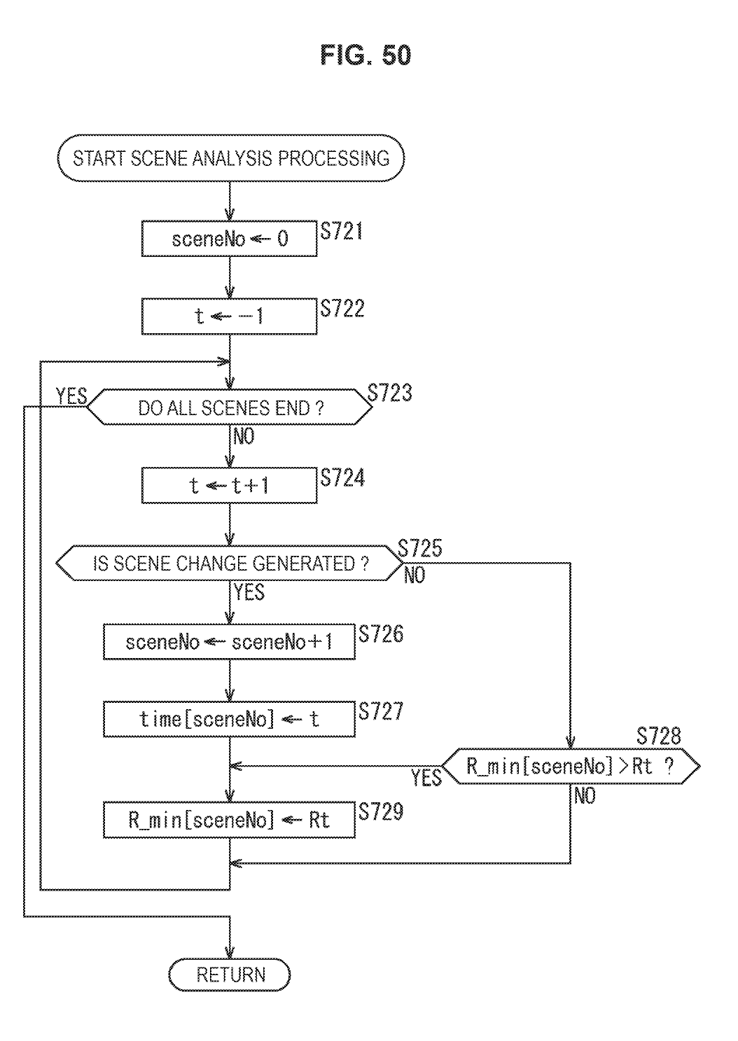

FIG. 50. The scene is analyzed by the processing of step S705 and the minimum value of the reliability for each scene, the time code of the scene, and the maximum value of the scene number are stored in the memory 612.

In step S706, the visual point position adjusting unit 611 adjusts the visual point position. The information of the output phase positions of the N visual points and the information of the interpolation directions of the N visual points are generated by the adjustment processing of the visual point position and are supplied to the image synthesizing unit 621.

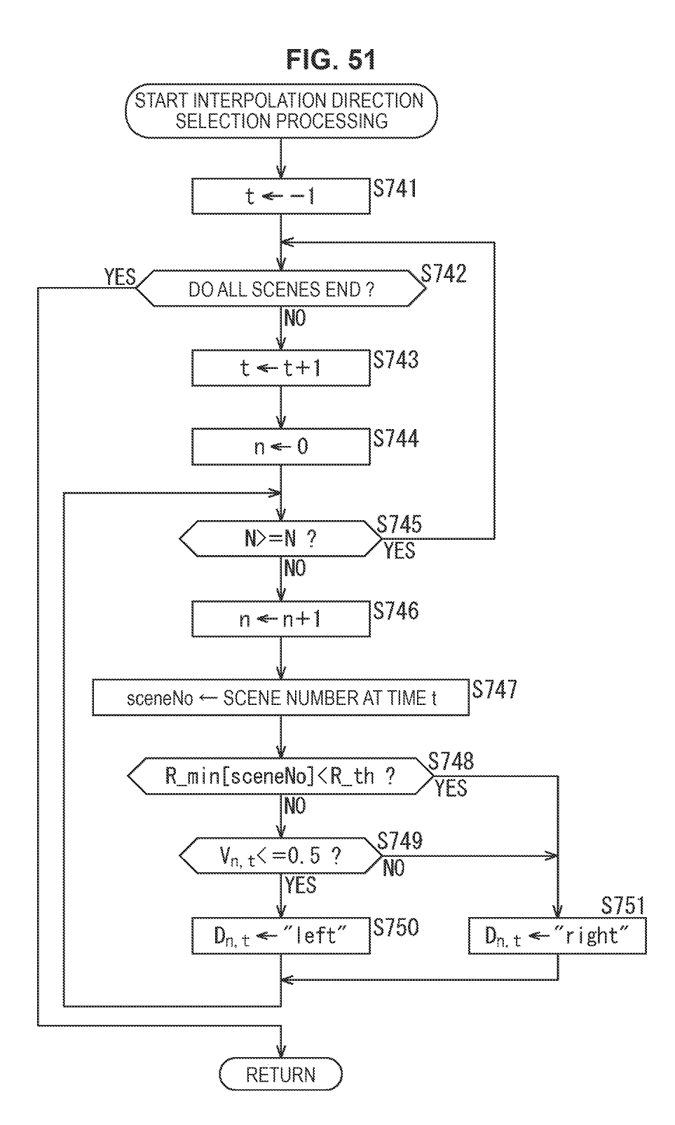

Because the visual point position adjustment processing is basically the same as the processing described above with reference to FIG. 26, except for the interpolation direction selection processing in step S212, explanation thereof is omitted. The different interpolation direction selection processing will be described below with reference to FIG. 51.

The L image from the left visual point image (L image) input unit 101, the R image from the right visual point image (R image) input unit 102, and the parallax information from the parallax estimating unit 103 are input to the image synthesizing unit 621.

In step S707, the image synthesizing unit 621 synthesizes the LR images with the image of the adjusted visual point position, on the basis of the input information, and supplies the synthesized N visual point images to the display control unit 106.

In step S708, the display control unit 106 displays the N visual point images on the display unit 110.

### [Example of Scene Analysis Processing]

Next, an example of the scene analysis processing in step S705 of FIG. 49 will be described with reference to a flowchart of FIG. 50.

In this case, sceneChange shows scene change information, sceneNo shows a scene number (initial value 0), R_min[s] shows a minimum value of reliability of a scene s, and Rt shows reliability. In addition, time_code shows a time code, time[s] shows a time code of the scene s, and scene_max shows a maximum value of a scene number.

In step S721, the visual point position adjusting unit 611 substitutes 0 for sceneNo. In step S722, the visual point position adjusting unit 611 substitutes −1 for t.

In step S723, the visual point position adjusting unit 611 determines whether sceneNo becomes scene_max, that is, whether all scenes end. When it is determined that all scenes end, the visual point position adjusting unit 611 ends the scene analysis processing.

In step S723, when it is determined that all scenes do not end, the processing proceeds to step S724. In step S724, the visual point position adjusting unit 611 substitutes t+1 for t. In step S725, the visual point position adjusting unit 611 determines whether the scene change is generated, by referring to the scene change information sceneChange from the scene change detecting unit 601.

When it is determined in step S725 that the scene change is generated, the processing proceeds to step S726. In step S726, the visual point position adjusting unit 611 substitutes sceneNo+1 for sceneNo. In step S727, the visual point position adjusting unit 611 substitutes t for time[sceneNo] and the processing proceeds to step S729.

Meanwhile, when it is determined in step S725 that the scene change is not generated, the processing proceeds to step S728. In step S728, the visual point position adjusting unit 611 determines whether R_min[sceneNo] is more than Rt. When it is determined that R_min[sceneNo] is more than Rt, the processing proceeds to step S729.

In step S729, the visual point position adjusting unit 611 substitutes Rt for R_min[sceneNo]. The processing returns to the processing of step S723 and the following processing is repeated.

When it is determined in step S728 that R_min[sceneNo] is not more than Rt, the processing of step S729 is skipped, the processing returns to step S723, and the following processing is repeated.

By the above processing, R_min[s] to be the minimum value of the reliability of the scene s, time[s] to be the time code of the scene s, and scene_max to be the maximum value of the scene number are stored in the memory 612 by the visual point position adjusting unit 611.

### [Example of Interpolation Direction Selection Processing]

Next, the selection processing of the interpolation direction will be described with reference to a flowchart of FIG. 51. This processing is the interpolation direction selection processing of the visual point position adjustment processing of step S706 of FIG. 49 (that is, the interpolation direction selection processing in step S212 of FIG. 26).

In this case, n shows a visual point number, N shows the total number of visual points, sceneChange shows a scene change signal, sceneNo shows a scene number (initial value 0), R_min[s] shows a minimum value of the reliability of the scene s, and R_th shows a threshold value (parameter). In addition, Vn,t shows a visual point phase, Dn,t shows an interpolation direction, time_code shows a time code, time[s] shows a time code of the scene s, and scene_max shows a maximum value of the scene number.

In the selection processing of the interpolation direction, R_min[s] to be the minimum value of the reliability of the scene s, time[s] to be the time code of the scene s, and scene_max to be the maximum value of the scene number that are stored in the memory 612 by the scene analysis processing are used. That is, because the time code of the scene s is stored, it is not necessary to detect the scene change, when the processing of FIG. 51 is executed.

In step S741, the visual point position adjusting unit 611 substitutes −1 for t. In step S742, the visual point position adjusting unit 611 determines whether sceneNo becomes scene_max, that is, whether all scenes end. When it is determined that all scenes end, the visual point position adjusting unit 611 ends the interpolation direction selection processing.

When it is determined in step S742 that all scenes do not end, the processing proceeds to step S743. In step S743, the visual point position adjusting unit 611 substitutes t+1 for t. In step S744, the visual point position adjusting unit 611 substitutes 0 for n.

In step S745, the visual point position adjusting unit 611 determines whether n is equal to or more than N. When it is determined that n is equal to or more than N, the processing returns to step S742 and the following processing is repeated.

When it is determined in step S745 that n is smaller than N, the processing proceeds to step S746. In step S746, the visual point position adjusting unit 611 substitutes n+1 for n. In step S747, the visual point position adjusting unit 611 substitutes a scene number at a time t for sceneNo. In step S748, the visual point position adjusting unit 611 determines whether R_min[sceneNo] is smaller than R_th.

When it is determined in step S748 that R_min[sceneNo] is equal to or smaller than R_th, the processing proceeds to step S749.

In step S749, the visual point position adjusting unit 611 determines whether Vn,t is equal to or smaller to 0.5. When it is determined that Vn,t is equal to smaller than 0.5, the processing proceeds to step S750 and the visual point position adjusting unit 611 substitutes “left” for Dn,t. That is, in step S750, the left is set to the interpolation direction. Then, the processing returns to step S745 and the following processing is repeated.

When it is determined in step S748 that R_min[sceneNo] is smaller than R_th, the processing proceeds to step S751. When it is determined in step S749 that Vn,t is more than 0.5, the processing proceeds to step S751.

In step S751, the visual point position adjusting unit 611 substitutes “right” for Dn,t. That is, in step S751, the right is set to the interpolation direction. Then, the processing returns to step S745 and the following processing is repeated.

As described above, it is determined whether the minimum value of the reliability is smaller than the threshold value, only when the scene change is detected. When the minimum value of the reliability is smaller than the threshold value, changing of the interpolation direction is prohibited. When the minimum value of the reliability is equal to or more than the threshold value, the changing of the interpolation direction is permitted.

That is, if the minimum value of the reliability is smaller than the threshold value, it means that mismatching of the left and right images may be conspicuous in a moment. Therefore, as described above, when the minimum value of the reliability is smaller than the threshold value, the changing of the interpolation direction is prohibited and the interpolation is performed from only the right over the entire scene. As a result, the mismatching of the left and right images in the scene can be suppressed.

In the above description, the interpolation is performed from only the right. However, the interpolation may be performed from only the left. When the converged position is the left (0), the scale value is more than the predetermined threshold value th_s, or the reliability is smaller than the predetermined threshold value th_r, the left is set as the temporary interpolation direction.

As described above, if the interpolation method (interpolation direction) changes frequently temporally, the changing may be conspicuous. Therefore, when the changing is conspicuous, the changing is suppressed from being performed frequently. Meanwhile, when the changing is inconspicuous, the changing is permitted.

That is, a suppression degree of the changing is changed by a conspicuous degree of the changing and the mismatching of the left and right images can be made to be inconspicuous.

The example corresponding to the parallax deviation when the parallax estimation is incorrect has been described. However, the present disclosure can be applied to a color deviation due to a conspicuous brightness deviation when the brightness of the left and right images is deviated.

The color deviation may be generated even when the parallax estimation is correct. When the color deviation is generated, the residual error may increase when the reliability is calculated. Therefore, the color deviation when the parallax estimation is correct can be resolved using the reliability.

The image processing of the three-dimensional image display has been described. However, the present disclosure is not limited to the image processing of the three-dimensional image display and may be applied to image processing of multi-dimensional image display.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

### 8. Seventh Embodiment

### Computer

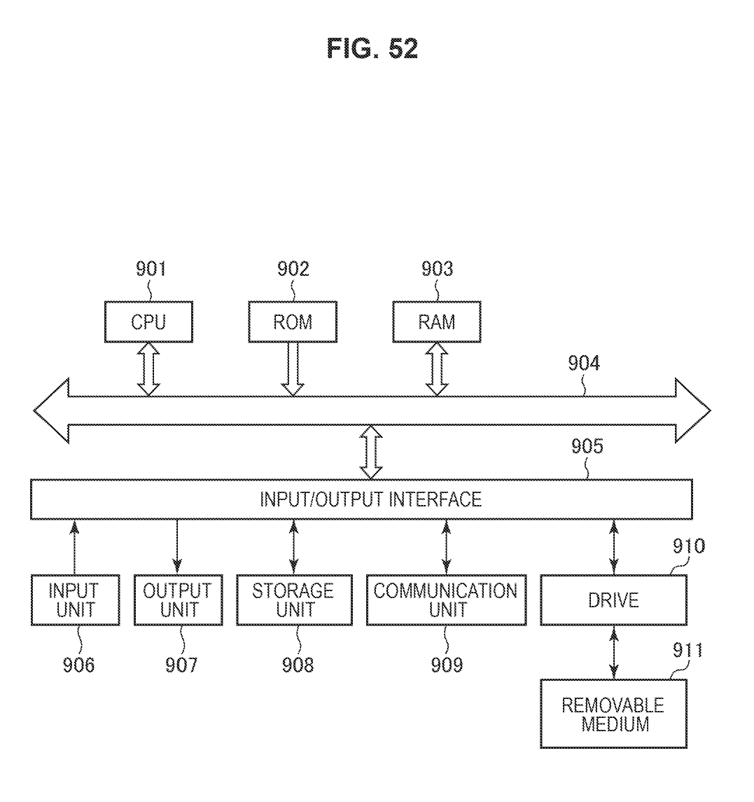

FIG. 52 shows an example configuration of the hardware of a computer that executes the series of processes described earlier according to a program.

In the computer, a central processing unit (CPU) 901, a read only memory (ROM) 902 and a random access memory (RAM) 903 are mutually connected by a bus 904.

An input/output interface 905 is also connected to the bus 904. An input unit 906, an output unit 907, a storage unit 908, a communication unit 909, and a drive 910 are connected to the input/output interface 905.

The input unit 906 is configured from a keyboard, a mouse, a microphone or the like. The output unit 907 configured from a display, a speaker or the like. The storage unit 908 is configured from a hard disk, a non-volatile memory or the like. The communication unit 909 is configured from a network interface or the like. The drive 910 drives a removable media 911 such as a magnetic disk, an optical disk, a magneto-optical disk, a semiconductor memory or the like.

In the computer configured as described above, the CPU 901 loads a program that is stored, for example, in the storage unit 908 onto the RAM 903 via the input/output interface 905 and the bus 904, and executes the program. Thus, the above-described series of processing is performed.

Programs to be executed by the computer (the CPU 901) are provided being recorded in the removable media 911 which is a packaged media or the like. Also, programs may be provided via a wired or wireless transmission medium, such as a local area network, the Internet or digital satellite broadcasting.

In the computer, by inserting the removable media 911 into the drive 910, the program can be installed in the storage unit 908 via the input/output interface 905. Further, the program can be received by the communication unit 909 via a wired or wireless transmission media and installed in the storage unit 908. Moreover, the program can be installed in advance in the ROM 902 or the storage unit 908.

It should be noted that the program executed by a computer may be a program that is processed in time series according to the sequence described in this specification or a program that is processed in parallel or at necessary timing such as upon calling.

In the present disclosure, the series of processes includes a process that is executed in the order described, but the process is not necessarily executed temporally and can be executed in parallel or individually.

Embodiments of the present disclosure are not limited to the embodiments described above, and various changes and modifications may be made without departing from the scope of the disclosure.

In addition, each step described in the flow chart above can be performed by a single apparatus as well as a plurality of apparatus in respective responsibilities.

Further, in a case where a single step includes a plurality of processes, the plurality of processes included in the step may be not only executed by a single device, but may also be distributed to a plurality of devices and be executed.

Further, an element described as a single device (or processing unit) above may be divided and to be configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same. In other words, an embodiment of the disclosure is not limited to the embodiments described above, and various changes and modifications may be made without departing from the scope of the disclosure.

It should be understood by those skilled in the art that various modifications, combinations, sub-combinations and alterations may occur depending on design requirements and other factors insofar as they are in the scope of the appended claims or the equivalents thereof.

Additionally, the present technology may also be configured as below.

(1) An image processing apparatus including:

a parallax estimating unit that generates parallax information from a left visual point image to be an image signal for a left eye applied to multi-dimensional image display and a right visual point image to be an image signal for a right eye applied to the multi-dimensional image display;

an interpolation direction control unit that controls changing of an interpolation direction of a virtual visual point image including a visual point image other than the left visual point image and the right visual point image, according to a parameter showing a degree of a variation based on the parallax information generated by the parallax estimating unit; and

a virtual visual point image generating unit that generates the virtual visual point image in the interpolation direction of which the changing is controlled by the interpolation direction control unit.

(2) The image processing apparatus according to (1),

wherein the interpolation direction control unit prohibits the changing of the interpolation direction of the virtual visual point image, when the variation shown by the parameter is large.

(3) The image processing apparatus according to (1) or (2),

wherein the interpolation direction control unit performs the changing of the interpolation direction of the virtual visual point image, when the variation shown by the parameter is small.

(4) The image processing apparatus according to any one of (1) to (3),

wherein the variation based on the parallax information that is generated by the parallax estimating unit is a time variation.

(5) The image processing apparatus according to any one of (1) to (4), further including:

a reliability calculating unit that calculates reliability of the parallax information generated by the parallax estimating unit,

wherein the parameter showing the degree of the variation based on the parallax information generated by the parallax estimating unit is the reliability of the parallax information calculated by the reliability calculating unit, and

the interpolation direction control unit controls the changing of the interpolation direction of the virtual visual point image, according to the reliability of the parallax information calculated by the reliability calculating unit.

(6) The image processing apparatus according to any one of (1) to (4),

wherein the parameter showing the degree of the variation based on the parallax information generated by the parallax estimating unit is a scale value calculated from the parallax information generated by the parallax estimating unit, and

the interpolation direction control unit controls the changing of the interpolation direction of the virtual visual point image, according to the scale value calculated from the parallax information generated by the parallax estimating unit.

(7) The image processing apparatus according to any one of (1) to (6),

wherein the interpolation direction control unit selects one direction as the interpolation direction of the virtual visual point image, according to the parameter showing the degree of the variation based on the parallax information generated by the parallax estimating unit,

when the selected one direction is selected as the interpolation direction of the virtual visual point image continuously for a constant time, the interpolation direction control unit changes the interpolation direction of the virtual visual point image to the selected one direction, and

when the selected one direction is not selected as the interpolation direction of the virtual visual point image continuously for the constant time, the interpolation direction control unit prohibits the changing of the interpolation direction of the virtual visual point image.

(8) The image processing apparatus according to any one of (1) to (7),

wherein the virtual visual point image generating unit sets a convergence position of a visual point position to a left visual point or a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

(9) The image processing apparatus according to any one of (1) to (7),

wherein the virtual visual point image generating unit sets a convergence position of a visual point position to any position between a left visual point and a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

(10) The image processing apparatus according to any one of (1) to (9), further including:

a face detecting unit that detects a position of a face of a user who views the virtual visual point image which is generated by the virtual visual point image generating unit and is displayed on a display unit,

wherein the interpolation direction control unit controls the changing of the interpolation direction of the virtual visual point image, according to the position of the face of the user detected by the face detecting unit.

(11) The image processing apparatus according to any one of (1) to (9),

wherein a display unit that displays the virtual visual point image generated by the virtual visual point image generating unit is wearable on a head of a user,

the image processing apparatus further comprises a face detecting unit that detects a position and a direction of a face of the user who views the virtual visual point image displayed on the display unit, and

the interpolation direction control unit controls the changing of the interpolation direction of the virtual visual point image, according to the position and the direction of the face of the user detected by the face detecting unit.

(12) The image processing apparatus according to any one of (1) to (11), further including:

a scene change detecting unit that detects a scene change from the left visual point image or the right visual point image,

wherein the interpolation direction control unit performs the changing of the interpolation direction of the virtual visual point image, when the scene change is detected by the scene change detecting unit.

(13) An image processing method including:

causing an image processing apparatus to generate parallax information from a left visual point image to be an image signal for a left eye applied to multi-dimensional image display and a right visual point image to be an image signal for a right eye applied to the multi-dimensional image display;

causing the image processing apparatus to control changing of an interpolation direction of a virtual visual point image including a visual point image other than the left visual point image and the right visual point image, according to a parameter showing a degree of a variation based on the generated parallax information; and

causing the image processing apparatus to generate the virtual visual point image in the interpolation direction of which the changing is controlled.

The present disclosure contains subject matter related to that disclosed in Japanese Priority Patent Application JP 2012-105252 filed in the Japan Patent Office on May 2, 2012, the entire content of which is hereby incorporated by reference.

What is claimed is:

1. An image processing apparatus comprising:
a parallax estimating unit that generates parallax information from a left visual point image to be an image signal for a left eye applied to multi-dimensional image display and a right visual point image to be an image signal for a right eye applied to the multi-dimensional image display;
an interpolation direction control unit that controls changing of an interpolation direction of a virtual visual point image including a visual point image other than the left visual point image and the right visual point image, according to a parameter showing a degree of a variation based on the parallax information generated by the parallax estimating unit; and
a virtual visual point image generating unit that generates the virtual visual point image in the interpolation direction of which the changing is controlled by the interpolation direction control unit.

2. The image processing apparatus according to claim 1,
wherein the interpolation direction control unit prohibits the changing of the interpolation direction of the virtual visual point image, when the variation shown by the parameter is large.

3. The image processing apparatus according to claim 2,
wherein the interpolation direction control unit performs the changing of the interpolation direction of the virtual visual point image, when the variation shown by the parameter is small.

4. The image processing apparatus according to claim 2,
wherein the variation based on the parallax information that is generated by the parallax estimating unit is a time variation.

5. The image processing apparatus according to claim 2, further comprising:
a reliability calculating unit that calculates reliability of the parallax information generated by the parallax estimating unit,
wherein the parameter showing the degree of the variation based on the parallax information generated by the parallax estimating unit is the reliability of the parallax information calculated by the reliability calculating unit, and
the interpolation direction control unit controls the changing of the interpolation direction of the virtual visual point image, according to the reliability of the parallax information calculated by the reliability calculating unit.

6. The image processing apparatus according to claim 2,
wherein the parameter showing the degree of the variation based on the parallax information generated by the parallax estimating unit is a scale value calculated from the parallax information generated by the parallax estimating unit, and
the interpolation direction control unit controls the changing of the interpolation direction of the virtual visual point image, according to the scale value calculated from the parallax information generated by the parallax estimating unit.

7. The image processing apparatus according to claim 2,
wherein the interpolation direction control unit selects one direction as the interpolation direction of the virtual visual point image, according to the parameter showing the degree of the variation based on the parallax information generated by the parallax estimating unit,
when the selected one direction is selected as the interpolation direction of the virtual visual point image continuously for a constant time, the interpolation direction control unit changes the interpolation direction of the virtual visual point image to the selected one direction, and
when the selected one direction is not selected as the interpolation direction of the virtual visual point image continuously for the constant time, the interpolation direction control unit prohibits the changing of the interpolation direction of the virtual visual point image.

8. The image processing apparatus according to claim 2,
wherein the virtual visual point image generating unit sets a convergence position of a visual point position to a left visual point or a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

9. The image processing apparatus according to claim 2,
wherein the virtual visual point image generating unit sets a convergence position of a visual point position to any position between a left visual point and a right visual point and calculates a virtual visual point position to generate the virtual visual point image, using the parallax information generated by the parallax estimating unit, and generates the virtual visual point image in the interpolation direction of which the changing is controlled by the interpolation direction control unit, at the calculated virtual visual point position.

10. The image processing apparatus according to claim 1, further comprising:
a face detecting unit that detects a position of a face of a user who views the virtual visual point image which is generated by the virtual visual point image generating unit and is displayed on a display unit,
wherein the interpolation direction control unit controls the changing of the interpolation direction of the virtual visual point image, according to the position of the face of the user detected by the face detecting unit.

11. The image processing apparatus according to claim 1,
wherein a display unit that displays the virtual visual point image generated by the virtual visual point image generating unit is wearable on a head of a user,
the image processing apparatus further comprises a face detecting unit that detects a position and a direction of a face of the user who views the virtual visual point image displayed on the display unit, and
the interpolation direction control unit controls the changing of the interpolation direction of the virtual visual point image, according to the position and the direction of the face of the user detected by the face detecting unit.

12. The image processing apparatus according to claim 1, further comprising:
a scene change detecting unit that detects a scene change from the left visual point image or the right visual point image,
wherein the interpolation direction control unit performs the changing of the interpolation direction of the virtual visual point image, when the scene change is detected by the scene change detecting unit.

13. An image processing method comprising:
causing an image processing apparatus to generate parallax information from a left visual point image to be an image signal for a left eye applied to multi-dimensional image display and a right visual point image to be an image signal for a right eye applied to the multi-dimensional image display;
causing the image processing apparatus to control changing of an interpolation direction of a virtual visual point image including a visual point image other than the left visual point image and the right visual point image, according to a parameter showing a degree of a variation based on the generated parallax information; and
causing the image processing apparatus to generate the virtual visual point image in the interpolation direction of which the changing is controlled.
